(19) United States
(12) Patent Application Publication
(10) Pub. No.: US 2023/0300579 A1
(43) Pub. Date: Sep. 21, 2023

(54) EDGE-CENTRIC TECHNIQUES AND TECHNOLOGIES FOR MONITORING ELECTRIC VEHICLES

(71) Applicant: Intel Corporation, Santa Clara, CA (US)

(72) Inventors: Arvind Merwaday, Beaverton, OR (US); Kathiravetpillai Sivanesan, Portland, OR (US); Varsha Ramamurthy, El Dorado Hills, CA (US); Fabian Oboril, Karlsruhe (DE); Cornelius Buerkle, Karlsruhe (DE); Frederik Pasch, Karlsruhe (DE); Ignacio Alvarez, Portland, OR (US); John M. Roman, Hillsboro, OR (US); Ecehan Uludag, San Jose, CA (US)

(21) Appl. No.: 18/090,029

(22) Filed: Dec. 28, 2022

Related U.S. Application Data
(60) Provisional application No. 63/314,217, filed on Feb. 25, 2022.

(51) Int. Cl. H04W 4/44; B60L 53/66; B60L 58/10; G06Q 30/0283; G06Q 20/14

(52) U.S. Cl. CPC H04W 4/44; B60L 53/665; B60L 58/10; G06Q 20/145; G06Q 30/0284

(57) ABSTRACT

The present disclosure is generally related to connected vehicles, computer-assisted and/or autonomous driving vehicles, Internet of Vehicles (IoV), Intelligent Transportation Systems (ITS), and Vehicle-to-Everything (V2X) technologies, and in particular, to technologies and techniques of a road usage monitoring (RUM) service for monitoring road usage of electric vehicles. The RUM service can be implemented or operated by individual electric vehicles, infrastructure nodes, edge compute nodes, cloud computing services, electric vehicle supply equipment, and/or combinations thereof. Additional RUM aspects may be described and/or claimed.

### RELATED APPLICATIONS

The present application claims priority to U.S. Provisional App. No. 63/314,217 filed on Feb. 25, 2022, the contents of which is hereby incorporated by reference in its entirety.

### TECHNICAL FIELD

The present disclosure is generally related to connected vehicles, computer-assisted and/or autonomous driving vehicles, Internet of Vehicles (IoV), Intelligent Transportation Systems (ITS), and Vehicle-to-Everything (V2X) technologies, and in particular, to technologies and techniques for monitoring road usage of electric vehicles.

### BACKGROUND

A fuel tax (also known as a petrol tax, gasoline (gas) tax, or fuel duty) is an excise tax imposed on the sale of fuel. In most jurisdictions, the fuel tax is imposed on fuels which are intended for transportation. In some of these jurisdictions, the fuel tax receipts are often dedicated, earmarked, or hypothecated to transportation projects so that the fuel tax is considered by many a user fee. Here, the term “hypothecated” refers to the dedication of the revenue from a specific tax for a particular expenditure purpose.

As more electric vehicles (EV) are introduced to existing roadways, government entities are experiencing fuel tax revenue decreases. Since most EVs do not use carbon-based fuel in the same way as combustion engine vehicles, EVs are seen as skirting the user fee aspect of fuel taxes. This pushes the costs of road infrastructure maintenance disproportionately to combustion engine vehicle owners, since fuel taxes are one of the main sources to fund road infrastructure improvement and maintenance projects. To alleviate this issues, a flat fee for road usage has been added to the EV registration in several U.S. states. However, the flat fee does not reflect the actual breakdown of the usage in different jurisdictions, which means the user fee aspect of existing fuel taxes is eliminated for EVs. This may also give disproportionate benefit for some jurisdictions or EV owners. Thus, a more effective framework for road usage charging is needed.

Road usage charging (RUC) is different from traditional tolls. A toll is a fee charged for the use of a road or waterway. Tolls are collected from vehicles for using a particular road segment. The entering and exit lanes are equipped with human toll collectors, radio-frequency identification (RFID) based or short-range communications-based toll collection infrastructure. By contrast, a RUC system is a system where all drivers pay to maintain the roads based on how much they drive, rather than how much gas they consume. However, toll systems cannot be scaled to RUC, especially where all road segments within a jurisdiction need to be covered. For example, even if all the entry and exit points of a road way within a jurisdiction are equipped with automatic toll collection systems, the road usage of vehicles (e.g., in terms of distance driven) is still difficult to determine. In RUC, different geo-areas may have different tariffs and overlap with different jurisdictions. Usually, the fee charged to a vehicle is based on the distance travelled on the roads. However, estimating the distances travelled by a vehicle in different areas is a challenging problem.

### BRIEF DESCRIPTION OF THE DRAWINGS

In the drawings, which are not necessarily drawn to scale, like numerals may describe similar components in different views. Like numerals having different letter suffixes may represent different instances of similar components. Some implementations are illustrated by way of example, and not limitation, in the figures of the accompanying drawings in which:

FIG. 1 depicts an example system architecture for infrastructure-based road usage monitoring (RUM) implementations utilizing radio access technologies (RATs). FIG. 2 depicts an example RUM information storage data structures. FIGS. 3 and 7 depict example edge-based RUM processing pipeline processes. FIG. 4 depicts an example process for estimating RUM information. FIGS. 5 and 8 depict example out-of-coverage RUM scenarios. FIG. 6 depicts a system architecture for infrastructure-based RUM implementations without RATs. FIG. 9 depicts an example Road Experience Management (REM)-based RUM framework. FIG. 10 depicts example electric vehicle charging implementations.

FIGS. 11 and 12 depict example charging-based RUM tracking systems.

FIG. 13 illustrates an operative Intelligent Transport System (ITS) environment and/or arrangement. FIG. 14 depicts an ITS-S reference architecture. FIG. 15 depicts a collective perception basic service (CPS) functional model. FIG. 16 depicts example object data extraction levels for the CPS. FIG. 17 depicts a vehicle station. FIG. 18 depicts a personal station. FIG. 19 depicts a roadside infrastructure node. FIG. 20 depicts example components of an example compute node.

### DETAILED DESCRIPTION

### 1. Road Usage Monitoring

The following discussion provides several frameworks for efficient road usage monitoring (RUM) (also referred to as “road usage charging” or “RUC”) for user fees of EVs using sensors (e.g., visual light cameras, infrared cameras, LiDAR, and/or other sensors such as those discussed herein), artificial intelligence (AI) and/or machine learning (ML), wireless communications (e.g., WLAN RATs, WLAN V2X (W-V2X) RATs, cellular RATs, cellular V2X (C-V2X) RATs, and the like), roadside infrastructure, and edge computing systems. Additionally or alternatively, RUM can be based on the power consumed by individual EVs while charging their power source (e.g., battery). As examples, EV charging can be performed at commercial charging kiosks/stations, at residential stations, and/or at other locations.

The EV/RUM frameworks discussed herein include: vehicle-centric solutions for RUM, infrastructure-centric solutions for RUM with V2X technology, infrastructure-centric solutions for RUM without V2X technology (a “passive” solution), road experience management (REM)-based RUM solutions, and vehicle charging-centric solutions. The REM-based RUC framework leverages the REM infrastructure and can be deployed faster with less additional cost overhead (e.g., in terms of resource usage and monetary costs). The vehicle charging-centric solutions involve monitoring the energy/power (e.g., kilowatt-hour (kWh)) consumed by a vehicle during charging and fetching road usage reports from the vehicle. In addition, security vulnerabilities of the schemes are addressed and mechanisms to mitigate these issues are also provided. Although the EV monitoring implementations discussed herein are discussed in terms of RUC systems, the monitoring implementations could also be used for other purposes such as evaluating vehicular accidents, identifying high usage areas for targeted maintenance and upkeep, and/or for other purposes.

One existing approach is the Road Usage Charge system provided by Intelligent Mechatronic Systems, Inc. (d/b/a DriveSync®) has a device based on the On-Board Diagnostic II (OBD-II) standard hardware interface. The OBD-II specification is based on the ISO 15031-3:2016 standard, and provides for a standardized hardware interface, and also specifies the electrical signaling protocols and the messaging format for obtaining OBD data, a list of vehicle parameters to be monitored, and information about how to encode the data associated with these parameters during transmission and storage. In many cases, vehicles are required to have an OBD-II port (female connector) near the vehicle’s steering wheel, under the instrument panel, or somewhere within reach of the driver. The OBD-II port (sometimes referred to as a data link connector (DLC)) is often implemented as a female 16-pin (2×8) J1962 connector, where type A is used for 12 volt vehicles and type B for 24 volt vehicles. An external scanning device (e.g., emission tester) can connect to the vehicle ECUs through the OBD-II port and can access real-time data streams and OBD results/data. The OBD-II interface includes a physical medium for communicating OBD data, such as a controller area network (CAN) bus or the like. The DriveSync device has location services (GNSS) and Bluetooth (BT) capabilities to collect the odometer readings and the locations periodically. The EV owner needs to install an app on their smartphone to receive the collected data from DriveSync via BT and push to centralized road usage charging processor in the cloud via the cellular (e.g., 3GPP LTE, 5G, and the like) connectivity. The centralized road usage charging processor is responsible for calculating the road usage charge for different jurisdiction and charging the EV owner accordingly. In addition, the EV owner has to take the picture of the odometer periodically (e.g., monthly) and upload the image to the cloud to show the data is not tampered before transmission to the cloud. One drawback to DriveSync is that collecting odometer readings and location coordinates periodically and transmitting them to the cloud is not efficient in terms of compute and network resource consumption. For example, this system consumes large amounts of bandwidth for the transmission and incurs data charges to the EV owner. Another drawback to DriveSync is that the removable device on OBD-II socket could be easily tampered with and the data could be manipulated. Furthermore, some EV manufacturers do not include OBD-II ports in their vehicles (e.g., Tesla® model 3) because OBD-II ports are mandated for emissions data collection purposes, and EV manufacturers can apply for a waivers from such mandates

Another existing approach used by some insurance companies is the use of telematics devices and/or smartphones to collect several data like braking, acceleration, speed, time of day, and the like. With these tracking methods, detailed information like trip routes may also be collected, for example, to check whether the driver violated speed limits, stop signs, and/or the like. However, the main intension/intention of these tracking methods is to monitor the driving behaviors of users, and the insurance companies need to get consent from each user before collecting such detailed information. However, RUC systems have different data collection requirements, as the government entities do not need to collect detailed trip information for tax purposes, which should alleviate privacy concerns of insurance telematics systems. Furthermore, transmitting the detailed trip information leads to unnecessary compute and network overhead, and is not a scalable solution. Moreover, sending odometer images to verify the consistency of the data is not very strong or efficient mechanism for tracking road usage.

As discussed in more detail infra, the present disclosure describes different RUM mechanisms (see e.g., RUM functions 1105, 1205, 1419, and 1420 of FIGS. 10 and 14) that can be used depending on the availability of communication technologies or RATs (e.g., including any of the RATs discussed herein), and whether the tracking and/or measurement is performed at infrastructure and/or at the vehicle.

The vehicle-centric implementations is/are based on odometer reading, timestamp, and location/geo fence information. Here, the vehicle tracks its own road usage within a geo-fence or geo-area, and reports vehicle identifier (ID), road usage (e.g., distance driven in miles or kilometers (km)) and corresponding geo-area ID to a remote RUM system/function. As examples, the RUM system/function can be implemented or otherwise embodied as a cloud application (app) operated by a set of cloud compute nodes (e.g., a cluster or cloud nodes, or the like), a distributed edge app operated by one or more edge compute nodes, a RAN function operated by one or more RAN nodes, a network function operated by one or more core network compute nodes, and/or the like. The reports may be sent periodically, in response to a trigger condition or the like. The vehicle-centric implementations is optimized for communication overhead and computation in the cloud/edge and EV. As it is integrated within the EV electronic system (e.g., an in-vehicle infotainment system (IVI) or the like) and uses the existing trust framework (e.g., secure credential management system (SCMS) or C-ITS SCMS (CCMS)) in the vehicle, the data will be difficult to manipulate or otherwise compromise. The vehicle-centric implementations also include message format(s) for data collection that contains a minimum amount of information required for RUM (e.g., including geo-area, distance driven, and/or the like). In these ways, user privacy is protected since the vehicles do not transmit personal information, such as trip routes, trip timings, user IDs, vehicle IDs, and/or other like personal data, confidential data, and/or sensitive data.

The implementations involving infrastructure with one or more RATs include vehicles reporting data, such as timestamp(s), odometer reading(s), and geo-area ID, at the start and/or end of a trip and/or at geofence boundary crossings. The reported information is processed at the road usage monitor to determine the road usage charge. The roadside infrastructure-based implementations are well suited and efficient when road side units (RSUs) (e.g., R-ITS-Ss 1330 and/or the like) are deployed widely with V2X capability. Where the ITS band is used, there is little to no cost for the transmission since the ITS band is unlicensed. Additionally, computation and storage resources on the vehicle side would be minimal.

The passive infrastructure-based implementations uses sensors (e.g., cameras, RFID sensor, and/or any other suitable sensor(s) such as those discussed herein) to detect the identity of the vehicle (e.g., based on license plate number, RFID tags, and/or the like), and calculates the road usage charge and/or provides such information to the road usage monitor for processing. The passive infrastructure-based implementations can be used for scenarios where data collection aspects are required or desired to be transparent and/or scenarios where there are sparsely deployed road infrastructure (e.g., no R-ITS-Ss within a specific geo-area).

Additionally, a road experience management (REM) based RUM framework is provided (see e.g., The Why and How of Making HD Maps for Automated Vehicles, INTEL NEWSROOM (01 Nov. 2019), and REM™ Gives Our Autonomous Vehicles the Maps They Need, MOBIL EYE BLOG, (10 Mar. 2021), the contents of each of which are hereby incorporated by reference in their entireties). The REM-based implementations leverages the existing REM infrastructure. The REM system draws data from the multiple CA/AD vehicles 1310 equipped with sensors (e.g., cameras, radar, lidar, microphones and other audio sensors, and the like) and suitable chips for processing and communicating collected sensor data. The collected sensor data is fully anonymized, and uploaded to the cloud 1390 (or edge cloud) in relatively small packets. These relatively small packets are processed at the cloud 1390 on a continuous basis to create the Mobileye Roadbook™, which is a database of highly precise, high-definition maps by which CA/AD vehicles 1310 can utilize for autonomous driving applications and/or advanced driver-assistance system (ADAS) applications. Unlike conventional static maps, the Mobileye Roadbook™ encompasses a dynamic history of how drivers drive on any given stretch of road to better inform the decision-making process and capabilities of individual CA/AD vehicles 1310. As the REM based RUC framework leverages the REM infrastructure, it can be deployed faster with less additional overhead.

The charging-centric solutions involve monitoring power/energy (kWh) consumption of individual vehicles. Here, a RUM tracking mechanism operating on a vehicle and/or EV supply equipment (EVSE) measures or tracks the power/energy consumed during charging from EVSE at a charging station (e.g., commercial charging kiosk, charging station, residential charging devices, and/or the like). The RUM tracking mechanism calculates or otherwise determines RUM data for the vehicle based on the measured/monitored power/energy supplied to the vehicle during the charging. In some implementations, the RUM tracking mechanism is implemented as an app, algorithm, or other software element at/on the EVSE and/or on the EV, and does not require additional or upgraded hardware. The vehicle reports its locally tracked road usage data to the EVSE and/or to a remote system (e.g., edge or cloud infrastructure), which is considered by the RUM tracking mechanism to adjust the road usage fees, accordingly. In these ways, the power/energy consumption-based RUM approach is somewhat similar to fuel tax imposed at a fuel pump at a petrol station.

The implementations discussed herein involves information exchange for data collection using any suitable access technologies or combination of access technologies. In the infrastructure-centric implementations, the road monitor and/or the infrastructure estimates the road usage data using periodic and/or asynchronous messages (e.g., V2X messages) transmitted by vehicles and/or other road users, and using the infrastructure sensor data. Additionally, in any of the implementations discussed herein (including the REM-based implementations), the road usage monitor may be a distributed app operated by a cloud computing service (e.g., cloud compute node or cluster of cloud compute nodes) or by edge computing infrastructure (e.g., the edge compute nodes and ECT infrastructure elements discussed herein).

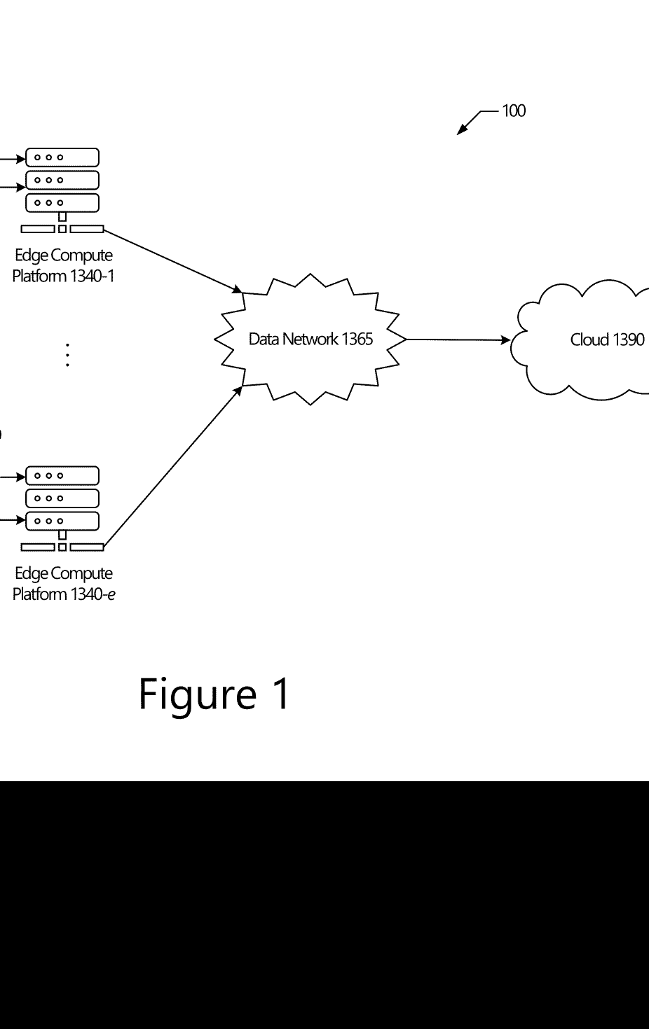

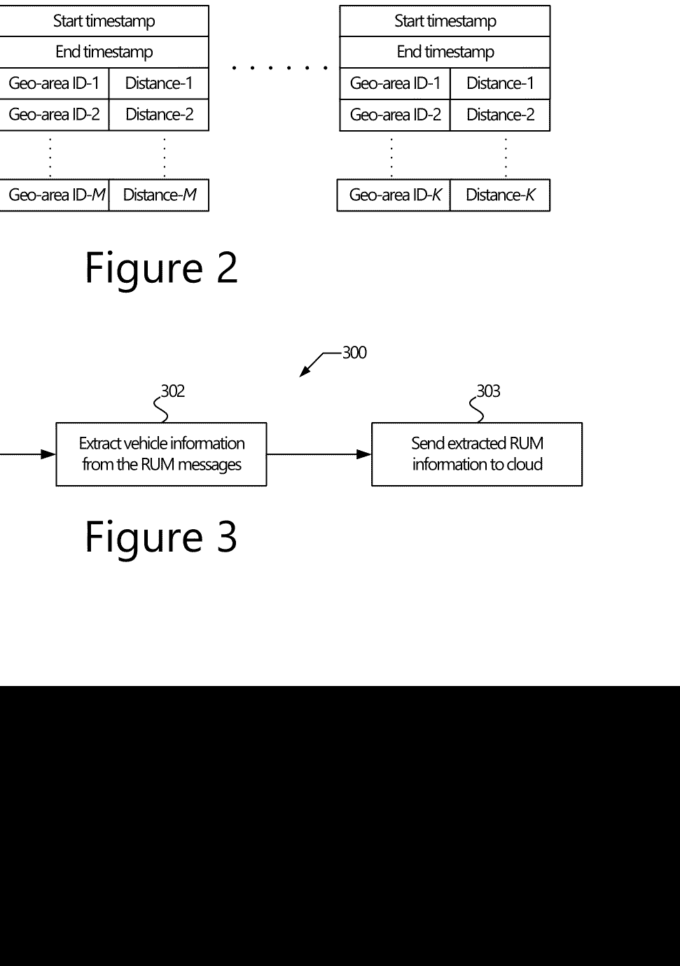

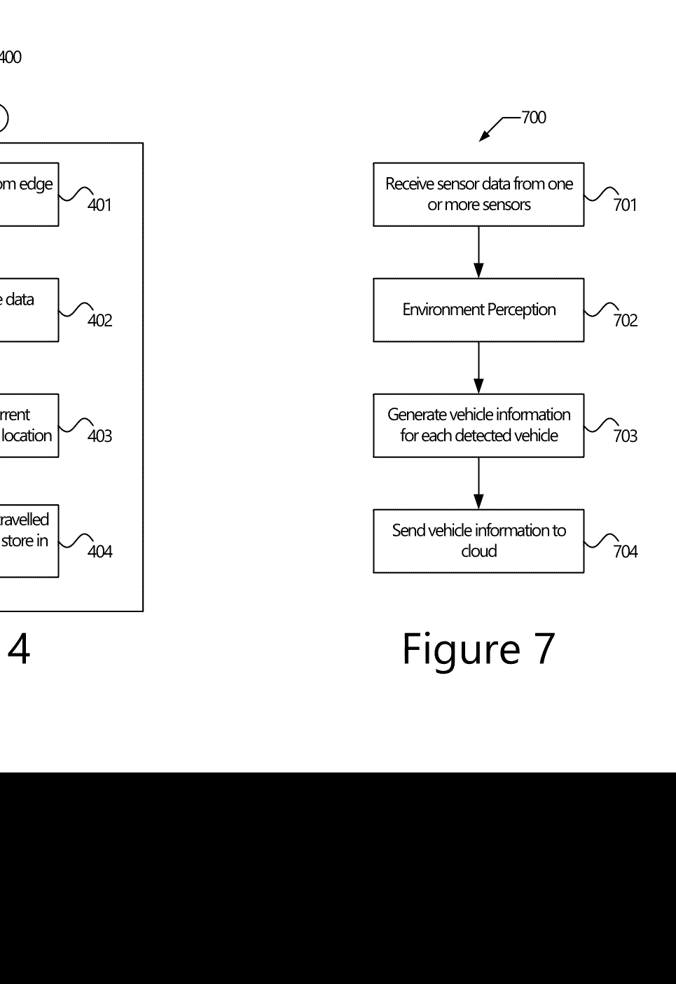

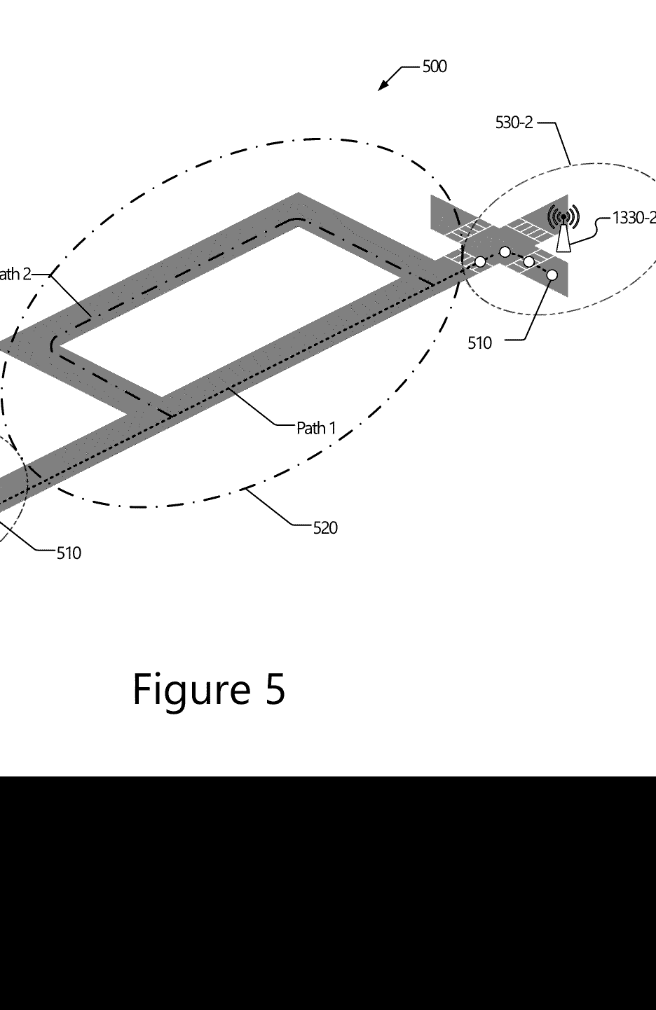

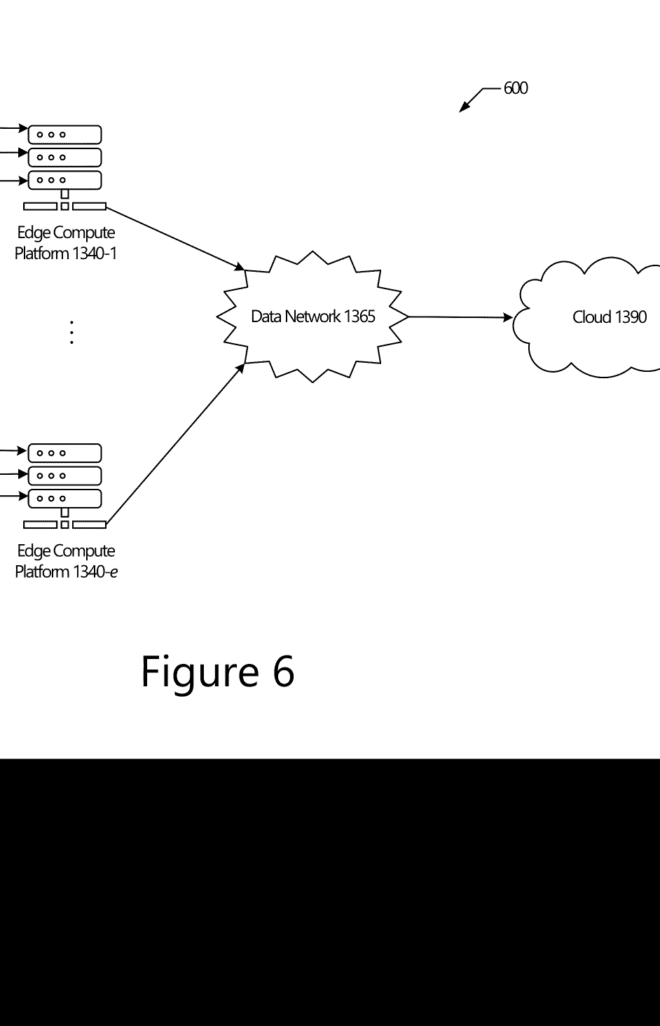

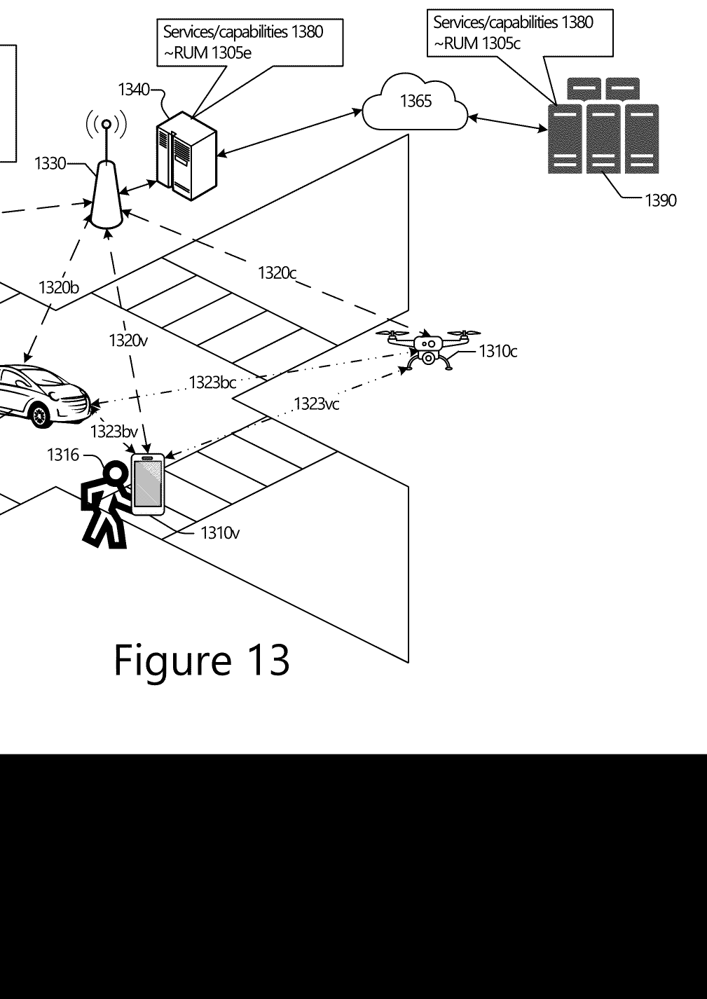

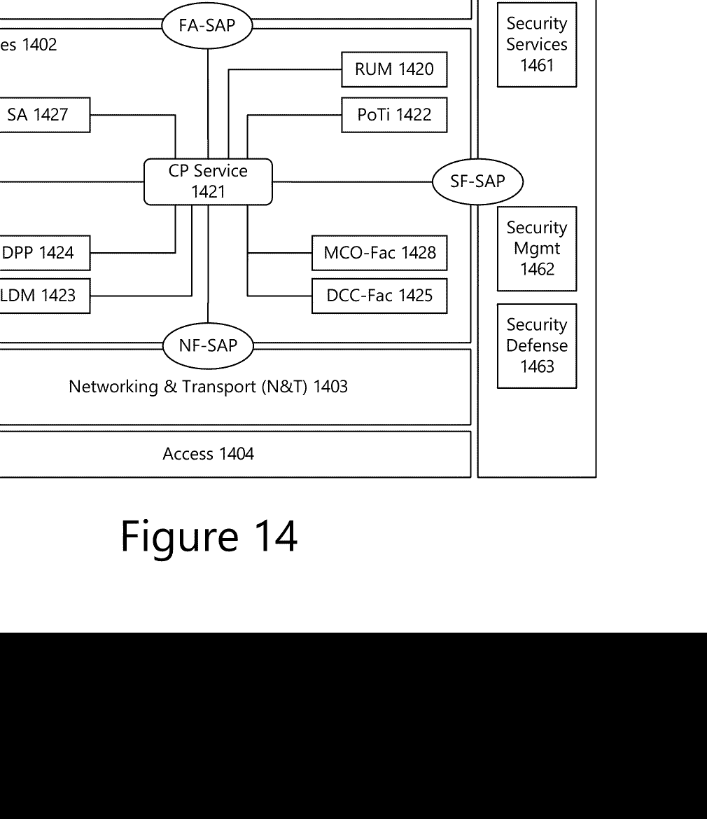

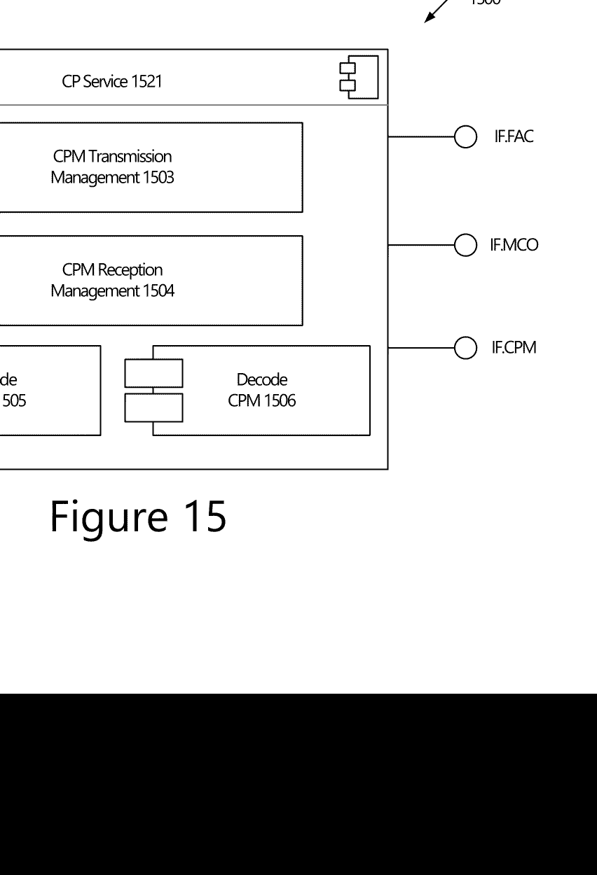

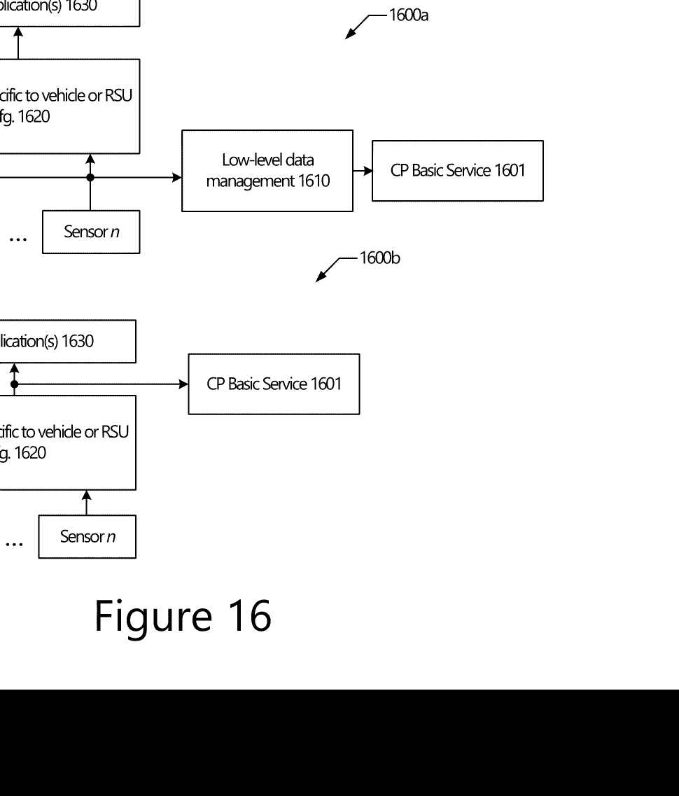

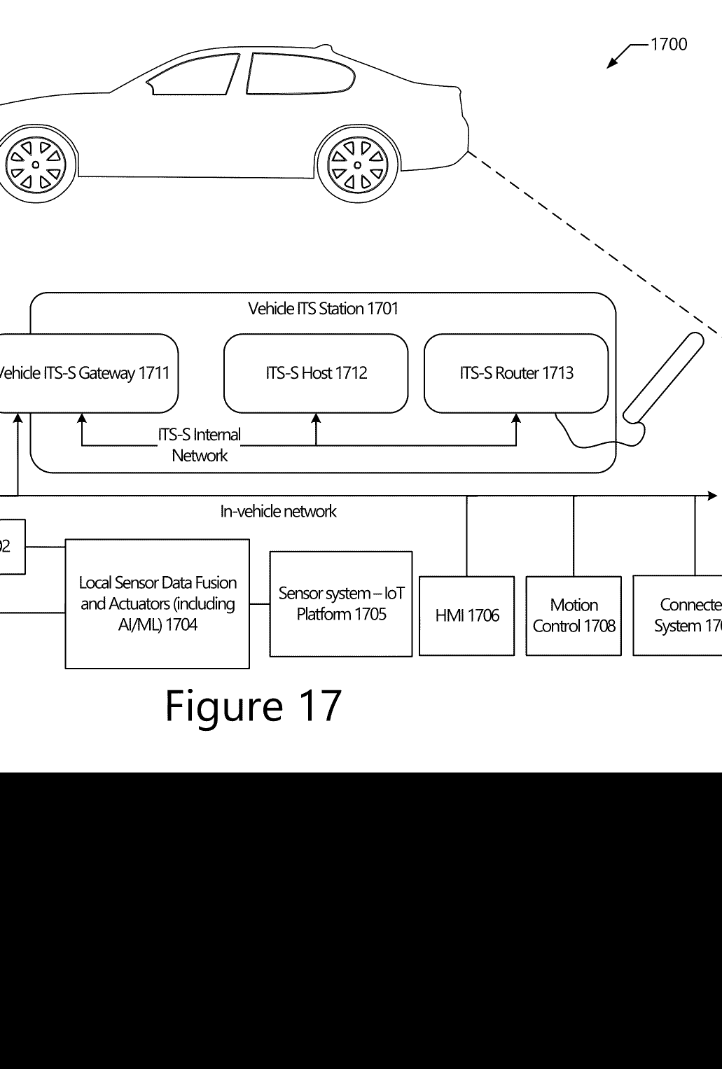

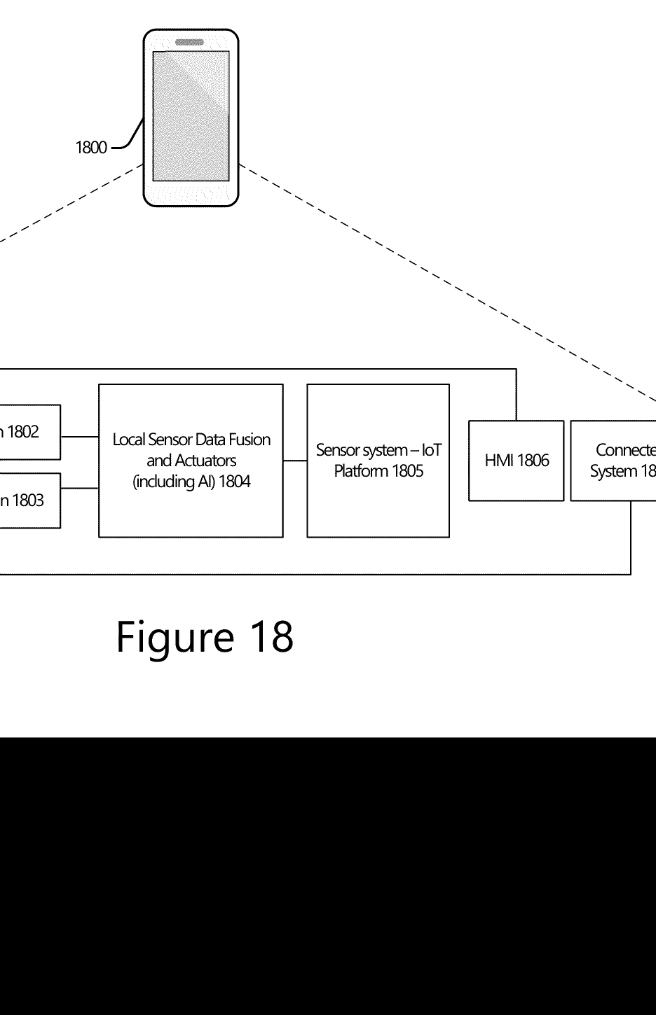

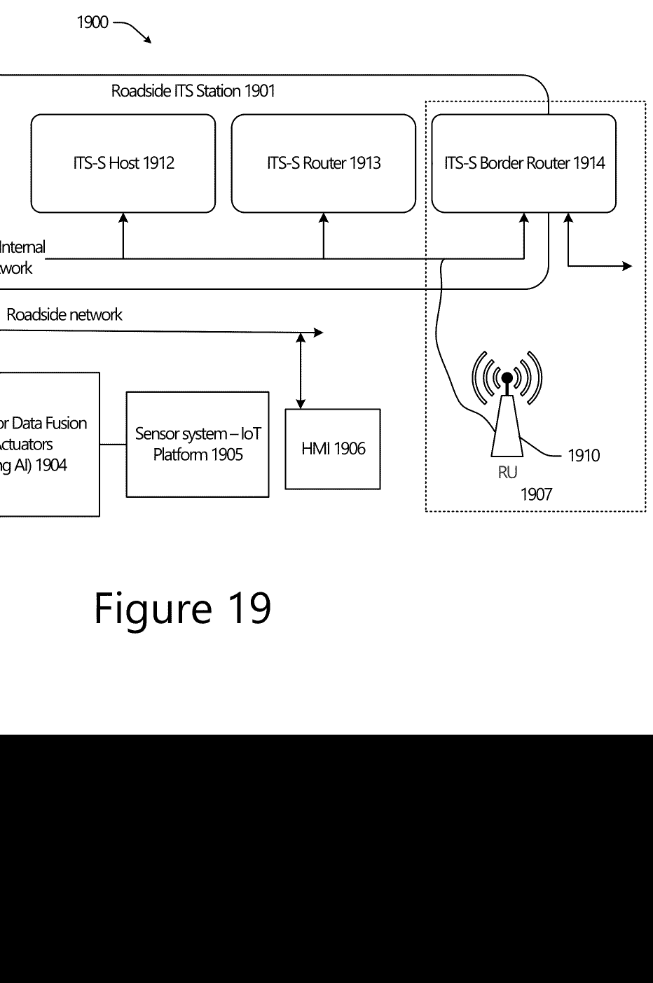

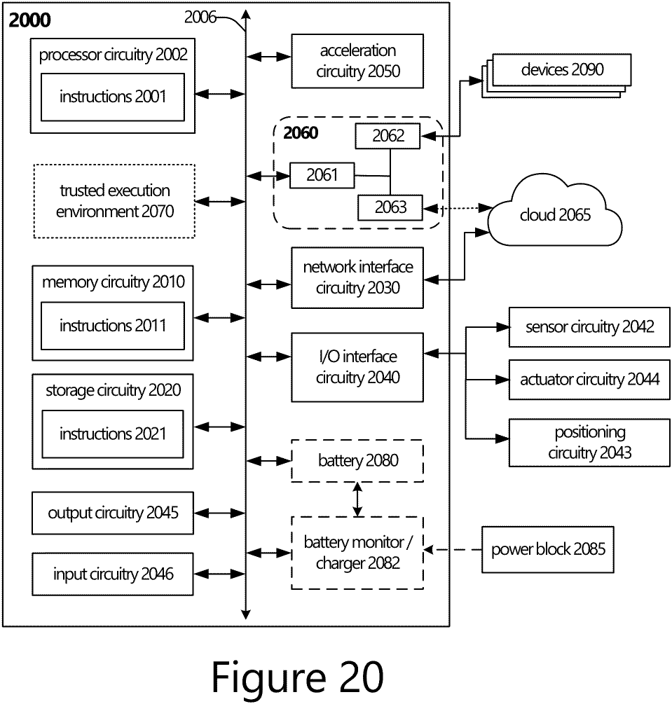

FIG. 1 depicts an example system architecture 100 for infrastructure-based RUM implementations that include the use of one or more RATs (e.g., V2X RATs). The system architecture 100 includes vehicles 1310-1 to 1310-V (where V is a number) communicatively coupled with one or more NANs 1330-1 to 1330-N (where N is a number), where one or more NANs 1330 (e.g., road side units (RSUs) or the like) are connected to one or more edge compute platforms 1340-1 to 1340-e (where e is a number). The NANs 1330 may be deployed suitably to provide uniform coverage (or nearly uniform coverage) in all the geo-areas of interest. The edge compute platforms 1340-1 to 1340-e are connected to the cloud 1390 via a data network (DN) 1365. These elements are discussed in more detail infra with respect to (w.r.t) FIG. 13. Road usage of the vehicles 1310 can be tracked and/or measured according to the vehicle-centric, infrastructure-centric, and/or power/energy consumption/charging-centric RUM approach(es) discussed infra. In any of the RUM approaches discussed herein, individual vehicles 1310 report road usage information and/or vehicle information via one or more suitable messages, such as any of the message types/formats discussed herein, over a suitable interface (e.g., PC5 interface, Uu interface, C-V2X interfaces, W-V2X interfaces, and/or the like) to the infrastructure (e.g., NANs 1330, edge platform 1340, DN 1365, and/or cloud 1390) periodically (e.g., once in an hour, or day, or week, and/or the like) and/or asynchronously (e.g., in response to one or more events, such as when the infrastructure requests a road usage report, when a vehicle 1310 enters a new/different geo-area, when a vehicle 1310 crosses a geofence boundary, and/or the like).

### 1.1. Vehicle-Centric Rum

In the vehicle-centric RUM approach, a vehicle 1310 locally tracks its own movements using position/location determination mechanisms for determining the vehicle’s 1310 position/location, mapping mechanisms for determining or obtaining map information, and a RUM service entity/element 1305v (not shown by FIG. 1; see FIG. 13) for locally computing or determining its travelled distances in different geo-areas. As examples, the position/location determination mechanisms includes a satellite positioning system (e.g., a GPS or GNSS system, such as positioning circuitry 2043 discussed of FIG. 20 and/or the like), network-based location services (e.g., MEC location services as discussed in ETSI GS MEC 013 v2.2.1 (2022-01), 3GPP LTE and/or 5G system location services (LCS) as discussed in 3GPP TS 23.273 v17.6.0 (2022-09-22), 3GPP TR 38.857 v17.0.0 (2021-03-30), 3GPP TR 21.917 v2.0.0 (2022-12-08), and/or the like), Positioning and Time management (PoTi) facility 1422 discussed infra w.r.t FIG. 14, and/or using some other location-determination and/or positioning mechanisms/techniques. Additionally or alternatively, the mapping mechanisms can include, for example, local dynamic map (LDM) facility 1423 discussed infra w.r.t FIG. 14, geographic information system (GIS) apps/systems (e.g., Google Maps®, Google Earth®, Environmental Systems Research Institute (Esri) or ArcGIS® (e.g., ArcReader, ArcMap, etc.), Android Team Awareness Kit (ATAK), EarthWatch® and/or SecureWatch® provided by Maxar Technologies, and/or the like), geoinformatics systems, and/or associated geographic/geospatial data model(s). The RUM service entity/element 1305v (also referred to as “RUM 1305v”) can be any suitable app, facility, and/or service for performing the various tasks, operations, functions as discussed herein. As examples, the RUM 1305v corresponds to one or more of the RUM apps 1105 and/or 1205 of FIGS. 10-12, the RUM facility 1420 and/or RUM app 1410 of FIG. 14, and/or any other RUM function/element discussed herein.

In some implementations, the vehicle-centric RUM approach involves the RUM 1305v of the vehicle 1310 computing or determining its road usage data locally and storing the road usage information in local memory/storage in the form of duration bins (e.g., bins 201 of FIG. 2). Depending on the configuration, the vehicle 1310 (or RUM 1305v) can update its road usage data to the edge compute platforms 1340 or cloud 1390 periodically and/or in response to receipt of update request message(s) from the edge compute platforms 1340 and/or cloud 1390.

FIG. 2 shows a duration binning system 200 for storing road usage information at a vehicle 1310 using duration bins 201-1 to 201-L (where L is a number). Vehicles 1310 are equipped with positioning technologies (e.g., positioning circuitry 2043) and online or offline maps (e.g., local dynamic maps as discussed infra w.r.t FIGS. 14-19). The positioning system provides a relatively accurate location of the vehicle 1310 (within some standard deviation or margin of error), while the map information can be used to detect events when the vehicle 1310 moves from one geo-area to another and/or crosses a geo-fence boundary. Hence, the vehicle 1310 can accurately determine the routes/paths it travelled and corresponding distances (within some standard deviation or margin of error) in respective geo-areas or geo-fences. The vehicle’s 1310 road usage information can include the determined routes/paths, the corresponding distances, as well as start and end timestamps. The vehicle 1310 (or the RUM 1305v) implements or operates the duration binning system 200 to periodically store the road usage information locally in the form of one or more duration bins 201-1 to 201-L (collectively referred to as “duration bins 201”, “duration bin 201”, “duration buckets 201”, or the like).

Each duration bin 201-1 to 201-L (collectively referred to as “duration bins 201” or “duration bin 201”) includes a start timestamp field that stores a starting timestamp, an end timestamp field that stores an end or stopping timestamp, and a set of geo-area tuples. Each geo-area tuple includes a geo-area identity (ID) field that stores a geo-area ID and a distance field that stores a corresponding distance value. As shown by FIG. 2, bin 201-1 includes 1 to N geo-area tuples (where N is a number), bin 201-2 includes 1 to M geo-area tuples (where M is a number), and bin 201-L includes 1 to K geo-area tuples (where K is a number). In various implementations, each bin 201 contains a list of geo-area IDs and corresponding travelled distances for a time duration between the bin’s 201 start timestamp and end timestamp. The duration granularity of each bin 201 can be configured based on the timing and/or granularity requirements (e.g., 100 milliseconds (ms), 1 second (s), 10s, 1 minute, and/or the like).

The duration binning system 200 can be embodied as any suitable data binning system, such as, for example, an adaptive-intelligent binning system, a histogram binning system, a discretization task system, a bucket sorting system, a ‘binr’ system, and/or the like. Additionally or alternatively, the duration binning system 200 can be embodied as, or otherwise utilize, a machine learning (ML)-based binning system, such as, for example, feature binning including unsupervised binning (e.g., equal width binning, equal frequency binning, and/or the like) and/or supervised binning (e.g., entropy-based binning, minimum description length principle (MDLP) binning, and/or the like).

In various implementations, individual vehicles 1310 report their road usage information to the infrastructure (e.g., NANs 1330, edge platform 1340, DN 1365, and/or cloud 1390) by transmitting road information messages over a suitable W-V2X RAT link and/or C-V2X RAT link. As examples, the road information messages contain some or all of the following information: identity (ID) information of the vehicle 1310 (e.g., VIN, an ITS-AID, and/or any other identifier or network address, such as any of those discussed herein), start timestamp for the reported road usage data, end timestamp for the reported road usage data, and a list of geo-area IDs and the corresponding travelled distances. Additionally or alternatively, the road information messages include one or more bins 201. The road information messages can be (or are encapsulated in) any suitable message format, such as Cooperative Awareness Message (CAM), Collective Perception Message (CPM), Decentralized Environmental Notification Message (DENM), VRU Awareness Messages (VAMs), cellular network message format(s), C-V2X message formats, and/or any other message format, such as any of those discussed herein.

In some implementations, the individual vehicles 1310 report their road usage information to the infrastructure synchronously and/or on a periodic basis. Additionally or alternatively, the individual vehicles 1310 report their road usage information to the infrastructure on asynchronously. In these examples, the infrastructure (e.g., NANs 1330, edge platform 1340, DN 1365, and/or cloud 1390) sends a road usage information request message to the individual vehicles 1310, where the road usage information request message includes requested start and end timestamps. In these examples, each of the vehicles 1310 can respond to the road usage information request message with the aforementioned road information messages including bins 201 having the requested start and end timestamps, bins 201 having start and end timestamps that are within some range of the requested start and end timestamps, and/or bins 201 having start and end timestamps that are somewhat close or similar to the requested start and end timestamps.

The vehicle-centric approach for RUM allows for accurate estimation of road usage data compared to other approaches (e.g., tracking vehicles 1310 at infrastructure 1330) because there is no dependence on the infrastructure 1330 for determining travelled path and calculation of distances. Additionally, this approach provides less computation burden at the infrastructure 1330 (in comparison to existing/conventional approaches) as it does not involve complex algorithms such as environment perception, path prediction, and the like. Furthermore, this approach has low communication overhead (in comparison to existing/conventional approaches) since the road usage data can be updated to the infrastructure 1330 with a relatively low frequency (e.g., once a day, once a week, and/or the like). Moreover, this approach provides privacy and security of vehicle users are inherently protected because the vehicles 1310 do not transmit details of trips (locations and timestamps, travel traces, and/or the like), but only transmits minimum required information (e.g., geo-areas and distances).

### 1.2. Infrastructure-Centric Rum

In the infrastructure-centric RUM approach, the infrastructure includes a RUM service entity/element 1305e (not shown by FIG. 1; see FIG. 13) that receives and processes periodic transmissions of road information messages from the vehicles 1310, through which the movement of each vehicle 1310 can be tracked, and hence the distance travelled by each vehicle 1310 in different geo-areas can be estimated and/or predicted. As examples, the infrastructure can be implemented or embodied as a set of roadside ITS-Ss and/or NANs 1330, a central ITS-S, edge compute platforms 1340, DN 1365, and/or cloud 1390.

The vehicles enabled with V2X communications periodically broadcast different types of messages such as, for example, ITS-S messages (e.g., Cooperative Awareness Message (CAM), Collective Perception Message (CPM), Decentralized Environmental Notification Message (DENM), VRU Awareness Messages (VAMs)) C-V2X messages, and/or other like messages, such as any of those discussed herein. These messages contain various information about the respective Tx vehicles 1310. For example, a CAM contains basic information about the transmitting vehicle 1310 such as vehicle ID, location, heading direction, speed, and the like (see e.g., [EN302637-2]). Other ITS-S messages include the same or similar information. This information can be used to track the vehicles’ 1310 movements at the infrastructure, and estimate and/or predict the road usage of the vehicles 1310.

### 1.2.1. Edge Processing Pipeline

FIG. 3 shows an example process 300 of an edge processing pipeline that is operated at or by an edge platform 1340. In some examples, the process 300 may be embodied as the RUM entity/service 1305e (also referred to as “RUM 1305e”), which may be an edge app and/or edge service that is operated or otherwise provided by the edge platform 1340. Process 300 begins at operation 301, where the RUM 1305e receives a road information message (or “RUM message”) from a Tx vehicle 1310 via a NAN 1330 (e.g., RSU or the like) within a coverage area of the edge platform 1340 and/or the NAN 1330. In these implementations, the RUM message includes various vehicle information/data that can be used to determine RUM information for the vehicle 1310, such as, for example, a vehicle ID, location data, heading/travel direction, speed data, and/or any other suitable vehicle-related information. At operation 302, the RUM 1305e processes the received RUM message and extracts the relevant vehicle information for estimating road usage for the vehicle 1310.

At operation 303, the RUM 1305e reports some or all of the extracted vehicle information to the cloud 1390. In these implementations, when the cloud 1390 receives the extracted vehicle information, the cloud 1390 operates or executes the cloud processing pipeline 400 of FIG. 4. The RUM 1305e can report the vehicle information to the cloud 1390 periodically and/or asynchronously. As examples, the vehicle information sent by the RUM 1305e to the cloud 1390 includes one or more of: timestamp of observation; unique identity (UID) of the vehicle 1310 (e.g., license plate number, vehicle identification number (VIN), and/or some other ID and/or network address, such as any of those discussed herein); location information (e.g., geo-coordinates, GPS data, location services data, and/or the like); heading direction; speed data; and/or any other relevant data and/or features of the vehicle 1310, such as, ITS-S type (e.g., vehicle type, VRU type/profile, and/or the like), make, model, color, compute system IDs, network IDs, and/or other information. In some implementations, the RUM 1305e can implement efficient reporting mechanisms, for example, by avoiding redundant updates. For instance, instead of continuously reporting information about a vehicle 1310, it can be reported once after the first detection, and then, subsequent reports only if the vehicle’s 1310 location changes significantly (e.g., some predefined or configured distance from the original location (e.g., a few meters)). Process 300 can be repeated or otherwise performed for some or all RUM messages received from respective vehicles 1310.

### 1.2.2. Cloud Processing Pipeline

FIG. 4 depicts an example process 400 of a cloud processing pipeline for estimating road usage of a vehicle 1310. In some examples, the process 400 may be embodied as a RUM entity/service 1305c (also referred to as “RUM 1305c”; see e.g., FIG. 13), which may be a cloud app and/or service that is operated or otherwise provided by the cloud 1390. Process 400 begins at operation 401, where the RUM 1305c receives a road usage update from an ego edge platform 1340 on a continuous and/or asynchronous basis (see also e.g., operation 303 discussed supra). The road usage updates include vehicle information about a detected ego vehicle 1310, which can include any of the vehicle information discussed previously w.r.t FIG. 3 (e.g., vehicle ID, position/location data, start and end timestamps, and/or the like) as well as any other information/data, such as any of the information/data discussed herein.

At operation 402, the RUM 1305c fetches, queries, or otherwise obtains historical road usage information from a RUM database (DB) 490. The cloud 1390 maintains the RUM DB 490, which contains road usage information of various vehicles 1310 that was/were previously reported by various edge platforms 1340. The (historic) road usage information stored by the RUM DB 490 includes information, such as distances driven in respective geo-areas and corresponding timings/timestamps (e.g., date, time) and/or any of the vehicle information discussed previously w.r.t FIG. 3 as well as any other information/data, such as any of the information/data discussed herein. In some examples, the historic/previously reported vehicle data is vehicle data about the ego vehicle 1310 reported by the ego edge platform 1340 and/or one or more other edge platforms 1340. The RUM DB 490 is updated by the cloud 1390 based on the vehicle reports received from the various edge platforms 1340, including the vehicle data received at operation 401.

At operation 403, the RUM 1305c determines/estimates a path of the ego vehicle 1310 using the vehicle data reported by the ego edge platform 1340 (see e.g., operation 303 of FIG. 3) and using map information of relevant road sections corresponding to position/location information included in the vehicle data and/or the historic vehicle data obtained from the RUM DB 490. After the path of the vehicle 1310 is determined/estimated, at operation 404, the RUM 1305c determines/estimates the distance travelled in one or more geo-areas corresponding to the reported position/location data, and stores the determined/estimated travel distance in the RUM DB 490. Before, during, or after performance of operation 404, the RUM 1305c proceeds back to operation 401 to receive vehicle data of the ego vehicle 1310 and/or other vehicles 1310. Process 400 can be repeated or otherwise performed for some or all RUM messages received from respective edge platforms 1340.

In some examples, such as deployment scenarios where there is adequate cell coverage by a set of NANs 1330 and/or a network of edge platforms 1340, it is relatively straightforward to calculate the distance traveled by the ego vehicle 1310 in the geo-area(s). However, estimating the ego vehicle’s 1310 path using location/positioning samples reported by the ego edge platform 1340 can be challenging in certain scenarios where there is relatively sparse or no coverage by edge platforms 1340 and/or NANs 1330, as is the case in the example of FIG. 5.

FIG. 5 shows an example road scenario 500 where an ego vehicle 1310 approaches an intersection within a cell coverage area 530-1 provided by NAN 1330-1, and then travels through cell coverage area 530-2 provided by NAN 1330-2. However, there is also a dead zone 520 between the coverage areas 530 where there is little or no network connectivity. The dead zone 520 may be a coverage hole or coverage blind spot, or can be cause by various issues, such as NAN 1330 line of sight obstructions, poor channel conditions, NAN Tx and/or power capabilities, RF and/or hardware issues, and/or the like. Regardless of the reason for the existence of the dead zone 520, the movements of vehicles 1310 may be difficult to track when the ego vehicle 1310 travels through the dead zone 520. In other scenarios, estimating the position/location of high mobility vehicles 1310 (e.g., vehicles 1310 traveling at relatively high speeds, such as on a highway or freeway) can sometimes be difficult because such high mobility vehicles 1310 can end up traversing numerous cells, and thus, end up perform numerous cell (or beam) reselection procedures. These issues can cause uncertainty at the NANs 1330, edge platform 1340, and/or cloud 1390 when attempting to determine the exact path of vehicles 1310 (within a certain margin of error or standard deviation), and can lead to degradation in the accuracy of estimating the road usage of vehicles 1310.

High density NAN 1330 deployments and implementing self-organizing network (SON) functionality, such as coverage and capacity optimization (CCO), load balancing optimization (LBO), handover parameter optimization, RACH optimization, SON coordination, NF and/or RANF self-establishment, self-optimization, self-healing, continuous optimization, automatic neighbor relation management, and/or the like (see e.g., 3GPP TS 32.500 v17.0.0 (2022-04-04) (“[TS32500]”), 3GPP TS 32.522 v11.7.0 (2013-09-20), 3GPP TS 32.541 v17.0.0 (2022-04-05), 3GPP TS 28.627 v17.0.0 (2022-03-31), 3GPP TS 28.313 v17.6.0 (2022-09-23), 3GPP TS 28.628 v17.0.0 (2022-03-31), 3GPP TS 28.629 v17.0.0 (2022-03-31)), can improve the overall coverage area of roads, and therefore, can improve the road usage estimation accuracy at the edge platform 1340 and/or cloud 1390. Moreover, optimization functions/algorithms can be implemented at the edge platform 1340 and/or cloud 1390 to achieve as much accuracy as possible for the given deployment density.

In the example of FIG. 5, vehicle location samples (with timestamps) 510 taken near the intersections (or otherwise within the cell coverage areas 530) are reported frequently, and hence, the path can be accurately tracked at least at or near the NANs 1330. However, in the road scenario 500, it is uncertain whether the vehicle 1310 travels along path 1 or path 2 because cell coverage is lacking in the region between the NANs 1330. Using the map information, the cloud 1390 (or an edge platform 1340) can determine the number of alternative paths available for the ego vehicle 1310 and the expected travel times for each path given existing or predicted road traffic conditions. Then, using the timestamps of the reported location samples 510, the cloud 1390 (or an edge platform 1340) can estimate the ego vehicle’s 1310 most probable travel path, and hence the distance travelled in or through the dead zone 520. However, this kind of uncertainty can be avoided (even in the presence of dead zones 520) by placing cameras at every intersection, as is discussed in more detail infra w.r.t FIG. 6.

### 1.3. Infrastructure-Centric Rum Without Network Connectivity

FIG. 6 depicts an system architecture 600 for infrastructure-based RUM implementations that have little or no network connectivity, such as the road scenario 500 of FIG. 5. The system architecture 600 include the same or similar elements as system architecture 100 of FIG. 1, except that system architecture 600 additionally or alternatively includes sensors 610-1 to 610-m (where m is a number). As examples, each of the sensors 610-1 to 610-m (collectively referred to as “sensors 610” or “sensor 610”) may be the same or similar as the sensor circuitry 2042 of FIG. 20. In some implementations, each sensors 610 can be the same type of sensor, or some or all of the sensors 610 can be different than one another. In one example, all of the sensors 610 are visible light sensors (e.g., cameras). In another example, sensor 610-1 and sensor 610-(m - 1) can be visible light sensors (e.g., cameras), sensor 610-2 and sensor 610-(m - 2) can be infrared sensors, and sensor 610-x and sensor 610-m are pressure sensors embedded in respective roadway sections. Additionally or alternatively, some or all of the sensors 610 can be attached to one or more NANs 1330, deployed at one or more cell sites, and/or deployed at various sections of the roadway. Different combinations of sensors 610 and/or deployment options can be used depending on implementation, use case, and/or design choice.

These implementations can be used for tracking the road usage of vehicles 1310 that do not include V2X communications capabilities and/or when vehicles 1310 travel through areas with little or no network connectivity by utilizing roadside infrastructure 1330 and/or sensors 610 resources. In the example of FIG. 6, each edge computing platform 1340 is connected to a set of sensors 610, via local DN 1365 (e.g., via a wired and/or wireless connection(s)), which stream sensor data (e.g., live video footage and/or other sensor data based on the type of sensors 610 being employed) of their respective coverage sectors (e.g., sectors 830 of FIG. 8). The edge computing platforms 1340 process received sensor data (e.g., video data and/or the like) using perception algorithms and/or object tracking techniques to detect vehicles 1310. The identity of vehicles 1310 can also be uniquely identified using, for example, license plate numbers and vehicle features (e.g., make, model, color, vehicle type, and/or the like), and/or other identification features/data. Furthermore, using the information about each sensors’ 610 deployment locations and/or field of views (FoVs), the perception algorithms can also estimate locations of the identified vehicles 1310.

Each of the edge computing platforms 1340 synchronously and/or asynchronously sends semantic and/or kinematic information of the detected and/or identified vehicles 1310 to the cloud 1390 via the DN 1350. The cloud 1390 performs further processing and estimates the road usage of individual vehicles 1310 over time by determining the distances traveled by the vehicle 1310 in different geo-areas.

### 1.3.1. Edge Processing Pipeline

FIG. 7 shows an example process 700 of an edge processing pipeline that is operated at or by an edge platform 1340. In some examples, the process 700 may be embodied as the RUM 1305e, which may be an edge app and/or edge service that is operated or otherwise provided by the edge platform 1340. Process 700 begins at operation 701, where the RUM 1305e receives sensor data from one or more sensors 610. In some examples, the edge compute node 1340 obtains continuous (or nearly continuous) streams of input (sensor) data from respective sensors 610. At operation 702, the RUM 1305e performs environment perception based on the received sensor data. In some examples, the environment perception includes methods and algorithms that collaboratively process the sensor data received from various sensors 610 (e.g., using sensor data fusion techniques, such as any of those discussed herein) to develop a contextual understanding of the environment. Additionally or alternatively, the environment perception can include one or more object detection and/or object tracking techniques, such as any of those discussed herein. Additionally or alternatively, recent advancements in the field of autonomous systems have allowed for real-time environmental perception capabilities with accurate semantic and kinematic details (see e.g., Pendleton, et al., Perception, Planning, Control, and Coordination for Autonomous Vehicles, MACHINES, vol. 5, no. 1 (17 Feb. 2017), https://www.mdpi.com/2075-1702/5/1/6, the contents of which is hereby incorporated by reference in its entirety).

At operation 703, the RUM 1305e generates or determines vehicle information for each of the detected vehicles 1310 based on the environment perception. As examples, this vehicle information includes vehicle identification (e.g., assigned by the environment perception algorithm and/or the like), semantic, and kinematic information. Furthermore, re-identification and tracking algorithms can be used to keep track of movements of the detected vehicles 1310. The RUM 1305e reports detected vehicle data to the cloud 1390 (or RUM 1305c) using the same or similar periodic and/or asynchronous reporting mechanisms discussed previously w.r.t operation 303 of FIG. 3.

### 1.3.2. Cloud Processing Pipeline

The cloud processing pipeline follows similar procedure as discussed previously w.r.t FIG. 4. In some cases, the RAT-based mechanism can have better coverage than the sensor-based mechanism. The sensing of the sensors 610 may be directional depending on the FoV and required line-of-sight (LoS), while the infrastructure nodes 1330 can receive RAT (e.g., V2X) messages from vehicles 1310 in some or all directions and/or from relatively longer distances (e.g., approx. 100 meters and/or the like), and can also receive information in non-LoS conditions.

FIG. 8 depicts an example road scenario 800 for determining uncertainty in out-of-coverage zones. The example of FIG. 8 is similar to that shown by FIG. 5, except that sensors 610-1 and 610-m are additionally or alternatively placed at respective intersections. Here, sensor 610-1 has an FoV 810-1 and sensor 610-m has an FoV 810-m, each of which points toward their respective intersections. However, there is also a dead zone 820 between the sensor coverage areas 810 where there is little or no perception capabilities (at least for sensors 610). The dead zone 820 may be sensor blind spot(s), based on limited FoVs 810 of sensors 610, LoS obstructions, and/or caused by other issues. Regardless of the reason for the existence of the dead zone 820, the movements of vehicles 1310 may be difficult to track when the ego vehicle 1310 travels through the dead zone 820. In such cases, the cloud 1390 can implement path prediction processes as explained previously.

### 1.4. Road Experience Management-Based Rum

FIG. 9 depicts an example Road Experience Management (REM)-based RUM framework 900 (“REM-RUM 900”). The REM-RUM 900 includes a REM-RUM service 950 (also referred to as a “RUM service 950”, “RUC) service 950”, and/or the like), which can be provided through already existing REM infrastructure (e.g., including NANs 1330, edge platforms 1340, cloud 1390, and/or the like) and reporting functions. Here, the REM-RUM service 950 can be embodied as a collection of REM servers and/or other computing elements, as well as the RUM 1305e and/or RUM 1305c. This is possible, as already many CA/AD vehicles 1310 are equipped with a REM systems that send its REM information (e.g., REM-RUM info 915) to a REM server, which is used by the REM server to send features for a map of a current location and/or upcoming areas to the vehicle 1310. In various implementations, map generation is fully automated, and maps can be updated in near-real time because of sophisticated change-detection algorithms on millions of mapping agents implemented by the REM system. Consequently, REM is aware of the route that every REM-equipped vehicle 1310 follows, and thus, has all information available that is required for a REM-RUM service 950. This information can be used to establish RUC services, toll or usage tax collection services, and/or other road monitoring services. This REM-based solution has the benefit for the vehicle 1310 owner that RUCs can be directly collected, and the user does not require additional third party apps or additional (third party) devices.

In this example, a user 901 opts-in 951 to the REM-RUM service 950. In some examples, the opt-in process 951 involves the user 901 performing a one-time registration process using web or app user interfaces, and providing REM registration information 905 to the REM-RUM service 950. In some examples, the user interfaces for the opt-in process 951 can be provided through an input/output device of an in-vehicle system (e.g., IVS 1301 of FIG. 13) in the vehicle 1310, or using a separate electronic device (e.g., smartphone, desktop, laptop, or the like). As examples, the REM registration information 905 includes a user ID (e.g., driver’s license, authentication credentials, VIN, vehicle license plate number, and/or other identifying data/documents) a REM ID, payment information, and/or other information that allows the REM system to identify the vehicle 1310.

During operation, the vehicle 1310 sends REM-RUM information 915 to the REM server(s) (REM-RUM service 950), and may also store/record 920 the REM-RUM information 915 locally on the vehicle 1310. As examples, the REM-RUM information 915 includes position/location information, REM ID, vehicle data (e.g., operational states of vehicle components, and/or the like), sensor data, and/or the like. Additionally or alternatively, the REM-RUM information 915 includes RUM charging information collected by the RUM trackers 1105, 1205 discussed infra w.r.t FIGS. 10-12.

At the REM-RUM service 950, the position/location is tracked by a position tracking service 953, and the driven route is determined or calculated by a route tracking service 955. For each segment of the route, a road usage authority 980 is determined or identified (e.g., if there is more than one). The information of the travelled route segments is then shared with the appropriate road usage authority 980 responsible for the individual route segments 960. For example, travel routes determined to have taken place on road segments 960a managed by road usage authority 980-A are sent to the road usage authority 980-A, and travel routes determined to have taken place on road segments 960b managed by road usage authority 980-B are sent to the road usage authority 980-B. The road usage authority 980 can then calculate the RUC and directly bill the user 901. In some cases, billing information is not shared with the REM system, but only with the road usage authorities 980. Then the user 901 can register at any authority 980, individually, and share its REM-RUM ID with the REM-RUM service 950.

REM-capable vehicles 1310 may participate in the REM-RUM service 950, but the REM-RUM service 950 is not limited to REM-equipped vehicles 1310 only. First, there are other map providers such as Here Technologies® that provide similar services that operate according to similar principles. Hence, the approaches discussed herein are not tied to REM only, but in general is applicable to all crowed sourcing-based and/or on-the-fly mapping data services. In addition, it might be possible to install either after-market REM devices provided by road usage authorities 980 (e.g., fast-RUC-service equipment that one can rent/buy in many European countries, or toll road transponders provided by many U.S. states). Additionally or alternatively, non-CA/AD vehicles 1310 can register using only their license plate and billing information, and grant the REM-RUM service 950 permission to track such vehicles 1310 using other REM vehicles 1310 with their cameras and/or using roadside sensors. In this case, REM sends a list of granted licenses plates to all REM vehicles 1310 in the relevant region, which then tracks the relevant vehicles 1310 with their sensors (e.g., cameras), and sends position data back to the REM-RUM service 950. As this is an opt-in service 951, every user 901 makes a dedicated decision, ensuring that privacy compliance (e.g., unwanted tracking) is ensured.

### 1.4.1. In-Vehicle Backup Systems

In cases where an RUC invoice is incorrect, for example, if an error occurs while the data is processed in the REM-RUM service 950, the communication with the REM server(s) and the associated timestamps and locations are stored 920 in or by the IVS 1311 of the vehicle 1310. This allows the user 901 to read-out or generate an accounting of travel routes, or at least the REM information 915 that were provided to the REM-RUM service 950 in case of questions and/or to give the user 901 the chance to raise complaints and justify that the invoice is incorrect. In some examples, the REM information 915 is encrypted and read-only from the user-side. Additionally or alternatively, permission or authorization from the REM-RUM service 950 and/or the road usage authorities 980 is required to access the locally stored REM information 915 to avoid user manipulation of data and/or reduce potential harms from data breaches.

### 1.4.2. Fraud Protection Aspects

In some examples, the REM-RUM service 950 and/or the REM equipment implemented by vehicles 1310 include fraud protection mechanisms. The classic mechanism to assure that vehicles 1310 pay tolls on toll roads involves placing toll booths at entry and/or exit ramps of the toll road, and/or placing toll booths at various points along the road. These solutions requires large infrastructure investments, and therefore, does not scale easily, especially for larger road networks.

For automated RUC collection systems, such as the REM-RUM service 950, position information (e.g., REM information 915) is sent to the REM server to calculate accurate road usage charges. These solutions are scalable and allow for toll booths to be removed from existing toll roads, which can drastically reduce the road traffic. However, fraud protection mechanisms may need to be put in place to ensure that the calculation of road usage charges is accurate.

A first example fraudulent activity/behavior includes a vehicle owner/operator disabling communication functionality to prevent sending REM information 915. A second example fraudulent activity/behavior includes manipulating the circuitry and/or the REM information 915 such that fraudulent/inaccurate vehicle position/location data and/or timestamps are sent to pretend that the vehicle 1310 is (or was) driving on road segments without usage charges and/or roads with less expensive fees. Protection against both types of fraudulent behaviors can be achieved with the REM-based system as well. For example, if there is already some monitoring infrastructure available, such as other monitoring systems (e.g., sensors 610) and/or V2I infrastructure (e.g., vehicle on-board sensors and/or the like), it is possible to determine presence of a misbehaving vehicle 1310, which can be used to provide protection against the first example fraudulent activity/behavior. Nevertheless, to determine the exact route of a vehicle 1310, good coverage of the road network would be beneficial.

For the second example fraudulent activity/behavior, referring back to FIG. 5, the ego vehicle 1310 may drive along path 1 but pretend to drive along path 2 because the route along path 2 may have a smaller road usage fee in comparison to the road usage fees of path 1. In this scenario, it may be difficult to prove that the ego vehicle 1310 used path 1. A potential prevention mechanism can include determining the time travelled between the two covered areas 530-1 and 530-2 (since one path may take longer to travel than the other path), but this may not be possible without any information on the traffic density. Here, the REM system can provide valuable information for fraud prevention. In particular, the REM-RUM service 950 can use the REM information 915 provided by multiple REM-equipped vehicles 1310 to generate real-time (or near real-time) traffic statistics about paths 1 and 2. Therefore, the current duration for all possible paths between the covered areas 530-1 and 530-2 can be determined and used to ensure accurate REM information reporting. If a potentially malicious vehicle 1310 reports position information indicating a travel path with a duration that is significantly different than those reported by other vehicles 1310 at the same or similar times/locations, then there is a strong indication of a fraud. This may not be evidence of actual fraud, as there a still possibility for deviation in duration, such as when the driver stopes to take a break. Nevertheless, the deviation can be recorded/stored and reported for further inquiry.

Another fraud protection solution can be established by adding the capability to identify license plates to the REM equipped vehicles 1310, as discussed previously. Then the vehicle 1310 can send together with its presence of other vehicles in its surrounding or proximity (e.g., within a predefined or configured distance from the vehicle 1310). This information can be used to double check any position of other vehicles 1310 for correctness. Also, it can be only used to verify positions of other vehicles that might be identified for a potential fraud with the previously described processes.

### 1.5. Power-Centric Rum

FIG. 10 depicts an example charging-centric RUM approach 1000, which involves monitoring power/energy (kWh) consumption of an ego EV 1310. The charging-centric RUM approach 1000 includes two charging technologies, including direct current (DC) charging technology 1001 including EV supply equipment (EVSE) 1011, and an alternating current (AC) charging technology 1002 including EVSE 1021. The EVSEs 1011, 1021 can be classified according to a charging level. For example, the EVSE 1021 can be a level 1 charger or level 2 charger. Level 1 chargers are usually based on AC power plugs and sockets (e.g., residential wall electrical outlets), and level 2 chargers are usually outside commercial establishments and also can be installed in residential homes. These chargers have charge rates varying from 3.3 kilowatts (kW) to about 80 kW. Additionally or alternatively, the EVSE 1011 can be embodied as a level 3 charger (also referred to as “DC fast charging”) that has the ability to charge the battery 1080 at rates between 80 kW up to 450 kW.

The EVSE 1011 includes a socket outlet 1012a, which is the port on the EVSE 1011 that supplies charging power/energy to the EV 1310 through a plug 1013a and cable 1014a. The cable 1014a is a flexible bundle of conductors that connects the EVSE 1011 with the EV 1310, and the plug 1013a is the end of the flexible cable 1014a that interfaces with the socket outlet 1012a on the EVSE 1011. In North America, the socket outlet 1012a and plug 1013a are not used because the cable is permanently attached to the EVSE 1011. The other end of the cable 1014a includes a connector 1015a that interfaces with a vehicle inlet 1016a. The connector 1015a can be embodied as a Combined Charging System (CCS) connector (e.g., CCS type 1 or type 2, EE/FF (CCS combo ½)), SAE J1772 (AC type 1) connector, Int′l Electrotechnical Commission (IEC) 62196 AC type 2 (“Mennekes”), 62196 AC type 2, IEC 62196 AC type 3 (“Scame”), ChaoJi, Megawatt Charging Systems (MCS), Tesla® North American Charging Standard (NACS) connectors, and/or the like. The vehicle inlet 1016a is a port on the EV 1310 that receives charging power/electricity from the EVSE 1011. The EVSE 1021 also includes a socket outlet 1012b that is configured to receive a plug 1013b, which is attached to a first end of a cable 1014b that also has a connector 1015b that interfaces with a vehicle inlet 1016b. The form factors and/or other aspects of the charging components 1012, 1013, 1014, 1015, 1016 may be different depending on the charging level of the EVSE 1011, 1021. Additionally or alternatively, the form factors and other aspects of the charging components 1012, 1013, 1014, 1015, 1016, and specific charging techniques, may be defined by relevant standards such as, for example, CCS, SAE J1772, SAE J3068, SAE J3105, IEC 62196, IEC 61851, IEC 62196, ISO 15118, Tesla® NACS, CHAdeMO, GB/T standards, and/or the like. Each of these standards also specify the communication protocols used to communicate between the EVSE 1011, 1021 and the vehicle’s power/energy charging circuitry (e.g., OBC 1082 and/or BMS 1084).

In most implementations, the EV 1310 includes a battery 1080 that is charged using DC electricity, while most electricity is delivered from the electrical grid 1050 using AC. For this reason, the EV 1310 also includes an on-board charger (OBC) 1082 that converts AC electricity supplied by an AC charging station (e.g., EVSE 1021) into DC electric power/energy to store it in the rechargeable battery 1080. The battery 1080 can be embodied as one or more battery cells or one or more battery packs. The EV 1310 also includes a battery management system (BMS) 1084, which manages the battery 1080, such as by protecting the battery 1080 from operating outside its safe operating area, monitoring the battery state (e.g., voltage, temperature, coolant flow, current, health of individual cells, state of balance of cells, and the like), calculating measurement values and/or metrics (e.g., “battery parameters”, such as any of those discussed herein) from the battery state, reporting the battery parameters to other components and/or functions data, controlling the battery’s 1080 environment, authenticating the battery 1080, and/or balancing the battery 1080 loads. In implementations where the EVSE 1011 is a level 3 charger, the EVSE 1011 can include one or more DC chargers that facilitates higher power/energy charging, which include relatively large AC-to-DC converters built directly into the EVSE 1011 itself instead of the ego EV 1310 to avoid size and weight restrictions. The EVSE 1011 then supplies DC power/energy to directly to ego EV 1310, bypassing the OBC 1082. In various implementations, the ego EV 1310 can accept both AC and DC power/energy. In various implementations, the OBC 1082 and/or the BMC 1084 corresponds to the battery monitor/charger 2082 of FIG. 20. Additionally or alternatively, the BMC 1084 is connected to user interface devices/circuitry that allows the user to submit authentication information to unlock the BMC 1084 and/or battery 1080 to provide charge. These user interface devices/circuitry can be part of the EVSE 1011, 1021 (e.g., as a keypad or touchscreen on the or attached to the EVSE 1011, 1021) and/or part of the ego EV 1310 (e.g., through an IVS 1311 (e.g., infotainment center), or a connected mobile device).

The EVSE 1011 also includes various HW and SW components to manage the charging process. Additionally, the EVSE 1011 can also include a (wired or wireless) communications interface to communicate with the ego EV 1310 during the charging process. In some implementations, the communications interface is a wireless RAT interface that can operate according to any of the communication protocols/RATs discussed herein. Additionally or alternatively, the communications interface is a wired RAT interface that can be incorporated into the charging cable 1013a, 1013b. In various implementations, the EVSE 1011 also includes a RUM tracking app/function 1105 (also referred to as a “RUM tracker 1105”, “RUC calculator 1105”, and/or the like) that tracks or monitors the amount of power/energy consumed (kWh) during the charging process. In some examples, the RUM tracker 1105 may correspond to the RUM 1305e and/or RUM 1305c discussed herein.

Additionally or alternatively, the ego EV 1310 includes HW and SW components (e.g., OBC 1082 and BMS 1084) to manage the charging process when connected to the EVSE 1021. In various implementations, the ego EV 1310 (or its IVS 1311) also includes a RUM tracking app/function 1205 (also referred to as a “RUM tracker 1205”, “RUC calculator 1205”, and/or the like) that tracks or monitors the amount of power/energy consumed (kWh) during the charging process when connected to the EVSE 1021. In some examples, the RUM tracker 1205 may correspond to the RUM 1305v discussed herein.

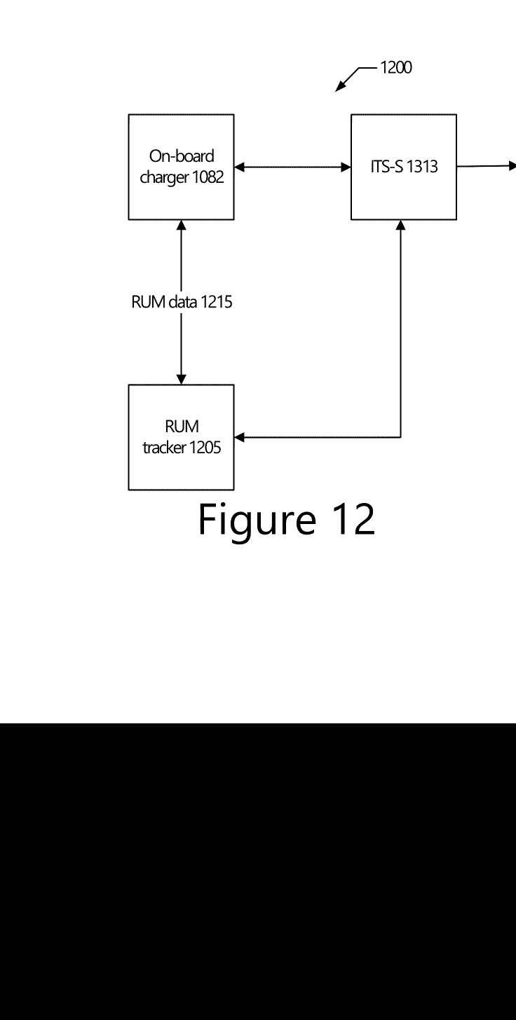

The RUM tracker 1105 operating on the EVSE 1011 and/or the RUM tracker 1200 operating on the ego EV 1310 measures and/or tracks the power/energy consumed during charging from EVSE 1011, 1021. The RUM trackers 1105, 1205 calculate or otherwise determines RUM data (e.g., which may be the same or similar as the RUM information 915) for the vehicle 1310 based on the measured/monitored power/energy supplied to the vehicle 1310 during the charging process. In some implementations, the RUM trackers 1105, 1205 is/are implemented as an app, algorithm, engine, facility, function, and/or other software element at/on the EVSE 1011 and/or on the EV 1310, and does not require additional or upgraded hardware. In some implementations, the ego EV 1310 (or RUM tracker 1200) reports its locally tracked RUM data 1215 (see e.g., FIG. 12) to the EVSE 1011 and/or to a remote system (e.g., edge platform 1340 and/or cloud infrastructure 1390), which is considered by the RUM tracker 1200 to adjust the road usage fees, accordingly. In these ways, the energy consumption/charging-based RUM approach emulates the fuel tax paradigm that are commonly imposed using fuel pump measurement devices at a petrol stations.

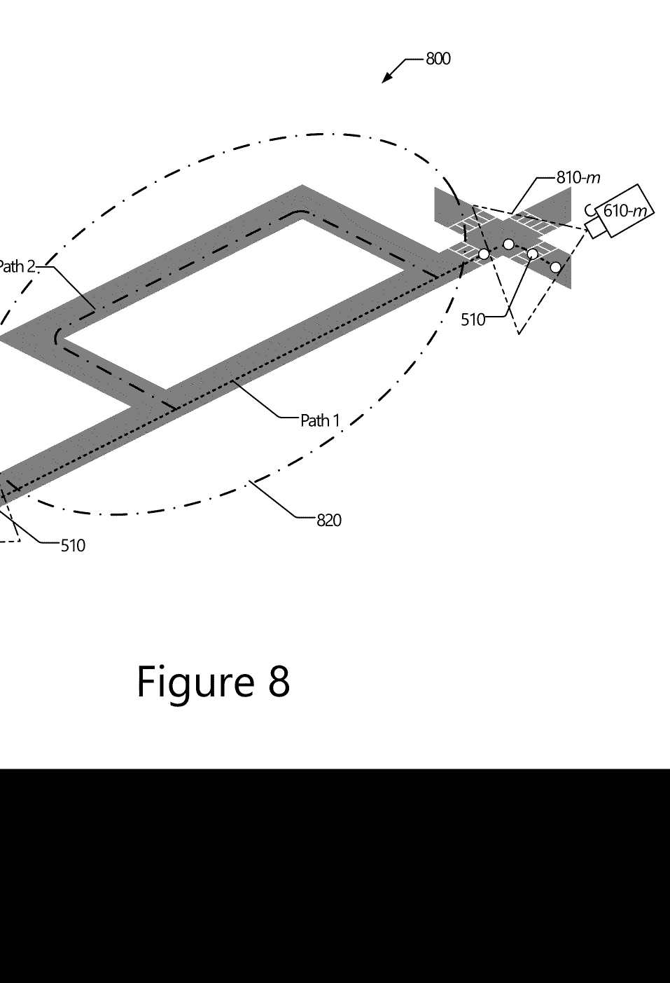

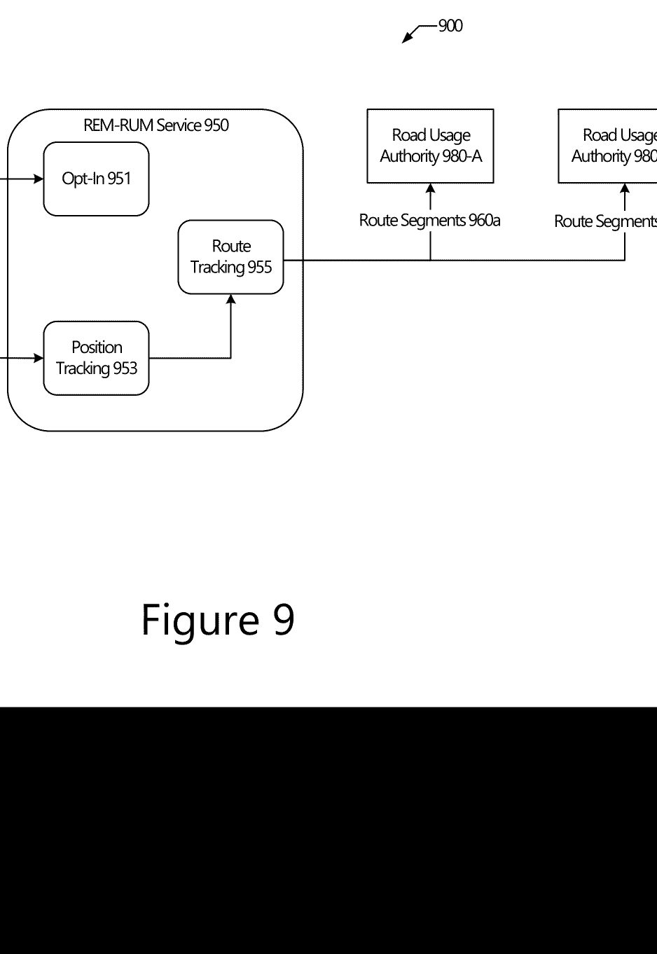

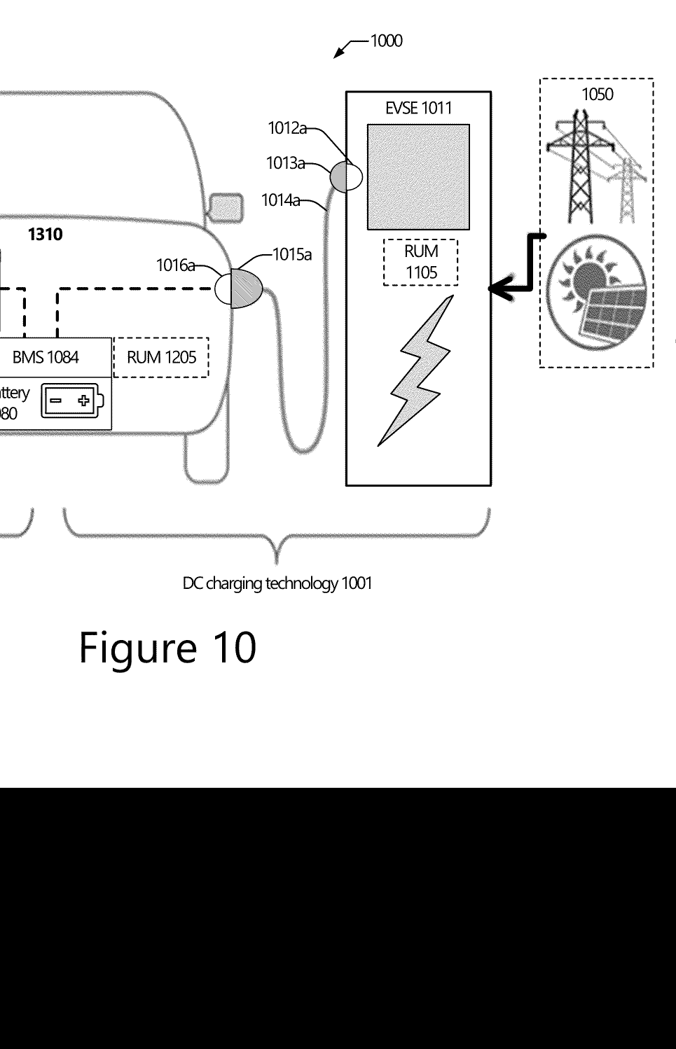

FIG. 11 shows example charging-based RUM tracking system 1100. In this example, the RUM tracking system 1100 includes the RUM tracker 1105 discussed previously, which is communicatively coupled with an EVSE controller 1110 of the EVSE 1011 via any suitable interconnect (IX) and/or communication protocol/access technology, such as any of those discussed herein. The EVSE controller 1110 and the RUM tracker 1105 are also communicatively coupled with an RUC authority 1180 (which may be the same or similar as the road usage authorities 980) using the same or different IXs and/or communication protocol/access technologies. In this example, the RUM tracker 1105 receives RUM parameters/data 1115 from the EVS controller 1110. As examples, the RUM parameters/data 1115 include power/energy consumed (kWh) during the charging process, the EV type, vehicle make and/or model, RUC rate, and/or any other RUM-related data, such as any of those discussed herein.

In some implementations, the RUM tracker 1105 calculates or otherwise determines a RUC for the ego EV 1310 based on the charge amount (e.g., power/energy consumption and/or electricity draw) and/or other data (e.g., subscription data/status, and/or the like), and sends the calculated/determined usage charge to the RUC authority 1180. Additionally or alternatively, the RUM tracker 1105 sends the RUM parameters/data 1115 with or without additional locally stored RUM data, to the RUC authority 1180, and the RUC authority 1180 calculates the RUC based on the received RUM data 1115. In either implementation, the RUC authority 1180 may be a component of the EVSE 1011 and/or the RUC authority 1180 can be implemented as a cloud/edge app operated by a cloud service 1390, edge platform 1340, or some other remote system. In either implementation, the calculated RUC can be sent back to the EVSE controller 1110 and/or the RUM tracker 1105 to be included in the overall bill to be paid by the user at the end of the charging session.

FIG. 12 shows example charging-based RUM tracking system 1200. In this example, the RUM tracking system 1200 includes the RUM tracker 1205 implemented by the ego EV 1310 (or the EV’s 1310 computing platform), which is communicatively coupled with the OBC 1082 and an IVS 1311 and/or an ITS-S 1313. In this example, the ITS-S 1313 may represent an IVS app operated by the IVS 1311, an ITS-S app 1401 operated by the ITS-S 1313 (e.g., infotainment system or the like), or may represent a mobile app operating on a mobile device (e.g., smartphone, tablet, or the like). As discussed in more detail infra, the ITS-S 1313 is also capable of communicating with the cloud system 1390 via a suitable communication interface/RAT, such as any of those discussed herein. In this example, the RUM tracker 1205 securely obtains road usage data 1215 (locally tracked and stored in the vehicle 1310) from the vehicle 1310 via wired/wireless connectivity during the charging process (e.g., when charging using the AC charging technology 1002). In some implementations, the RUM tracker 1205 uses the road usage data 1215 to make any required adjustments to the RUC fees, if any.

In the residential AC charging situation, the RUM tracker 1205 on the vehicle RUM tracker 1205 tracks the road usage based on the power/energy consumed while charging at the EVSE 1021. The OBC 1082 and/or the BMS 1084 include circuitry and/or SW elements to manage the charging process, which can be displayed using HMI elements (e.g., rendering on a screen, audible warnings, haptic/tactile feedback, and/or the like). The RUM tracker 1205 is connected to the OBC 1082 (and/or the BMS 1084) using any suitable IX, communication protocol/access technology, and/or other HW and/or SW interfaces, such as any of those discussed herein. Here, the RUM tracker 1205 obtains the road usage data 1215 from the OBC 1082 (and/or the BMS 1084) via the HW/SW interface. The road usage data 1215 may be the same or similar as the RUM parameters/data 1115 discussed previously, and can include the same or different parameters, measurements, or metrics as the RUM parameters/data 1115.

In some implementations, the RUM tracker 1205 calculates or otherwise determines a RUC for the ego EV 1310 based on the charge amount (power/energy consumption) and/or other data (e.g., subscription data/status, and/or the like), and provides the calculated/determined RUC to the ITS-S 1313 to be delivered to a RUC app server in the cloud 1390 and/or the edge platform 1340. The RUC app server may be the same or similar as the RUC authority 1180 discussed previously. Additionally or alternatively, the RUM tracker 1205 sends the road usage data 1215 with or without additional locally stored RUM data to the RUC app server in the cloud 1390 and/or the edge platform 1340, and the RUC app server calculates the RUC based on the received road usage data 1215. In either implementation, the calculated RUC can be sent back to the ITS-S 1313 and/or the RUM tracker 1205 to be included in the overall bill to be paid by the user at the end of the charging session. For example, the overall bill to be paid at the end of the charging session can be displayed the a vehicle charging app ITS-S app 1401 operating on the IVS 1311, a smartphone app, and/or the like. Additionally, the app 1401 (or smartphone app) may send the RUC to the RUC app server in the cloud 1390 and/or the edge platform 1340 for billing at regular intervals (e.g., weekly, monthly, annually, and/or the like).

### 1.6. Avoidance of Duplicate Rucs

Several different RUM approaches are discussed herein for collecting vehicle 1310 road usage data and enforcing RUC fees. In practice, it is possible that more than one RUM/RUC solution is deployed for better coverage of RUC framework. In that case, mechanisms to ensure that vehicles 1310 are not imposed with duplicate charges, for example, multiple charges to a vehicle through different solutions for same road usage instance.

To avoid duplicate RUCs to vehicles 1310, an edge or cloud service (e.g., managed by relevant RUC/RUM authority, such as any of those discussed herein) that tracks the details of the fees applied to the vehicles 1310, and also provides recommendations on the fee amounts to the fee charging entities. In these implementations, the edge/cloud service logs the data such as, for example, the road usage fees charged to a vehicle 1310, vehicle ID, RUC amount, timestamp when fee is applied/charged, mileage (e.g., actual and/or estimated) in different geo-areas for which the fees is/are applied, geo-area IDs, and/or the actual mileage of a vehicle in different geo-areas along with timestamps. Additionally or alternatively, the bin data 201 can be logged by the edge/cloud service. When the cloud service receives actual mileage info of a vehicle 1310 from multiple different entities (e.g., edge service, EV charging station, infrastructure elements, and/or the like), then the edge/cloud service uses the timestamps and/or other relevant information to detect duplicate RUC/RUM reports. The duplicate RUC/RUM reports may be discarded or can be used to improve the accuracy of information in the RUC/RUM system/service.

Additionally or alternatively, the RUC/RUM authority can first consult with the edge/cloud service before charging a RUC fee to a vehicle 1310 by sending a proposed fee and breakdown of charges. The edge/cloud service can then calculate the actual fee to be charged by considering previous fees charged to the vehicle and actual RUM information/data of the vehicle 1310 previously logged in the database. The cloud service then sends recommended fee to the billing entity. In these ways, not only are duplicate RUC fees avoided, but corrections to defective RUC fees that may occur due to discrepancies in the estimated can be made (e.g., flat RUC fee at EV charging stations and/or the like) and the actual mileages driven by the vehicle 1310.

### 2. Intelligent Transport System (its) Configurations and Arrangements

Intelligent Transport Systems (ITS) comprise advanced apps and services related to different modes of transportation and traffic to enable an increase in traffic safety and efficiency, and to reduce emissions and fuel consumption. Various forms of wireless communications and/or Radio Access Technologies (RATs) may be used for ITS. Cooperative Intelligent Transport Systems (C-ITS) have been developed to enable an increase in traffic safety and efficiency, and to reduce emissions and fuel consumption. The initial focus of C-ITS was on road traffic safety and especially on vehicle safety. C-ITS includes Collective Perception Service (CPS), which supports ITS apps in the road and traffic safety domain by facilitating information sharing among ITS stations.

FIG. 13 illustrates an overview of an vehicular network environment 1300, which includes vehicles 1310a, 1310b, and 1310c (collectively referred to as “vehicle 1310” or “vehicles 1310”), vulnerable road user (VRU) 1316, a network access node (NAN) 1330, edge compute node 1340, and a service provider platform (SPP) 1390 (also referred to as “cloud computing service 1390”, “cloud 1390”, “servers 1390”, or the like). Vehicles 1310a and 1310b are illustrated as motorized vehicles, each of which are equipped with an engine, transmission, axles, wheels, as well as control systems used for driving, parking, passenger comfort and/or safety, and/or the like. The terms “motor”, “motorized”, and/or the like as used herein refer to devices that convert one form of energy into mechanical energy, and include internal combustion engines (ICE), compression combustion engines (CCE), electric motors, and hybrids (e.g., including an ICE/CCE and electric motor(s)), which may utilize any suitable form of fuel. Vehicle 1310c is illustrated as a remote controlled or autonomous flying quadcopter, which can include various components such as, for example, a fuselage or frame, one or more rotors (e.g., either fixed-pitch rotors, variable-pitch rotors, coaxial rotors, and/or the like), one or more motors, a power/energy source (e.g., batteries, hydrogen fuel cells, solar cells, hybrid gas-electric generators, and the like), one or more sensors, and/or other like components (not shown), as well as control systems for operating the vehicle 1310c (e.g., flight controller (FC), flight controller board (FCB), UAV systems controllers, and the like), controlling the on-board sensors, and/or for other purposes. The vehicles 1310a, a10b may represent motor vehicles of varying makes, models, trim, and/or the like, and/or any other type of vehicles, and vehicle 1310c may represent any type of flying drone and/or unmanned aerial vehicle (UAV). Additionally, the vehicles 1310 may correspond to the vehicle computing system 1700 of FIG. 17.

Environment 1300 also includes VRU 1316, which includes a VRU device 1310v (also referred to as “VRU equipment 1310v”, “VRU system 1310v”, or simply “VRU 1310v”). The VRU 1316 is a non-motorized road user, such as a pedestrian, light vehicle carrying persons (e.g., wheelchair users, skateboards, e-scooters, Segways, and/or the like), motorcyclist (e.g., motorbikes, powered two wheelers, mopeds, and/or the like), and/or animals posing safety risk to other road users (e.g., pets, livestock, wild animals, and/or the like). The VRU 1310v includes an ITS-S that is the same or similar as the ITS-S 1313 discussed previously, and/or related hardware components, other in-station services, and sensor sub-systems. The VRU 1310v could be a pedestrian-type VRU device 1310v (e.g., a personal computing system 1800 of FIG. 18, such as a smartphone, tablet, wearable device, and the like), a vehicle-type VRU device 1310v (e.g., a device embedded in or coupled with a bicycle, motorcycle, or the like, or a pedestrian-type VRU device 1310v in or on a bicycle, motorcycle, or the like), or an IoT device (e.g., traffic control devices) used by a VRU 1310v integrating ITS-S technology. Various details regarding VRUs and VAMs are discussed in ETSI TR 103 300-1 v2.1.1 (2019-09) (“[TR103300-1]”), ETSI TS 103 300-2 V0.3.0 (2019-12) (“[TS103300-2]”), and ETSI TS 103 300-3 V0.1.11 (2020-05) (“[TS103300-3]”). For purposes of the present disclosure, the term “VRU 1310v” may to refer to both the VRU 1316 and its VRU device 1310v unless the context dictates otherwise. The various vehicles 1310 referenced throughout the present disclosure, may be referred to as vehicle UEs (vUEs) 1310, vehicle stations 1310, vehicle ITS stations (V-ITS-S) 1310, computer-assisted or autonomous driving (CA/AD) vehicles 1310, drones 1310, robots 1310, and/or the like. Additionally, the term “user equipment 1310”, “UE 1310”, “ITS-S 1310”, “station 1310”, or “user 1310” (either in singular or plural form) may to collectively refer to the vehicle 1310a, vehicle 1310b, vehicle 1310c, and VRU 1310v, unless the context dictates otherwise.

For illustrative purposes, the following description is provided for deployment scenarios including vehicles 1310 in a 2D freeway/highway/roadway environment wherein the vehicles 1310 are automobiles. However, other types of vehicles are also applicable, such as trucks, busses, motorboats, motorcycles, electric personal transporters, and/or any other motorized devices capable of transporting people or goods. In another example, the vehicles 1310 may be robots operating in an industrial environment or the like. 3D deployment scenarios are also applicable where some or all of the vehicles 1310 are implemented as flying objects, such as aircraft, drones, UAVs, and/or to any other like motorized devices. Additionally, for illustrative purposes, the following description is provided where each vehicle 1310 includes in-vehicle systems (IVS) 1311. However, it should be noted that the UEs 1310 could include additional or alternative types of computing devices/systems, such as, for example, smartphones, tablets, wearables, PDAs, pagers, wireless handsets, smart appliances, single-board computers (SBCs) (e.g., Raspberry Pi®, Arduino®, Intel® Edison®, and/or the like), plug computers, laptops, desktop computers, workstations, robots, drones, in-vehicle infotainment system, in-car entertainment system, instrument cluster, head-up display (HUD) device, onboard diagnostic device, on-board unit, dashtop mobile equipment, mobile data terminal, electronic engine management system, electronic/engine control unit, electronic/engine control module, embedded system, microcontroller, control module, and/or any other suitable device or system that may be operable to perform the functionality discussed herein, including any of the computing devices discussed herein.

Each vehicle 1310 includes an IVS 1311, one or more sensors 1312, ITS-S 1313, and one or more driving control units (DCUs) 1314 (also referred to as “electronic control units 1314”, “engine control units 1314”, or “ECUs 1314”). For the sake of clarity, not all vehicles 1310 are labeled as including these elements in FIG. 13. In various implementations, the ITS-S 1313 includes a RUM service entity/element 1305v that is configured to operate aspects of the vehicle-centric RUM approaches and/or the charging-based RUM approaches discussed herein. Additionally or alternatively, the RUM 1305v may correspond to one or more of the RUM apps 1105 and/or 1205 of FIGS. 10-12, the RUM facility 1420 and/or RUM app 1410 of FIG. 14, and/or any other RUM function/element discussed herein. In other implementations, the RUM 1305v may be part of the IVS 1311. Additionally, the VRU 1310v may include the same or similar components and/or subsystems as discussed herein w.r.t any of the vehicles 1310, such as the sensors 1312 and ITS-S 1313. The IVS 1300 includes a number of vehicle computing hardware subsystems and/or apps including, for example, instrument cluster subsystems, a head-up display (HUD) subsystem, infotainment/media subsystems, a vehicle status subsystem, a navigation subsystem (NAV), artificial intelligence and/or machine learning (AI/ML) subsystems, and/or other subsystems. The NAV provides navigation guidance or control, depending on whether vehicle 1310 is a computer-assisted vehicle, or an autonomous driving vehicle. The NAV may include or access computer vision functionality of the and/or the AI/ML subsystem to recognize stationary or moving objects based on sensor data collected by sensors 1312, and may be capable of controlling DCUs 1314 based on the recognized objects.

The UEs 1310 also include an ITS-S 1313 that employs one or more Radio Access Technologies (RATs) to allows the UEs 1310 to communicate directly with one another and/or with infrastructure equipment (e.g., network access node (NAN) 1330). In some examples, the ITS-S 1313 corresponds to the ITS-S 1400 of FIG. 14. The one or more RATs may refer to cellular V2X (C-V2X) RATs (e.g., V2X technologies based on 3GPP LTE, 5G/NR, and beyond), a WLAN V2X (W-V2X) RAT (e.g., V2X technologies based on DSRC in the USA and/or ITS-G5 in the EU), and/or some other RAT, such as any of those discussed herein.

For example, the ITS-S 1313 utilizes respective connections (also referred to as “channels” or “links”) 1320a, 1320b, 1320c, 1320v to communicate data (e.g., transmit and receive) data with the NAN 1330. The connections 1320a, 1320b, 1320c, 1320v are illustrated as an air interface to enable communicative coupling consistent with one or more communications protocols, such as any of those discussed herein. The ITS-Ss 1313 can directly exchange data with one another via respective direct links 1323ab, 1323bc, 1323vc, each of which may be based on 3GPP or C-V2X RATs (e.g., LTE/NR Proximity Services (ProSe) link, PC5 links, sidelink channels, LTE/5G Uu interface, and/or the like), IEEE or W-V2X RATs (e.g., WiFi-direct, [IEEE80211p], IEEE 802.11bd, [IEEE802154], ITS-G5, DSRC, WAVE, and/or the like), or some other RAT (e.g., Bluetooth®, and/or the like). The ITS-Ss 1313 exchange ITS protocol data units (PDUs) (e.g., CAMs, CPMs, DENMs, misbehavior reports, and/or the like) and/or other messages with one another over respective links 1323 and/or with the NAN 1330 over respective links 1320.

The ITS-S 1313 are also capable of collecting or otherwise obtaining radio information, and providing the radio information to the NAN 1330, the edge compute node 1340, and/or the SPP/cloud 1390. The radio information may be in the form of one or more measurement reports, and/or may include, for example, signal strength measurements, signal quality measurements, and/or the like. Each measurement report is tagged with a timestamp and the location of the measurement (e.g., the current location of the ITS-S 1313 or UE 1310). The radio information may be used for various purposes including, for example, cell selection, handover, network attachment, testing, and/or other purposes. As examples, the measurements collected by the UEs 1310 and/or included in the measurement reports may include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (Eb/N0), energy per chip to interference power density ratio (Ec/I0), energy per chip to noise power density ratio (Ec/N0), peak-to-average power ratio (PAPR), reference signal received power (RSRP), reference signal received quality (RSRQ), received signal strength indicator (RSSI), received channel power indicator (RCPI), received signal to noise indicator (RSNI), Received Signal Code Power (RSCP), average noise plus interference (ANPI), GNSS timing of cell frames for UE positioning for E-UTRAN or 5G/NR (e.g., a timing between an AP or RAN node reference time and a GNSS-specific reference time for a given GNSS), GNSS code measurements (e.g., the GNSS code phase (integer and fractional parts) of the spreading code of the ith GNSS satellite signal), GNSS carrier phase measurements (e.g., the number of carrier-phase cycles (integer and fractional parts) of the ith GNSS satellite signal, measured since locking onto the signal; also called Accumulated Delta Range (ADR)), channel interference measurements, thermal noise power measurements, received interference power measurements, power histogram measurements, channel load measurements, STA statistics, and/or other like measurements. The RSRP, RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g., LTE or 5G/NR), and RSRP, RSSI, RSRQ, RCPI, RSNI, and/or ANPI measurements of various beacon, Fast Initial Link Setup (FILS) discovery frames, or probe response frames for WLAN/WiFi (e.g., [IEEE80211]) networks. Other measurements may be additionally or alternatively used, such as those discussed in 3GPP TS 36.214 v16.2.0 (2021-03-31) (“[TS36214]”), 3GPP TS 38.215 v16.4.0 (2021-01-08) (“[TS38215]”), 3GPP TS 38.314 v16.4.0 (2021-09-30) (“[TS38314]”), IEEE Standard for Information Technology-Telecommunications and Information Exchange between Systems - Local and Metropolitan Area Networks--Specific Requirements - Part 11: Wireless LAN Medium Access Control (MAC) and Physical Layer (PHY) Specifications, IEEE Std 802.11-2020, pp.1-4379 (26 Feb. 2021) (“[IEEE80211]”), and/or the like. Additionally or alternatively, any of the aforementioned measurements (or combination of measurements) may be collected by the NAN 1330 and provided to the edge compute node(s) 1340, cloud compute node(s) 1390 (or app server(s) 1390). The measurements/metrics can also be those defined by other suitable specifications/standards, such as 3GPP (e.g., [SA6Edge]), ETSI (e.g., [MEC]), O-RAN (e.g., [O-RAN]), Intel® Smart Edge Open (formerly OpenNESS) (e.g., [ISEO]), IETF (e.g., [MEC]), IEEE/WiFi (e.g., [IEEE80211], [WiMAX], [IEEE16090], and/or the like), and/or any other like standards such as those discussed elsewhere herein. Some or all of the UEs 1310 can include positioning circuitry (e.g., positioning circuitry 2043 of FIG. 20) to (coarsely) determine their respective geolocations and communicate their current position with one another and/or with the NAN 1330 in a secure and reliable manner. This allows the UEs 1310 to synchronize with one another and/or with the NAN 1330.

The DCUs 1314 include hardware elements that control various (sub)systems of the vehicles 1310, such as the operation of the engine(s)/motor(s), transmission, steering, braking, rotors, propellers, servos, and/or the like. DCUs 1314 are embedded systems or other like computer devices that control a corresponding system of a vehicle 1310. The DCUs 1314 may each have the same or similar components as compute node 2000 of FIG. 20 discussed infra, or may be some other suitable microcontroller or other like processor device, memory device(s), communications interfaces, and the like. Additionally or alternatively, one or more DCUs 1314 may be the same or similar as the actuators 2044 of FIG. 20. Furthermore, individual DCUs 1314 are capable of communicating with one or more sensors 1312 and one or more actuators 2044 within the UE 1310.

The sensors 1312 are hardware elements configurable or operable to detect an environment surrounding the vehicles 1310 and/or changes in the environment. The sensors 1312 are configurable or operable to provide various sensor data to the DCUs 1314 and/or one or more AI agents to enable the DCUs 1314 and/or one or more AI agents to control respective control systems of the vehicles 1310. In particular, the IVS 1311 may include or implement a facilities layer and operate one or more facilities within the facilities layer. The sensors 1312 include(s) devices, modules, and/or subsystems whose purpose is to detect events or changes in its environment and send the information (sensor data) about the detected events to some other a device, module, subsystem, and/or the like. Some or all of the sensors 1312 may be the same or similar as the sensor circuitry 2042 of FIG. 20.

The NAN 1330 is a network element that is part of an access network that provides network connectivity to the UEs 1310 via respective interfaces/links 1320. In V2X scenarios, the NAN 1330 may be or act as an road side unit (RSU) or roadside (R-ITS-S), which refers to any transportation infrastructure entity used for V2X communications. In these scenarios, the NAN 1330 includes an ITS-S that is the same or similar as ITS-S 1313 and/or may be the same or similar as the roadside infrastructure system 1900 of FIG. 19.

The access network may be Radio Access Networks (RANs) such as an NG-RAN or a 5G RAN for a RAN that operates in a 5G/NR cellular network, an E-UTRAN for a RAN that operates in an LTE or 4G cellular network, a legacy RAN such as a UTRAN or GERAN for GSM or CDMA cellular networks, an Access Service Network for WiMAX implementations, and/or the like. All or parts of the RAN may be implemented as one or more RAN functions (RANFs) or other software entities running on server(s) as part of a virtual network, which may be referred to as a cloud RAN (CRAN), Cognitive Radio (CR), a virtual RAN (vRAN), RAN intelligent controller (RIC), and/or the like. The RAN may implement a split architecture wherein one or more communication protocol layers are operated by the RANF or controller and other communication protocol entities are operated by individual NANs 1330. In either implementation, the NAN 1330 can include ground stations (e.g., terrestrial access points) and/or satellite stations to provide network connectivity or coverage within a geographic area (e.g., a cell). The NAN 1330 may be implemented as one or more dedicated physical devices such as a macrocell base stations and/or a low power base station for providing femtocells, picocells, or other like cells having smaller coverage areas, smaller user capacity, or higher bandwidth compared to macrocells.

As alluded to previously, the RATs employed by the NAN 1330 and the UEs 1310 may include any number of V2X RATs may be used for V2X communication, which allow the UEs 1310 to communicate directly with one another, and/or communicate with infrastructure equipment (e.g., NAN 1330). As examples, the V2X RATs can include a WLAN V2X (W-V2X) RAT based on IEEE V2X technologies and a cellular V2X (C-V2X) RAT based on 3GPP technologies. The C-V2X RAT may be based on any suitable 3GPP standard including any of those mentioned herein. The W-V2X RATs include, for example, IEEE Guide for Wireless Access in Vehicular Environments (WAVE) Architecture, IEEE Std 1609.0-2019, pp.1-106 (10 Apr. 2019) (“[IEEE16090]”), V2X Communications Message Set Dictionary, SAE Std J2735_202211 (14 Nov. 2022) (“[J2735]”), Intelligent Transport Systems in the 5 GHz frequency band (ITS-G5), the [IEEE80211p] (which is the layer 1 (L1) and layer 2 (L2) part of WAVE, DSRC, and ITS-G5), and sometimes IEEE Standard for Air Interface for Broadband Wireless Access Systems, IEEE Std 802.16-2017, pp.1-2726 (2 Mar. 2018) (sometimes referred to as “Worldwide Interoperability for Microwave Access” or “WiMAX”) (“[WiMAX]”). The term “DSRC” refers to vehicular communications in the 5.9 GHz frequency band that is generally used in the United States, while “ITS-G5” refers to vehicular communications in the 5.9 GHz frequency band in Europe. Since any number of different RATs are applicable (including [IEEE80211p]-based RATs) that may be used in any geographic or political region, the terms “DSRC” (used, among other regions, in the U.S.) and “ITS-G5” (used, among other regions, in Europe) may be used interchangeably throughout this disclosure. The access layer for the ITS-G5 interface is outlined in ETSI EN 302 663 V1.3.1 (2020-01) (“[EN302663]”) and describes the access layer of the ITS-S reference architecture 1400. The ITS-G5 access layer comprises [IEEE80211] (which now incorporates [IEEE80211p]) and/or IEEE/ISO/IEC 88Feb. 2, 1998 protocols, as well as features for Decentralized Congestion Control (DCC) methods discussed in ETSI TS 102 687 V1.2.1 (2018-04) (“[TS102687]”). The access layer for 3GPP C-V2X based interface(s) is outlined in, inter alia, ETSIEN 303 613 V1.1.1 (2020-01), 3GPP TS 23.285 v17.0.0 (2022-03-29) (“[TS23285]”); and 3GPP 5G/NR-V2X is outlined in, inter alia, 3GPP TR 23.786 v16.1.0 (2019-06) and 3GPP TS 23.287 v17.2.0 (2021-12-23) (“[TS23287]”).

The NAN 1330 and/or an edge compute node 1340 may provide one or more services/capabilities 1380. In an example implementation, RSU 1330 is a computing device coupled with radio frequency circuitry located on a roadside that provides connectivity support to passing UEs 1310. The RSU 1330 may also include internal data storage circuitry to store intersection map geometry, traffic statistics, media, as well as apps/software to sense and control ongoing vehicular and pedestrian traffic. The RSU 1330 provides various services/capabilities 1380 such as, for example, very low latency communications required for high speed events, such as crash avoidance, traffic warnings, and the like. Additionally or alternatively, the RSU 1330 may provide other services/capabilities 1380 such as, for example, cellular/WLAN communications services. In various implementations, the services/capabilities 1380 provided by the NAN 1330 includes a RUM service (which may be the same or similar as the RUM service entity/elements 1305e and/or 1305c provided by the edge compute node 1340 and/or the SPP 1390) that is configured to operate aspects of the infrastructure-centric RUM approaches and/or the charging-based RUM approaches discussed herein. In some implementations, the RUM service provided by the NAN 1330 is implemented or embodied as a RAN function that interacts with other RAN functions of the NAN 1330. Additionally or alternatively, the RUM service provided by the NAN 1330 may correspond to one or more of the REM-RUM service 950, RUM apps 1105 and/or 1205 of FIGS. 10-12, the RUM facility 1420 and/or RUM app 1410 of FIG. 14, and/or any other RUM function/element discussed herein. In some implementations, the components of the RSU 1330 may be packaged in a weatherproof enclosure suitable for outdoor installation, and may include a network interface controller to provide a wired connection (e.g., Ethernet [IEEE802.3] or the like) to a traffic signal controller and/or a backhaul network. Further, RSU 1330 may include wired or wireless interfaces to communicate with other RSUs 1330 (not shown by FIG. 13).

The network 1365 may represent a network such as the Internet, a wireless local area network (WLAN), or a wireless wide area network (WWAN), a cellular core network, a backbone network, an edge computing network, a cloud computing service, a data network (DN), proprietary and/or enterprise networks for a company or organization, and/or combinations thereof. As examples, the network 1365 and/or access technologies may include cellular technology (e.g., 3GPP LTE, NR/5G, MuLTEfire, WiMAX, and so forth), WLAN (e.g., WiFi and the like), and/or any other suitable access technology, such as any of those discussed herein.

The SPP 1390 may represent one or more app servers, a cloud computing service that provides cloud computing services, and/or some other remote infrastructure. The SPP 1390 may include any one of a number of services and capabilities 1380 such as, for example, ITS-related apps and services, driving assistance (e.g., mapping/navigation), content (e.g., multi-media infotainment) streaming services, social media services, and/or any other services. In various implementations, the services/capabilities 1380 provided by the SPP 1390 includes a RUM service 1305c that is configured to operate aspects of the infrastrucure-centric RUM approaches and/or the charging-based RUM approaches discussed herein. In some implementations, the RUM service 1305c is implemented or embodied as an application function and/or a cloud computing service that interacts with other apps/functions/services 1380 provided by the SPP 1390. Additionally or alternatively, the RUM service 1305c may correspond to one or more of the REM-RUM service 950, RUM apps 1105 and/or 1205 of FIGS. 10-12, the RUM facility 1420 and/or RUM app 1410 of FIG. 14, and/or any other RUM function/element discussed herein. Additionally or alternatively, the SPP 1390 provides geographic mapping services and/or spatial analysis service. In some examples, the SPP 1390 is, or operates, a tile map service (TMS) server, an ArcGIS server, and/or some other mapping app(s) and/or service(s). Additionally or alternatively, the SPP 1390 provides geographic mapping services and/or spatial analysis, and/or location-based services, such as any of those discussed herein. that is configured to operate aspects of the vehicle-centric RUM approaches and/or the charging-based RUM approaches discussed herein. Additionally or alternatively, the RUM 1305v may correspond to one or more of the RUM apps 1105 and/or 1205 of FIGS. 10-12, the RUM facility 1420 and/or RUM app 1410 of FIG. 14, and/or any other RUM function/element discussed herein

An edge compute node 1340 (or a collection of edge compute nodes 1340 as part of an edge network or “edge cloud”) is colocated with the NAN 1330. The edge compute node 1340 includes an edge platform (also referred to as “edge platform 1340”) may provide any number of services/capabilities 1380 to UEs 1310, which may be the same or different than the services/capabilities 1380 provided by the service provider platform 1390. For example, the services/capabilities 1380 provided by edge compute node 1340 can include a distributed computing environment for hosting apps and services, and/or providing storage and processing resources so that data and/or content can be processed in close proximity to subscribers (e.g., UEs 1310). The edge compute node 1340 also supports multitenancy run-time and hosting environment(s) for apps, including virtual appliance apps that may be delivered as packaged virtual machine (VM) images, middleware and infrastructure services, cloud-computing capabilities, IT services, content delivery services including content caching, mobile big data analytics, and computational offloading, among others. Computational offloading involves offloading computational tasks, workloads, apps, and/or services to the edge compute node 1340 from the UEs 1310, core network, cloud service, and/or server(s) 1390, or vice versa. For example, a device app or client app operating in a ITS-S 1310 may offload app tasks or workloads to one or more edge servers 1340. In another example, an edge server 1340 may offload app tasks or workloads to one or more UEs 1310 (e.g., for distributed ML computation or the like). In various implementations, the services/capabilities 1380 provided by the edge compute node 1340 includes a RUM service 1305e that is configured to operate aspects of the infrastrucure-centric RUM approaches and/or the charging-based RUM approaches discussed herein. In some implementations, the RUM service 1305e is implemented or embodied as an application function and/or a cloud computing service that interacts with other apps/functions/services 1380 provided by the edge compute node 1340. Additionally or alternatively, the RUM service 1305e may correspond to one or more of the REM-RUM service 950, RUM apps 1105 and/or 1205 of FIGS. 10-12, the RUM facility 1420 and/or RUM app 1410 of FIG. 14, and/or any other RUM function/element discussed herein.

The edge compute node 1340 includes or is part of an edge computing network (or edge cloud) that employs one or more edge computing technologies (ECTs). In one example implementation, the ECT is and/or operates according to the MEC framework, as discussed in ETSI GR MEC 001 v3.1.1 (2022-01), ETSI GS MEC 003 v3.1.1 (2022-03), ETSI GS MEC 009 v3.1.1 (2021-06), ETSI GS MEC 010-1 v1.1.1 (2017-10), ETSI GS MEC 010-2 v2.2.1 (2022-02), ETSI GS MEC 011 v2.2.1 (2020-12), ETSI GS MEC 012 V2.2.1 (2022-02), ETSI GS MEC 013 V2.2.1 (2022-01), ETSI GS MEC 014 v2.1.1 (2021-03), ETSI GS MEC 015 v2.1.1 (2020-06), ETSI GS MEC 016 v2.2.1 (2020-04), ETSI GS MEC 021 v2.2.1 (2022-02), ETSI GR MEC 024 v2.1.1 (2019-11), ETSI GS MEC 028 V2.2.1 (2021-07), ETSI GS MEC 029 v2.2.1 (2022-01), ETSI MEC GS 030 v2.1.1 (2020-04), and ETSI GR MEC 031 v2.1.1 (2020-10) (collectively referred to herein as “[MEC]”), the contents of each of which are hereby incorporated by reference in their entireties.

In another example implementation, the ECT is and/or operates according to the Open RAN alliance (“O-RAN”) framework, as described in O-RAN Architecture Description v07.00, O-RAN ALLIANCE WG1 (October 2022); O-RAN Working Group 2 AI/ML workflow description and requirements v01.03 O-RAN ALLIANCE WG2 (October 2021); O-RAN Working Group 2 Non-RTRIC: Functional Architecture v01.01, O-RAN ALLIANCE WG2 (June 2021); O-RAN Working Group 3 Near-Real-time RAN Intelligent Controller Architecture & E2 General Aspects and Principles v02.02 (July 2022); O-RAN Working Group 3 Near-Real-time Intelligent Controller E2 Service Model (E2SM) v02.01 (March 2022); and/or any other O-RAN standard/specification (collectively referred to as “[O-RAN]”) the contents of each of which are hereby incorporated by reference in their entireties.

In another example implementation, the ECT is and/or operates according to the 3rd Generation Partnership Project (3GPP) System Aspects Working Group 6 (SA6) Architecture for enabling Edge Applications (referred to as “3GPP edge computing”) as discussed in 3GPP TS 23.558 v1.2.0 (2020-12-07) (“[TS23558]”), 3GPP TS 23.501 v17.6.0 (2022-09-22) (“[TS23501]”), 3GPP TS 23.548 v17.4.0 (2022-09-22) (“[TS23548]”), and U.S. App. No. 17/484,719 filed on 24 Sep. 2021 (“[‘719]”) (collectively referred to as “[SA6Edge]”), the contents of each of which are hereby incorporated by reference in their entireties.

In another example implementation, the ECT is and/or operates according to the Intel® Smart Edge Open framework (formerly known as OpenNESS) as discussed in Intel® Smart Edge Open Developer Guide, version 21.09 (30 Sep. 2021), available at: https://smart-edge-open.github.io/ (“[ISEO]”), the contents of which is hereby incorporated by reference in its entirety.

In another example implementation, the ECT operates according to the Multi-Access Management Services (MAMS) framework as discussed in Kanugovi et al., Multi-Access Management Services (MAMS), INTERNET ENGINEERING TASK FORCE (IETF), Request for Comments (RFC) 8743 (March 2020), Ford et al., TCP Extensions for Multipath Operation with Multiple Addresses, IETF RFC 8684, (March 2020), De Coninck et al., Multipath Extensions for QUIC (MP-QUIC), IETF DRAFT-DECONINCK-QUIC-MULTIPATH-07, IETA, QUIC Working Group (03-May-2021), Zhu et al., User-Plane Protocols for Multiple Access Management Service, IETF DRAFT-ZHU-INTAREA-MAMS-USER-PROTOCOL-09, IETA, INTAREA (04-Mar-2020), and Zhu et al., Generic Multi-Access (GMA) Convergence Encapsulation Protocols, IETF RFC 9188 (February 2022) (collectively referred to as “[MAMS]”), the contents of each of which are hereby incorporated by reference in their entireties.

Any of the aforementioned example implementations, and/or in any other example implementation discussed herein, may also include one or more virtualization technologies, such as those discussed in ETSI GR NFV 001 V1.3.1 (2021-03); ETSI GS NFV 002 V1.2.1 (2014-12); ETSI GR NFV 003 V1.6.1 (2021-03); ETSI GS NFV 006 V2.1.1 (2021-01); ETSI GS NFV-INF 001 V1.1.1 (2015-01); ETSI GS NFV-INF 003 V1.1.1 (2014-12); ETSI GS NFV-INF 004 V1.1.1 (2015-01); ETSI GS NFV-MAN 001 v1.1.1 (2014-12); Israel et al., OSM Release FIVE Technical Overview, ETSI OPEN SOURCE MANO, OSM White Paper, 1st ed. (January 2019); E2E Network Slicing Architecture, GSMA, Official Doc. NG.127, v1.0 (03 Jun. 2021); Open Network Automation Platform (ONAP) documentation, Release Istanbul, v9.0.1 (17 Feb. 2022); 3GPP Service Based Management Architecture (SBMA) as discussed in 3GPP TS 28.533 v17.1.0 (2021-12-23) (“[TS28533]”); the contents of each of which are hereby incorporated by reference in their entireties.

It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge networks/ECTs described herein. Further, the techniques disclosed herein may relate to other IoT ECTs, edge networks, and/or and configurations, and other intermediate processing entities and architectures may also be applicable to the present disclosure. For example, many ECTs and/or edge networking technologies may be applicable to the present disclosure in various combinations and layouts of devices located at the edge of a network. Examples of such edge computing/networking technologies include [MEC]; [O-RAN]; [ISEO]; [SA6Edge]; Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used for purposes of the present disclosure.

### 2.1. Collective Perception Services

As alluded to previously, CPS supports ITS apps in the domain of road and traffic safety by facilitating information sharing among ITS-Ss. Collective Perception reduces the ambient uncertainty of an ITS-S about its current environment, as other ITS-Ss contribute to context information. By reducing ambient uncertainty, it improves efficiency and safety of the ITS. Aspects of CPS are described in ETSI TS 103 324 v.0.0.44 (2022-11) (“[TS103324]”), the contents of which is hereby incorporated by reference in its entirety.

CPS provides syntax and semantics of Collective Perception Messages (CPM) and specification of the data and message handling to increase the awareness of the environment in a cooperative manner. CPMs are exchanged in the ITS network between ITS-Ss to share information about the perceived environment of an ITS-S such as the presence of road users, other objects, and perceived regions (e.g., road regions that together with the contained object allow receiving ITS-Ss to determine drivable areas that are free from road users and collision-relevant objects). This allows CPS-enabled ITS-Ss to enhance their environmental perception not only regarding non-V2X-equipped road users and drivable regions, but also increasing the number of information sources for V2X-equipped road users. A higher number of independent sources generally increases trust and leads to a higher precision of the environmental perception.

A CPM contains a set of detected objects and regions, along with their observed status and attribute information. The content may vary depending on the type of the road user or object and the detection capabilities of the originating ITS-S. For detected objects, the status information is expected to include at least the detection time, position, and motion state. Additional attributes such as the dimensions and object type may be provided. To support the CPM interpretation at any receiving ITS-S, the sender can also include information about its sensors, like sensor types and fields of view.

In some cases, the detected road users or objects are potentially not equipped with an ITS-S themselves. Such non-ITS-S equipped objects cannot make other ITS-Ss aware of their existence and current state and can therefore not contribute to the cooperative awareness. A CPM contains status and attribute information of these non-ITS-S equipped users and objects that have been detected by the originating ITS sub-system. The content of a CPM is not limited to non-ITS-S equipped objects but may also include measured status information about ITS-S equipped road users. The content may vary depending on the type of the road user or object and the detection capabilities of the originating ITS sub-system. For vehicular objects, the status information is expected to include at least the actual time, position and motion state. Additional attributes such as the dimensions, vehicle type and role in the road traffic may be provided.

The CPM complements the Cooperative Awareness Message (CAM) (see e.g., ETSI EN 302 637-2 v1.4.1 (2019-04) (“[EN302637-2]”)) to establish and increase cooperative awareness. The CPM contains externally observable information about detected road users or objects and/or free space. The CP service may include methods to reduce duplication of CPMs sent by different ITS-Ss by checking for sent CPMs of other stations. On reception of a CPM, the receiving ITS-S becomes aware of the presence, type, and status of the recognized road user or object that was detected by the transmitting ITS-S. The received information can be used by the receiving ITS-S to support ITS apps to increase the safety situation and to improve traffic efficiency or travel time. For example, by comparing the status of the detected road user or received object information, the receiving ITS-S sub-system is able to estimate the collision risk with such a road user or object and may inform the user via the HMI of the receiving ITS sub-system or take corrective actions automatically. Multiple ITS apps may rely on the data provided by CPS. It is assigned to domain app support facilities in ETSI TS 102 894-1 v1.1.1 (2013-08) (“[TS102984-1]”). Additionally, CPM contents, structure, format, generation rules and processes, as well as various other aspects of CPMs are discussed in U.S. App. No. 18/079,499 filed on Dec. 12, 2022 (“[‘499]”), the contents of which are hereby incorporated by reference in its entirety and for all purposes.

On reception of a CPM, the receiving (Rx) ITS-S becomes aware of the presence, type, and status of the recognized road user, object, and/or region that was detected by the transmitting (Tx) ITS-S. The received information can then be used by the Rx ITS-S to support ITS apps to increase the safety situation and to improve traffic efficiency or travel time. For example, by comparing the status of the detected road user or received object information, the Rx ITS-S can estimate the collision risk with that road user or object and may inform the user via the HMI of the Rx ITS-S or take corrective actions automatically. Multiple ITS apps may thereby rely on the data provided by the CPS.

FIG. 14 shows an ITS-S reference architecture 1400. Some or all of the components depicted by FIG. 14 follows the ITSC protocol, which is based on the principles of the OSI model for layered communication protocols extended for ITS apps. The ITSC 1400 includes an access layer 1404 that corresponds with the OSI layers 1 and 2, a networking & transport (N&T) layer 1403 that corresponds with OSI layers 3 and 4, the facilities layer which corresponds with OSI layers 5, 6, and at least some functionality of OSI layer 7, and an apps layer 1401 that corresponds with some or all of OSI layer 7. Each of these layers are interconnected via respective observable interfaces, service access points (SAPs), APIs, and/or other like connectors or interfaces (see e.g., ETSI EN 302 665 v1.1.1 (2010-09) and ETSI TS 103 898 (“[TS103898]”)). The interconnections in this example include the MF-SAP, FA-SAP, NF-SAP, and SF-SAP.

The apps layer 1401 provides ITS services, and ITS apps are defined within the app layer 1401. An ITS app is an app layer entity that implements logic for fulfilling one or more ITS use cases. An ITS app makes use of the underlying facilities and communication capacities provided by the ITS-S. Each app can be assigned to one of the three identified app classes: (active) road safety, (cooperative) traffic efficiency, cooperative local services, global internet services, and other apps (see e.g., [EN302663]), ETSI TR 102 638 V1.1.1 (2009-06) (“[TR102638]”); and ETSI TS 102 940 v1.3.1 (2018-04), ETSI TS 102 940 v2.1.1 (2021-07) (collectively “[TS102940]”)). A V-ITS-S 1310 provides ITS apps to vehicle drivers and/or passengers, and may require an interface for accessing in-vehicle data from the in-vehicle network or IVS 1301 (see e.g., FIG. 13). Similarly, a P-ITS-S 1310v and/or an R-ITS-S 1330 provides ITS apps to users, which may require an interface for accessing ITS-S data from the ITS-S network or the like. For deployment and performances needs, specific instances of a ITS-Ss 1310, 1330 contains groupings of ITS apps and/or facilities. Examples of ITS apps may include driving assistance for cooperative awareness (CA), driving assistance for road hazard warnings (RHW), Automatic Emergency Braking (AEB), Forward Collision Warning (FCW), cooperative adaptive cruise control (CACC), control loss warning (CLW), queue warning, Automated Parking System (APS), pre-crash sensing warning, cooperative Speed Management (CSM) (e.g., curve speed warning and the like), mapping and/or navigation apps (e.g., turn-by-turn navigation and cooperative navigation), cooperative navigation (e.g. platooning and the like), location based services (LBS), community services, ITS-S lifecycle management services, transport related electronic financial transactions, and the like. In some implementations, the ITS apps 1401 includes a RUM tracking app 1410 that collects and reports RUM information according to the various examples discussed herein. Additionally or alternatively, the RUM tracking app 1410 corresponds to the RUC tracker 1010a and/or RUM tracker 1010b. In these implementations, the RUM tracking app 1410 provides RUM information to the RUM facility 1420 (if implemented in the facilities layer 1402) and/or the CPS 1421 to include the RUM information in a suitable CPM or another facility to include the RUM information in another ITS message format.

The facilities layer 1402 comprises middleware, software connectors, software glue, or the like, comprising multiple facility layer functions (or simply a “facilities”). In particular, the facilities layer contains functionality from the OSI app layer, the OSI presentation layer (e.g., ASN.1 encoding and decoding, and encryption) and the OSI session layer (e.g., inter-host communication). A facility is a component that provides functions, information, and/or services to the apps in the app layer and exchanges data with lower layers for communicating that data with other ITS-Ss. C-ITS facility services can be used by ITS Apps. Examples of these facility services include: Cooperative Awareness (CA) provided by cooperative awareness basic service (CABS) facility (see e.g., [EN302637-2]) to create and maintain awareness of ITS-Ss and to support cooperative performance of vehicles using the road network; Decentralized Environmental Notification (DEN) provided by the DEN basic service (DENBS) facility to alert road users of a detected event using ITS communication technologies; Cooperative Perception (CP) provided by a CP services (CPS) facility 1421 (see e.g., [TS103324]) complementing the CA service to specify how an ITS-S can inform other ITS-Ss about the position, dynamics and attributes of detected neighboring road users and other objects; Multimedia Content Dissemination (MCD) to control the dissemination of information using ITS communication technologies; VRU awareness provided by a VRU basic service (VBS) facility to create and maintain awareness of vulnerable road users participating in the VRU system; Interference Management Zone to support the dynamic band sharing in co-channel and adjacent channel scenarios between ITS stations and other services and apps; Diagnosis, Logging and Status for maintenance and information purposes; Positioning and Time management (PoTi) provided by a PoTi facility 1422 that provides time and position information to ITS apps and services; Decentralized Congestion Control (DCC) facility (DCC-Fac) 1425 contributing to the overall ITS-S congestion control functionalities using various methods at the facilities and apps layer for reducing at the number of generated messages based on the congestion level; Device Data Provider (DDP) 1424 for a V-ITS-S 1310 connected with the in-vehicle network and provides the vehicle state information; Local Dynamic Map (LDM) 1423, which is a local georeferenced database (see e.g., ETSI EN 302 895 v1.1.1 (2014-09) (“[TS302895]”) and ETSI TR 102 863 v1.1.1 (2011-06) (“[TR102863]”)); Service Announcement (SA) facility 1427; Signal Phase and Timing Service (SPATS); a Maneuver Coordination Services (MCS) entity; and/or a Multi-Channel Operations (MCO) facility (MCO-Fac) 1428. A list of the common facilities is given by ETSI TS 102 894-1 v1.1.1 (2013-08) (“[TS102894-1]”), which is hereby incorporated by reference in its entirety. The CPS 1421 may exchange information with additional facilities layer entities not shown by FIG. 14 for the purpose of generation, transmission, forwarding, and reception of CPMs. In some implementations, the facilities 1402 also include a RUM tracking facility 1420 that collects and reports RUM information according to the various examples discussed herein. In some examples, the ITS-S 1400 includes the RUM tracking app 1410, RUM tracking facility 1420, and/or both RUM trackers 1410 and 1420. Additionally or alternatively, the RUM tracking facility 1420 corresponds to the RUM trackers 1105 and/or 1205 of FIGS. 10-12. In these implementations, the RUM tracking app 1410 and/or RUM tracking facility 1420 provides the calculated/determined RUM information to the CPS 1421 to include the RUM information in a suitable CPM, and/or provides the calculated/determined RUM information to another facility to include the RUM information in another ITS message format.

FIG. 14 shows the CPS-specific functionality, including interfaces mapped to the ITS-S architecture 1400 along with the logical interfaces to other layers and entities within the facilities layer 1402. The CPS-specific functionality is centered around the CP Service (CPS) 1421 (also referred to as “CPS Basic Service 1421” or the like) located in the facilities layer. The CPS 1421 interfaces with other entities of the facilities layer 1402 and with ITS apps 1401 to collect relevant information for CPM generation and for forwarding received CPM content for further processing. Collective Perception (CP) is the concept of sharing a perceived environment of an ITS-S based on perception sensors. In contrast to Cooperative Awareness (CA), an ITS-S broadcasts information about its current (e.g., driving) environment rather than about its current state. Hence, CP is the concept of actively exchanging locally perceived objects between different ITS-Ss by means of V2X communication technology (or V2X RAT). CP decreases the ambient uncertainty of ITS-Ss by contributing information to their mutual Field-of-Views. The CPM enables ITS-Ss to share information about objects in the surrounding, which have been detected by sensors, cameras, or other information sources mounted or otherwise accessible to the Tx ITS-S. The CPS differs fundamentally from the CA basic service (see e.g., ETSI EN 302 637-2 V1.4.1 (2019-04) (“[EN302637-2]”)), as it does not focus on Tx data about the current state of the disseminating ITS-S but about its perceived environment. To avoid broadcasting CPMs about the same object by multiple ITS-Ss, the CP service may filter detected objects to be included in CPMs (see e.g., [TS103324] § 6.1).

The CPS 1421 operates according to the CPM protocol, which is an ITS facilities layer protocol for the operation of the CPMs transmission (Tx) and reception (Rx). The CPM is a CP basic service PDU including CPM data and an ITS PDU header. The CPM data comprises a partial or complete CPM payload, and includes the various data containers and associated values/parameters as discussed in [‘499] and/or [TS103324] (e.g., perceived object container (POC), free space addendum container (FSAC), sensor information container (SIC), a costmap container (CMC), and/or the like). In various implementations, the CPM data can include a road usage container (also referred to as a “RUM container” or “RUMC”), which contains the RUM information discussed herein. Additionally or alternatively, the same or similar RUMC with the same or similar RUM information can be included in other ITS-S messages, such as any of those discussed herein. The CPS basic service 1421 consumes data from other services located in the facilities layer, and is linked with others app support facilities. The CPS Basic Service 1421 is responsible for Tx of CPMs.

The entities for the collection of data to generate a CPM include the Device Data Provider (DDP) 1424, the PoTi 1422, and the LDM 1423. For subsystems of V-ITS-Ss 1310, the DDP 1424 is connected with the in-vehicle network and provides the vehicle state information. For subsystems of R-ITS-Ss 1330, the DDP 1424 is connected to sensors mounted on the roadside infrastructure such as poles, gantries, gates, signage, and the like.

The LDM 1423 is a database in the ITS-S, which in addition to on-board sensor data may be updated with received CAM and CPM data (see e.g., ETSI TR 102 863 v1.1.1 (2011-06)). ITS apps may retrieve information from the LDM 1423 for further processing. The CPS 1421 may also interface with the Service Announcement (SA) service 1427 to indicate an ITS-S’s ability to generate CPMs and to provide details about the communication technology (e.g., RAT) used. Message dissemination-specific information related to the current channel utilization are received by interfacing with the DCC-Fac entity 1425, which provides access network congestion information to the CPS 1421. Additionally or alternatively, message dissemination-specific information can be obtain by interfacing with a multi-channel operation facility (MCO_Fac) (see e.g., ETSI TR 103 439 V2.1.1 (2021-10)).

The PoTi 1422 manages the position and time information for use by ITS apps layer 1401, facility layer 1402, N&T layer 1403, management layer 1405, and security layer 1406. The position and time information may be the position and time at the ITS-S. For this purpose, the PoTi 1422 gets information from sub-system entities such as GNSS, sensors and other subsystem of the ITS-S. The PoTi 1422 ensures ITS time synchronicity between ITS-Ss in an ITS constellation, maintains the data quality (e.g., by monitoring time deviation), and manages updates of the position (e.g., kinematic and attitude state) and time. An ITS constellation is a group of ITS-S’s that are exchanging ITS data among themselves. The PoTi entity 1422 may include augmentation services to improve the position and time accuracy, integrity, and reliability. Among these methods, communication technologies may be used to provide positioning assistance from mobile to mobile ITS-Ss and infrastructure to mobile ITS-Ss. Given the ITS app requirements in terms of position and time accuracy, PoTi 1422 may use augmentation services to improve the position and time accuracy. Various augmentation methods may be applied. PoTi 1422 may support these augmentation services by providing messages services broadcasting augmentation data. For instance, an R-ITS-S 1330 may broadcast correction information for GNSS to oncoming V-ITS-S 1310; ITS-Ss may exchange raw GPS data or may exchange terrestrial radio position and time relevant information. PoTi 1422 maintains and provides the position and time reference information according to the app and facility and other layer service requirements in the ITS-S. In the context of ITS, the “position” includes attitude and movement parameters including velocity, heading, horizontal speed and optionally others. The kinematic and attitude state of a rigid body contained in the ITS-S included position, velocity, acceleration, orientation, angular velocity, and possible other motion related information. The position information at a specific moment in time is referred to as the kinematic and attitude state including time, of the rigid body. In addition to the kinematic and attitude state, PoTi 1422 should also maintain information on the confidence of the kinematic and attitude state variables.

The CPS 1421 interfaces through the Network - Transport/Facilities (NF)-Service Access Point (SAP) with the N&T layer 1403 for exchanging of CPMs with other ITS-Ss. The CPS interfaces through the Security - Facilities (SF)-SAP with the Security entity to access security services for CPM Tx and CPM Rx. The CPS interfaces through the Management-Facilities (MF)-SAP with the Management entity and through the Facilities - Application (FA)-SAP with the app layer if received CPM data is provided directly to the apps. Each of the aforementioned interfaces/SAPs may provide the full duplex exchange of data with the facilities layer, and may implement suitable APIs to enable communication between the various entities/elements.

The CPS 1421 resides or operates in the facilities layer 1402, generates CPS rules, checks related services/messages to coordinate transmission of CPMs with other ITS service messages generated by other facilities and/or other entities within the ITS-S, which are then passed to the N&T layer 1403 and access layers 1404 for transmission to other proximate ITS-Ss. The CPMs are included in ITS packets, which are facilities layer PDUs that are passed to the access layer 1404 via the N&T layer 1403 or passed to the app layer 1401 for consumption by one or more ITS apps. In this way, the CPM format is agnostic to the underlying access layer 1404 and is designed to allow CPMs to be shared regardless of the underlying access technology/RAT.

Each of the aforementioned interfaces/Service Access Points (SAPs) may provide the full duplex exchange of data with the facilities layer, and may implement suitable APIs to enable communication between the various entities/elements.

For a V-ITS-S 1310, the facilities layer 1402 is connected to an in-vehicle network via an in-vehicle data gateway as shown and described infra. The facilities and apps of a V-ITS-S 1310 receive required in-vehicle data from the data gateway in order to construct ITS messages (e.g., CSMs, VAMs, CAMs, DENMs, MCMs, and/or CPMs) and for app usage. FIG. 15 shows and describes the functionality for sending and receiving CPMs.

As alluded to previously, CP involves ITS-Ss sharing information about their current environments with one another. An ITS-S participating in CP broadcasts information about its current (e.g., driving) environment rather than about itself. For this purpose, CP involves different ITS-Ss actively exchanging locally perceived objects (e.g., other road participants and VRUs 1316, obstacles, and the like) detected by local perception sensors by means of one or more V2X RATs. In some implementations, CP includes a perception chain that can be the fusion of results of several perception functions at predefined times. These perception functions may include local perception and remote perception functions. The local perception is provided by the collection of information from the environment of the considered ITS element (e.g., VRU device, vehicle, infrastructure, and/or the like). This information collection is achieved using relevant sensors (optical camera, thermal camera, radar, LIDAR, and/or the like). The remote perception is provided by the provision of perception data via C-ITS (mainly V2X communication). CPS 1421 can be used to transfer a remote perception. Several perception sources may then be used to achieve the cooperative perception function. The consistency of these sources may be verified at predefined instants, and if not consistent, the CPS 1421 may select the best one according to the confidence level associated with each perception variable. The result of the CP should comply with the required level of accuracy as specified by PoTi. The associated confidence level may be necessary to build the CP resulting from the fusion in case of differences between the local perception and the remote perception. It may also be necessary for the exploitation by other functions (e.g., risk analysis) of the CP result. The perception functions from the device local sensors processing to the end result at the cooperative perception level may present a significant latency time of several hundred milliseconds. For the characterization of a VRU trajectory and its velocity evolution, there is a need for a certain number of the vehicle position measurements and velocity measurements thus increasing the overall latency time of the perception. Consequently, it is necessary to estimate the overall latency time of this function to take it into account when selecting a collision avoidance strategy.

Additionally or alternatively, existing infrastructure services, such as those described herein, can be used in the context of the CPS 1421. For example, the broadcast of the SPAT and SPAT relevance delimited area (MAP) is already standardized and used by vehicles at intersection level. In principle they protect VRUs 1316 crossing. However, signal violation warnings may exist and can be detected and signaled using DENM. This signal violation indication using DENMs is very relevant to VRU devices 1310v as indicating an increase of the collision risk with the vehicle which violates the signal. If it uses local captors or detects and analyses VAMs, the traffic light controller may delay the red phase change to green and allow the VRU 1316, 1310v to safely terminate its road crossing. The contextual speed limit using In-Vehicle Information (IVI) can be adapted when a large cluster of VRUs 1316 is detected (e.g., limiting the vehicles’ speed to 30 km/hour). At such reduced speed a vehicle 1310 may act efficiently when perceiving the VRUs by means of its own local perception system.

Referring back to FIG. 14, the N&T layer 1403 provides functionality of the OSI network layer and the OSI transport layer and includes one or more networking protocols, one or more transport protocols, and network and transport layer management. Each of the networking protocols may be connected to a corresponding transport protocol. Additionally, sensor interfaces and communication interfaces may be part of the N&T layer 1403 and access layer 1404. Examples of the networking protocols include IPv4, IPv6, IPv6 networking with mobility support, IPv6 over GeoNetworking, CALM, CALM FAST, FNTP, and/or some other suitable network protocol such as those discussed herein. Examples of the transport protocols include BOSH, BTP, GRE, GeoNetworking protocol, MPTCP, MPUDP, QUIC, RSVP, SCTP, TCP, UDP, VPN, one or more dedicated ITSC transport protocols, and/or some other suitable transport protocol such as those discussed herein.

The access layer includes a physical layer (PHY) 1404 connecting physically to the communication medium, a data link layer (DLL), which may be sub-divided into a medium access control sub-layer (MAC) managing the access to the communication medium, and a logical link control sub-layer (LLC), management adaptation entity (MAE) to directly manage the PHY 1404 and DLL, and a security adaptation entity (SAE) to provide security services for the access layer 1404. The access layer 1404 may also include external communication interfaces (CIs) and internal CIs. The CIs are instantiations of a specific access layer technology or RAT and protocol such as 3GPP LTE, 3GPP 5G/NR, C-V2X (e.g., based on 3GPP LTE and/or 5G/NR), WiFi, W-V2X (e.g., including ITS-G5 and/or DSRC), DSL, Ethernet, Bluetooth, and/or any other RAT and/or communication protocols discussed herein, or combinations thereof. The CIs provide the functionality of one or more logical channels (LCHs), where the mapping of LCHs on to physical channels is specified by the standard of the particular access technology involved. As alluded to previously, the V2X RATs may include ITS-G5/DSRC and 3GPP C-V2X. Additionally or alternatively, other access layer technologies (V2X RATs) may be used in various other implementations.

The management entity 1405 is in charge of managing communications in the ITS-S including, for example, cross-interface management, Inter-unit management communications (IUMC), networking management, communications service management, ITS app management, station management, management of general congestion control, management of service advertisement, management of legacy system protection, managing access to a common Management Information Base (MIB), and so forth.

The security entity 1406 provides security services to the OSI communication protocol stack, to the security entity and to the management entity 1405. The security entity 1406 contains security functionality related to the ITSC communication protocol stack, the ITS station and ITS apps such as, for example, firewall and intrusion management; authentication, authorization and profile management; identity, crypto key and certificate management; a common security information base (SIB); hardware security modules (HSM); and so forth. The security entity 1406 can also be considered as a specific part of the management entity 1405.

In some implementations, the security entity 1406 includes a security services layer/entity 1461 (see e.g., [TS102940]). Examples of the security services provided by the security services entity in the security entity 1406 are discussed in Table 3 in [TS102940]. In FIG. 14, the security entity 1406 is shown as a vertical layer adjacent to each of the ITS. In some implementations, security services are provided by the security entity 1406 on a layer-by-layer basis so that the security layer 1406 can be considered to be subdivided into the four basic ITS processing layers (e.g., one for each of the apps, facilities, N&T, and access layers). Security services are provided on a layer-by-layer basis, in the manner that each of the security services operates within one or several ITS architectural layers, or within the security management layer/entity 1462. Besides these security processing services, which provide secure communications between ITS stations, the security entity 1406 in the ITS-S architecture 1400 can include two additional sub-parts: security management services layer/entity 1462 and security defense layer/entity 1463.

The security defense layer 1463 prevents direct attacks against critical system assets and data and increases the likelihood of the attacker being detected. The security defense layer 1463 can include mechanisms such as intrusion detection and prevention (IDS/IPS), firewall activities, and intrusion response mechanisms. The security defense layer 1463 can also include misbehavior detection (MD) functionality, which performs plausibility checks on the security elements, processing of incoming V2X messages including the various MD functionality discussed herein. The MD functionality performs misbehavior detection on CAMs, DENMs, CPMs, and/or other ITS-S/V2X messages.

The ITS-S reference architecture 1400 may be applicable to the elements of FIGS. 17 and 19. The ITS-S gateway 1711, 1911 (see e.g., FIGS. 17 and 19) interconnects, at the facilities layer, an OSI protocol stack at OSI layers 5 to 7. The OSI protocol stack is typically is connected to the system (e.g., vehicle system or roadside system) network, and the ITSC protocol stack is connected to the ITS station-internal network. The ITS-S gateway 1711, 1911 (see e.g., FIGS. 17 and 19) is capable of converting protocols. This allows an ITS-S to communicate with external elements of the system in which it is implemented. The ITS-S router 1711, 1911 provides the functionality the ITS-S reference architecture 1400 excluding the Apps and Facilities layers. The ITS-S router 1711, 1911 interconnects two different ITS protocol stacks at layer 3. The ITS-S router 1711, 1911 may be capable to convert protocols. One of these protocol stacks typically is connected to the ITS station-internal network. The ITS-S border router 1914 (see e.g., FIG. 19) provides the same functionality as the ITS-S router 1711, 1911, but includes a protocol stack related to an external network that may not follow the management and security principles of ITS (e.g., the mgmnt layer 1405 and security layer 1406 in FIG. 14).

Additionally, other entities that operate at the same level but are not included in the ITS-S include the relevant users at that level, the relevant HMI (e.g., audio devices, display/touchscreen devices, and/or the like); when the ITS-S is a vehicle, vehicle motion control for computer-assisted and/or automated vehicles (e.g., both HMI and vehicle motion control entities may be triggered by the ITS-S apps); a local device sensor system and IoT Platform that collects and shares IoT data; local device sensor fusion and actuator app(s), which may contain ML/AI and aggregates the data flow issued by the sensor system; local perception and trajectory prediction apps that consume the output of the fusion app and feed the ITS-S apps; and the relevant ITS-S. The sensor system can include one or more cameras, radars, LIDARs, and/or the like, in a V-ITS-S 1310 or R-ITS-S 1330. In the central station, the sensor system includes sensors that may be located on the side of the road, but directly report their data to the central station, without the involvement of a V-ITS-S 1310 or R-ITS-S 1330. In some cases, the sensor system may additionally include gyroscope(s), accelerometer(s), and the like (see e.g., sensor circuitry 2042 of FIG. 20). These elements are discussed in more detail infra w.r.t FIGS. 17, 18, and 19.

FIG. 15 shows an example CPS service functional architecture 1500 including various functional entities of the CPS 1521 and interfaces to other facilities and other ITS layers. The CPS 1521 may correspond to the CPS 1421 of FIG. 14. For sending and receiving CPMs, the CPS includes a CPM transmission management function (CPM TxM) 1503, CPM reception management function (CPM RxM) 1504, an encode CPM function (E-CPM) 1505, and a decode CPM function (D-CPM) 1506. The E-CPM 1505 constructs CPMs as discussed herein and/or according to the format specified in Annex A of [TS103324].

The CPM RxM 1504 implements the protocol operation of the receiving (Rx) ITS-S 1400 such as, for example, triggering the decoding of CPMs upon receiving incoming CPMs; provisioning of the received CPMs to the LDM 1423 and/or ITS apps 1401 of the Rx ITS-S 1400; and/or checking the validity of the information of the received CPMs (see e.g., ETSI TR 103 460 V2.1.1 (2020-10) (“[TR103460]”)). The D-CPM 1506 decodes received CPMs.

The E-CPM 1505 generates individual CPMs for dissemination (e.g., transmission to other ITS-Ss). The E-CPM 1505 generates and/or encodes individual CPMs to include the most recent abstract CP object information, sensor information, free space information, and/or perceived region data. The CPM TxM 1503 implements the protocol operation of the originating (Tx) ITS-S 1400 such as, for example, activation and termination of CPM Tx operation; determination of CPM generation frequency; and triggering the generation of CPMs. In some implementations, the CPS 1521 activation may vary for different types of ITS-S (e.g., V-ITS-S 1310, 1701; R-ITS-S 1330, 1901; P-ITS-S 1310v, 1801; and central ITS-S 1340, 1390). As long as the CPS 1521 is active, CPM generation is managed by the CPS 1521. For compliant V-ITS-Ss 1310, the CPS 1521 is activated with the ITS-S 1400 activation function, and the CPS 1521 is terminated when the ITS-S 1400 is deactivated. For compliant R-ITS-Ss 1330, the CPS 1521 may be activated and deactivated through remote configuration. The activation and deactivation of the CPS 1521 other than the V-ITS-Ss 1310 and R-ITS-Ss 1330 can be implementation specific. Additionally or alternatively, the CPS 1521 can include the CPM generation management function(s) discussed in [‘499]. In these implementations, the CPM generation management can include an RUMC management function, which causes a CPM to include RUM information computed or otherwise currently known to a Tx ITS-S 1400 by adding a RoadUsageContainer DF to the perceivedObjectContainer and/or to another container of the CPM. The operation of the RUMC management function is based on the profile configuration (e.g., CPM configuration). For example, if a profile UseRoadUsageInclusionRules is set to “false”, all or a subset of the known RUM data is/are included in the RUMC; otherwise, some or all of the predefine or configured RUMC inclusion rules apply.

Interfaces of the CPS 1521 include a management layer interface (IF.Mng), a security layer interface (IF. Sec), an N&T layer interface (IF.N&T), a facilities layer interface (IF.FAC), an MCO layer interface (IF.MCO, and an app layer/CPM interface (IF.CPM). The IF.CPM is an interface between the CPS 1521 and the LDM 1423 and/or the ITS app layer 1401. The IF.CPM is provided by the CPS 1521 for the provision of received data. The IF.FAC is an interface between the CPS 1521 and other facilities layer entities (e.g., data provisioning facilities). For the generation of CPMs, the CPS 1521 interacts with other facilities layer entities to obtain the required data. This set of other facilities is referred to as data provisioning facilities (e.g., the ITS-S’s PoTi 1422, DDP 1424, and/or LDM 1423). Data is exchanged between the data provisioning facilities and the CPS 1521 via the IF.FAC.

If MCO is supported, the CPS 1521 exchanges information with the MCO_FAC 1428 via the IF.MCO (see e.g., ETSI TR 103 439 V2.1.1 (2021-10) and/or ETSI TS 103 141 (collectively “[etsiMCO]”)). This interface can be used to configure the default MCO settings for the generated CPMs and can also be used to configure the MCO parameters on a per message basis (see e.g., [etsiMCO]). If MCO_FAC is used, the CPS 1521 provides the CPM embedded in a facility layer 1402 service data unit (FL-SDU) together with protocol control information (PCI) according to ETSI EN 302 636-5-1 V2.1.0 (2017-05) (“[EN302636-5-1]”) to the MCO_FAC. In addition, it can also provide MCO control information (MCI) following [etsiMCO] to configure the MCO parameters of the CPM being provided.

At the receiving ITS-S, the MCO_FAC passes the received CPM to the CPS, if available. The data set that is passed between CPS 1521 and the MCO_FAC 1428 for the originating and receiving ITS-S is as follows: according to Annex A of [TS103324] when the data set is a CPM; depending on the protocol stack applied in the N&T 1403 as specified in [TS103324] § 5.3.5 when the data set is PCI; and MCO parameters configuration (may be needed if the default MCO parameters have not been configured or want to be overwritten for a specific CPM) when the data set is MCI.

If MCO is not supported, the CPS exchanges information with the N&T 1403 via the IF.N&T. The IF.N&T is an interface between the CPS 1521 and the N&T 1403 (see e.g., ETSI TS 102 723-11 V1.1.1 (2013-11)). At the originating ITS-S, the CPS 1521 provides the CPM embedded in a FL-SDU together with protocol control information (PCI) according to [EN302636-5-1] to the ITS N&T 1403. At the receiving ITS-S, the N&T 1403 passes the received CPM to the CPS 1521, if available. The data set that is passed between the CPS 1521 and the N&T 1403 for the originating and receiving ITS-Ss is as follows: according to Annex A of [TS103324] when the data set is a CPM; and depending on the protocol stack applied in the N&T 1403 as specified in [TS103324] § 5.3.5 when the data set is PCI.

The interface between the CPS 1521 and the N&T 1403 relies on the services of the GeoNetworking/BTP stack as specified in [TS103324] § 5.3.5.1 or on the IPv6 stack and the combined IPv6 / GeoNetworking stack as specified in [TS103324] § 5.3.5.2. If the GeoNetworking/BTP stack is used, the GN packet transport type single-hop broadcasting (SHB) is used. In this scenario, ITS-Ss located within direct communication range may receive the CPM. If GeoNetworking is used as the network layer protocol, then the PCI being passed from the CPS 1521 to the GeoNetworking/BTP stack (directly or indirectly through the MCO_FAC 1428 when MCO is supported) complies with [EN302636-5-1] and/or ETSI TS 103 836-4-1 (see e.g., [TS103324] § 5.3.5).

The CPS 1521 may use the IPv6 stack or the combined IPv6/GeoNetworking stack for CPM dissemination as specified in ETSI TS 103 836-3. If IP based transport is used to transfer the facility layer CPM between interconnected actors, security constraints as outlined in [TS103324] § 6.2 may not be applicable. In this case trust among the participating actors, e.g. using mutual authentication, and authenticity of information can be based on other standard IT security methods, such as IPSec, DTLS, TLS or other VPN solutions that provide an end-to-end secure communication path between known actors. Security methods, sharing methods and other transport related information, such as messaging queuing protocols, transport layer protocol, ports to use, and the like, can be agreed among interconnected actors. When the CPM dissemination makes use of the combined IPv6/GeoNetworking stack, the interface between the CPS 1521 and the combined IPv6/GeoNetworking stack may be the same or similar to the interface between the CPS 1521 and IPv6 stack.

The IF.Mng is an interface between the CPS 1521 and the ITS management entity 1405. The CPS of an originating ITS-S gets information for setting the T_GenCpm variable from the management entity defined in [TS103324] § 6.1.2.2 via the IF.Mng. A list of primitives exchanged with the management layer are provided in ETSI TS 102 723-5.

The IF.Sec is an interface between the CPS 1521 and the ITS security entity 1406. The CPS 1521 may exchange primitives with the Security entity of the ITS-S (see e.g., FIG. 14) using the IF.Sec provided by the security entity 1406. In case the facility layer security is used, for ITS-Ss that use the trust model according to [TS102940] and ITS certificates according to ETSI TS 103 097 v2.1.1 (2021-10) (“[TS103097]”) and that are of type [Itss_WithPrivacy] as defined in [TS102940], the CPS 1521 interacts with the ID management functionality of the security entity 1406 to set the actual value of the ITS-S ID in the CPM. When the Security entity is triggering a pseudonym change, it shall change the value of the ITS-ID accordingly and shall not send CPMs with the previous ID anymore.

Due to priority mechanisms such as DCC 1425 and/or 1428 at facilities 1402 or lower layers (e.g., N&T 1403, access layer 1404, and the like), the sending ITS-S may apply reordering of the messages contained in its buffer. Queued messages which are identified with the old ITS-ID are discarded as soon as a message with the new ITS-ID is sent. Whether or not messages previously queued prior to an ID change event get transmitted or not is implementation-specific. Additionally or alternatively, ITS-Ss of type [Itss_NoPrivacy] as defined in [TS102940] and ITS-Ss that do not use the trust model according to [TS102940] and ITS certificates according to [TS103097] do not need to implement functionality that changes ITS-S IDs (e.g., pseudonyms). In order to avoid similarities between successive CPMs, all detected objects is reported as newly detected objects in the CPM following a pseudonym change. Additionally, the SensorInformationContainer may be omitted for a certain time around a pseudonym change.

FIG. 16 shows an example of object data extraction levels of the CP basic service 1601, which may be the same or similar as the CPS 1521 of FIG. 15 and/or CPS 1421 of FIG. 14. Part 1600a depicts an implementation in which sensor data from sensors 1 to n (where n is a number) is processed as part of a low-level data management entity 1610. The CP basic service 1601 then selects object candidates to be transmitted as defined in clause 4.3 of ETSI TR 103 562 V2.1.1 (2019-12) (“[TR103562]”) and/or according to section 6 of [TS103324]. Part 1600a is more likely to avoid filter cascades, as the task of high-level fusion will be performed by the receiving ITS-S. Part 1600b depicts an implementation in which the CP basic service 1601 selects objects to be transmitted as part of the CPM according to section 6 of [TS103324] and/or according to clause 4.3 of [TR103562] from a high-level fused object list, thereby abstracting the original sensor measurement used in the fusion process. The CPM provides data fields to indicate the source of the object. In parts 1600a and 1600b, the sensor data is also provided to a data fusion function 1620 for high-level object fusion, and the fused data is then provided to one or more ADAS apps 1630.

Raw sensor data refers to low-level data generated by a local perception sensor that is mounted to, or otherwise accessible by, a vehicle or an RSU. This data is specific to a sensor type (e.g., reflexions, time of flight, point clouds, camera image, and/or the like). In the context of environment perception, this data is usually analyzed and subjected to sensor-specific analysis processes to detect and compute a mathematical representation for a detected object from the raw sensor data. The IST-S sensor may provide raw sensor data as a result of their measurements, which is then used by a sensor specific low-level object fusion system (e.g., sensor hub, dedicated processor(s), and the like) to provide a list of objects as detected by the measurement of the sensor. The detection mechanisms and data processing capabilities are specific to each sensor and/or hardware configurations.

This means that the definition and mathematical representation of an object can vary. The mathematical representation of an object is called a state space representation. Depending on the sensor type, a state space representation may comprise multiple dimensions (e.g., relative distance components of the feature to the sensor, speed of the feature, geometric dimensions, and/or the like). A state space is generated for each detected object of a particular measurement. Depending on the sensor type, measurements are performed cyclically, periodically, and/or based on some defined trigger condition. After each measurement, the computed state space of each detected object is provided in an object list that is specific to the timestamp of the measurement.

The object (data) fusion system maintains one or more lists of objects that are currently perceived by the ITS-S. The object fusion mechanism performs prediction of each object to timestamps at which no measurement is available from sensors; associates objects from other potential sensors mounted to the station or received from other ITS-Ss with objects in the tracking list; and merges the prediction and an updated measurement for an object. At each point in time, the data fusion mechanism is able to provide an updated object list based on consecutive measurements from (possibly) multiple sensors containing the state spaces for all tracked objects. V2X information (e.g., CAMs, DENMs, CPMs, and/or the like) from other vehicles may additionally be fused with locally perceived information. Other approaches additionally provide alternative representations of the processed sensor data, such as an occupancy grid.

The data fusion mechanism also performs various housekeeping tasks such as, for example, adding state spaces to the list of objects currently perceived by an ITS-S in case a new object is detected by a sensor; updating objects that are already tracked by the data fusion system with new measurements that should be associated to an already tracked object; and removing objects from the list of tracked objects in case new measurements should not be associated to already tracked objects. Depending on the capabilities of the fusion system, objects can also be classified (e.g., some sensor systems may be able to classify a detected object as a particular road user, while others are merely able to provide a distance measurement to an obj ect within the perception range). These tasks of object fusion may be performed either by an individual sensor, or by a high-level data fusion system or process.

### 2.2. Its Station Aspects

FIG. 17 depicts an example vehicle computing system 1700. In this example, the vehicle computing system 1700 includes a V-ITS-S 1701 and Electronic Control Units (ECUs) 1744. The V-ITS-S 1701 includes a V-ITS-S gateway 1711, an ITS-S host 1712, and an ITS-S router 1713. The V-ITS-S gateway 1711 provides functionality to connect the components at the in-vehicle network (e.g., ECUs 1744) to the ITS station-internal network. The interface to the in-vehicle components (e.g., ECUs 1744) may be the same or similar as those discussed herein (see e.g., IX 2006 of FIG. 20) and/or may be a proprietary interface/interconnect. Access to components (e.g., ECUs 1744) may be implementation specific. The ECUs 1744 may be the same or similar to the driving control units (DCUs) 1314 discussed previously w.r.t FIG. 13. The ITS station connects to ITS ad hoc networks via the ITS-S router 1713.

FIG. 18 depicts an example personal computing system 1800. The personal ITS sub-system 1800 provides the app and communication functionality of ITSC in mobile devices, such as smartphones, tablet computers, wearable devices, PDAs, portable media players, laptops, and/or other mobile devices. The personal ITS sub-system 1800 contains a personal ITS station (P-ITS-S) 1801 and various other entities not included in the P-ITS-S 1801, which are discussed in more detail infra. The device used as a personal ITS station may also perform HMI functionality as part of another ITS sub-system, connecting to the other ITS sub-system via the ITS station-internal network (not shown). For purposes of the present disclosure, the personal ITS sub-system 1800 may be used as a VRU ITS-S 1310v.

FIG. 19 depicts an example roadside infrastructure system 1900. In this example, the roadside infrastructure system 1900 includes an R-ITS-S 1901, output device(s) 1905, sensor(s) 1908, and one or more radio units (RUs) 1910. The R-ITS-S 1901 includes a R-ITS-S gateway 1911, an ITS-S host 1912, an ITS-S router 1913, and an ITS-S border router 1914. The ITS station connects to ITS ad hoc networks and/or ITS access networks via the ITS-S router 1913. The R-ITS-S gateway 1711 provides functionality to connect the components of the roadside system (e.g., output devices 1905 and sensors 1908) at the roadside network to the ITS station-internal network. The interface to the in-vehicle components (e.g., ECUs 1744) may be the same or similar as those discussed herein (see e.g., IX 2006 of FIG. 20) and/or may be a proprietary interface/interconnect. Access to components (e.g., ECUs 1744) may be implementation specific. The sensor(s) 1908 may be inductive loops and/or sensors that are the same or similar to the sensors 1312 discussed infra w.r.t FIG. 13 and/or sensor circuitry 2042 discussed infra w.r.t FIG. 20.

The actuators 1913 are devices that are responsible for moving and controlling a mechanism or system. The actuators 1913 are used to change the operational state (e.g., on/off, zoom or focus, and/or the like), position, and/or orientation of the sensors 1908. The actuators 1913 are used to change the operational state of some other roadside equipment, such as gates, traffic lights, digital signage or variable message signs (VMS), and/or the like The actuators 1913 are configured to receive control signals from the R-ITS-S 1901 via the roadside network, and convert the signal energy (or some other energy) into an electrical and/or mechanical motion. The control signals may be relatively low energy electric voltage or current. The actuators 1913 comprise electromechanical relays and/or solid state relays, which are configured to switch electronic devices on/off and/or control motors, and/or may be that same or similar or actuators 2044 discussed infra w.r.t FIG. 20.

Each of FIGS. 17, 18, and 19 also show entities which operate at the same level but are not included in the ITS-S including the relevant HMI 1706, 1806, and 1906; vehicle motion control 1708 (only at the vehicle level); local device sensor system and IoT Platform 1705, 1805, and 1905; local device sensor fusion and actuator app 1704, 1804, and 1904; local perception and trajectory prediction apps 1702, 1802, and 1902; motion prediction 1703 and 1803, or mobile objects trajectory prediction 1903 (at the RSU level); and connected system 1707, 1807, and 1907.

The local device sensor system and IoT Platform 1705, 1805, and 1905 collects and shares IoT data. The sensor system and IoT Platform 1805 is at least composed of the PoTi management function present in each ITS-S of the system (see e.g., ETSI EN 302 890-2 (“[EN302890-2]”)). The PoTi entity provides the global time common to all system elements and the real time position of the mobile elements. Local sensors may also be embedded in other mobile elements as well as in the road infrastructure (e.g., camera in a smart traffic light, electronic signage, and/or the like). An IoT platform, which can be distributed over the system elements, may contribute to provide additional information related to the environment surrounding the device/system 1700, 1800, 1900. The sensor system can include one or more cameras, radars, LiDARs, and/or other sensors (see e.g., sensors 2042 of FIG. 20), in a V-ITS-S 1310 or R-ITS-S 1330. In personal computing system 1800 (or VRU 1310v), the sensor system 1805 may include gyroscope(s), accelerometer(s), and/or other sensors (see e.g., sensors 2042 of FIG. 20). In a central station (not shown), the sensor system includes sensors that may be located on the side of the road, but directly report their data to the central station, without the involvement of a V-ITS-S 1310, an R-ITS-S 1330, or VRU 1310v.

The (local) sensor data fusion function and/or actuator apps 1704, 1804, and 1904 provides the fusion of local perception data obtained from the VRU sensor system and/or different local sensors. This may include aggregating data flows issued by the sensor system and/or different local sensors. The local sensor fusion and actuator app(s) may contain machine learning (ML)/artificial intelligence (AI) algorithms and/or models. Sensor data fusion usually relies on the consistency of its inputs and then to their timestamping, which correspond to a common given time. Various ML/AI techniques can be used to carry out the sensor data fusion and/or may be used for other purposes, such as any of the AI/ML techniques and technologies discussed herein. Where the apps 1704, 1804, and 1904 are (or include) AI/ML functions, the apps 1704, 1804, and 1904 may include AI/ML models that have the ability to learn useful information from input data (e.g., context information, and/or the like) according to supervised learning, unsupervised learning, reinforcement learning (RL), and/or neural network(s) (NN). Separately trained AI/ML models can also be chained together in a AI/ML pipeline during inference or prediction generation.

The input data may include AI/ML training information and/or AI/ML model inference information. The training information includes the data of the ML model including the input (training) data plus labels for supervised training, hyperparameters, parameters, probability distribution data, and other information needed to train a particular AI/ML model. The model inference information is any information or data needed as input for the AI/ML model for inference generation (or making predictions). The data used by an AI/ML model for training and inference may largely overlap, however, these types of information refer to different concepts. The input data is called training data and has a known label or result.

Supervised learning is an ML task that aims to learn a mapping function from the input to the output, given a labeled data set. Examples of supervised learning include regression algorithms (e.g., Linear Regression, Logistic Regression, ), and the like), instance-based algorithms (e.g., k-nearest neighbor, and the like), Decision Tree Algorithms (e.g., Classification And Regression Tree (CART), Iterative Dichotomiser 3 (ID3), C4.5, chi-square automatic interaction detection (CHAID), and/or the like), Fuzzy Decision Tree (FDT), and the like), Support Vector Machines (SVM), Bayesian Algorithms (e.g., Bayesian network (BN), a dynamic BN (DBN), Naive Bayes, and the like), and Ensemble Algorithms (e.g., Extreme Gradient Boosting, voting ensemble, bootstrap aggregating (“bagging”), Random Forest and the like). Supervised learning can be further grouped into Regression and Classification problems. Classification is about predicting a label whereas Regression is about predicting a quantity. For unsupervised learning, Input data is not labeled and does not have a known result. Unsupervised learning is an ML task that aims to learn a function to describe a hidden structure from unlabeled data. Some examples of unsupervised learning are K-means clustering and principal component analysis (PCA). Neural networks (NNs) are usually used for supervised learning, but can be used for unsupervised learning as well. Examples of NNs include deep NN (DNN), feed forward NN (FFN), deep FNN (DFF), convolutional NN (CNN), deep CNN (DCN), deconvolutional NN (DNN), a deep belief NN, a perception NN, recurrent NN (RNN) (e.g., including Long Short Term Memory (LSTM) algorithm, gated recurrent unit (GRU), echo state network (ESN), and the like), spiking NN (SNN), deep stacking network (DSN), Markov chain, perception NN, generative adversarial network (GAN), transformers, stochastic NNs (e.g., Bayesian Network (BN), Bayesian belief network (BBN), a Bayesian NN (BNN), Deep BNN (DBNN), Dynamic BN (DBN), probabilistic graphical model (PGM), Boltzmann machine, restricted Boltzmann machine (RBM), Hopfield network or Hopfield NN, convolutional deep belief network (CDBN), and the like), Linear Dynamical System (LDS), Switching LDS (SLDS), Optical NNs (ONNs), an NN for reinforcement learning (RL) and/or deep RL (DRL), and/or the like. In RL, an agent aims to optimize a long-term objective by interacting with the environment based on a trial and error process. Examples of RL algorithms include Markov decision process, Markov chain, Q-learning, multi-armed bandit learning, and deep RL.

The (local) sensor data fusion function and/or actuator apps 1704, 1804, and 1904 can use any suitable data fusion or data integration technique(s) to generate fused data, union data, and/or composite information. For example, the data fusion technique may be a direct fusion technique or an indirect fusion technique. Direct fusion combines data acquired directly from multiple sensors or other data sources, which may be the same or similar (e.g., all devices or sensors perform the same type of measurement) or different (e.g., different device or sensor types, historical data, and/or the like). Indirect fusion utilizes historical data and/or known properties of the environment and/or human inputs to produce a refined data set. Additionally or alternatively, the data fusion technique can include one or more fusion algorithms, such as a smoothing algorithm (e.g., estimating a value using multiple measurements in real-time or not in real-time), a filtering algorithm (e.g., estimating an entity’s state with current and past measurements in real-time), and/or a prediction state estimation algorithm (e.g., analyzing historical data (e.g., geolocation, speed, direction, and signal measurements) in real-time to predict a state (e.g., a future signal strength/quality at a particular geolocation coordinate)). Additionally or alternatively, data fusion functions can be used to estimate various device/system parameters that are not provided by that device/system. As examples, the data fusion algorithm(s) 1704, 1804, and 1904 may be or include one or more of a structured-based algorithm (e.g., tree-based (e.g., Minimum Spanning Tree (MST)), cluster-based, grid and/or centralized-based), a structure-free data fusion algorithm, a Kalman filter algorithm, a fuzzy-based data fusion algorithm, an Ant Colony Optimization (ACO) algorithm, a fault detection algorithm, a Dempster-Shafer (D-S) argumentation-based algorithm, a Gaussian Mixture Model algorithm, a triangulation based fusion algorithm, and/or any other like data fusion algorithm(s), or combinations thereof.

In one example, the ML/AI techniques are used for object tracking. The object tracking and/or computer vision techniques may include, for example, edge detection, corner detection, blob detection, a Kalman filter, Gaussian Mixture Model, Particle filter, Mean-shift based kernel tracking, an ML object detection technique (e.g., Viola-Jones object detection framework, scale-invariant feature transform (SIFT), histogram of oriented gradients (HOG), and/or the like), a deep learning object detection technique (e.g., fully convolutional neural network (FCNN), region proposal convolution neural network (R-CNN), single shot multibox detector, ‘you only look once’ (YOLO) algorithm, and/or the like), and/or the like.

In another example, the ML/AI techniques are used for motion detection based on the y sensor data obtained from the one or more sensors. Additionally or alternatively, the ML/AI techniques are used for object detection and/or classification. The object detection or recognition models may include an enrollment phase and an evaluation phase. During the enrollment phase, one or more features are extracted from the sensor data (e.g., image or video data). A feature is an individual measurable property or characteristic. In the context of object detection, an object feature may include an object size, color, shape, relationship to other objects, and/or any region or portion of an image, such as edges, ridges, corners, blobs, and/or some defined regions of interest (ROI), and/or the like. The features used may be implementation specific, and may be based on, for example, the objects to be detected and the model(s) to be developed and/or used. The evaluation phase involves identifying or classifying objects by comparing obtained image data with existing object models created during the enrollment phase. During the evaluation phase, features extracted from the image data are compared to the object identification models using a suitable pattern recognition technique. The object models may be qualitative or functional descriptions, geometric surface information, and/or abstract feature vectors, and may be stored in a suitable database that is organized using some type of indexing scheme to facilitate elimination of unlikely object candidates from consideration.

Any suitable data fusion or data integration technique(s) may be used to generate the composite information. For example, the data fusion technique may be a direct fusion technique or an indirect fusion technique. Direct fusion combines data acquired directly from multiple vUEs or sensors, which may be the same or similar (e.g., all vUEs or sensors perform the same type of measurement) or different (e.g., different vUE or sensor types, historical data, and/or the like). Indirect fusion utilizes historical data and/or known properties of the environment and/or human inputs to produce a refined data set. Additionally, the data fusion technique may include one or more fusion algorithms, such as a smoothing algorithm (e.g., estimating a value using multiple measurements in real-time or not in real-time), a filtering algorithm (e.g., estimating an entity’s state with current and past measurements in real-time), and/or a prediction state estimation algorithm (e.g., analyzing historical data (e.g., geolocation, speed, direction, and signal measurements) in real-time to predict a state (e.g., a future signal strength/quality at a particular geolocation coordinate)). As examples, the data fusion algorithm may be or include a structured-based algorithm (e.g., tree-based (e.g., Minimum Spanning Tree (MST)), cluster-based, grid and/or centralized-based), a structure-free data fusion algorithm, a Kalman filter algorithm and/or Extended Kalman Filtering, a fuzzy-based data fusion algorithm, an Ant Colony Optimization (ACO) algorithm, a fault detection algorithm, a Dempster-Shafer (D-S) argumentation-based algorithm, a Gaussian Mixture Model algorithm, a triangulation based fusion algorithm, and/or any other like data fusion algorithm

A local perception function (which may or may not include trajectory prediction app(s)) 1702, 1802, and 1902 is provided by the local processing of information collected by local sensor(s) associated to the system element. The local perception (and trajectory prediction) function 1702, 1802, and 1902 consumes the output of the sensor data fusion app/function 1704, 1804, and 1904 and feeds ITS-S apps with the perception data (and/or trajectory predictions). The local perception (and trajectory prediction) function 1702, 1802, and 1902 detects and characterize objects (static and mobile) which are likely to cross the trajectory of the considered moving objects. The infrastructure, and particularly the road infrastructure 1900, may offer services relevant to the VRU support service. The infrastructure may have its own sensors detecting VRUs 1316/1310v evolutions and then computing a risk of collision if also detecting local vehicles’ evolutions, either directly via its own sensors or remotely via a cooperative perception supporting services such as the CPS 1421 (see e.g., [TR103562]). Additionally, road marking (e.g., zebra areas or crosswalks) and vertical signs may be considered to increase the confidence level associated with the VRU detection and mobility since VRUs 1316/1310v usually have to respect these marking/signs.

The motion dynamic prediction function 1703 and 1803, and the mobile objects trajectory prediction 1903 (at the RSU level), are related to the behavior prediction of the considered moving objects. The motion dynamic prediction function 1703 and 1803 predict the trajectory of the vehicle 1310 and the VRU 1316, respectively. The motion dynamic prediction function 1703 may be part of the VRU Trajectory and Behavioral Modeling module and trajectory interception module of the V-ITS-S 1310. The motion dynamic prediction function 1803 may be part of the dead reckoning module and/or the movement detection module of the VRU ITS-S 1310v. Alternatively, the motion dynamic prediction functions 1703 and 1803 may provide motion/movement predictions to the aforementioned modules. Additionally or alternatively, the mobile objects trajectory prediction 1903 predict respective trajectories of corresponding vehicles 1310 and VRUs 1316, which may be used to assist the vehicles 1310 and/or VRU ITS-S 1310v in performing dead reckoning and/or assist the V-ITS-S 1310 with VRU Trajectory and Behavioral Modeling entity. Motion dynamic prediction includes a moving object trajectory resulting from evolution of the successive mobile positions. A change of the moving object trajectory or of the moving object velocity (acceleration/deceleration) impacts the motion dynamic prediction. In most cases, when VRUs 1316/1310v are moving, they still have a large amount of possible motion dynamics in terms of possible trajectories and velocities. This means that motion dynamic prediction 1703, 1803, 1903 is used to identify which motion dynamic will be selected by the vehicles 1310 and/or VRU 1316 as quickly as possible, and if this selected motion dynamic is subject to a risk of collision with another VRU or a vehicle. The motion dynamic prediction functions 1703, 1803, 1903 analyze the evolution of mobile objects and the potential trajectories that may meet at a given time to determine a risk of collision between them. The motion dynamic prediction works on the output of cooperative perception considering the current trajectories of considered device (e.g., VRU device 1310v) for the computation of the path prediction; the current velocities and their past evolutions for the considered mobiles for the computation of the velocity evolution prediction; and the reliability level which can be associated to these variables. The output of this function is provided to a risk analysis function.

In many cases, working only on the output of the cooperative perception is not sufficient to make a reliable prediction because of the uncertainty which exists in terms of device/system trajectory selection and its velocity. However, complementary functions may assist in increasing consistently the reliability of the prediction. For example, the use of the device’s navigation system, which provides assistance to the user to select the best trajectory for reaching its planned destination. With the development of Mobility as a Service (MaaS), multimodal itinerary computation may also indicate to the device or user dangerous areas and then assist to the motion dynamic prediction at the level of the multimodal itinerary provided by the system. In another example, the knowledge of the user habits and behaviors may be additionally or alternatively used to improve the consistency and the reliability of the motion predictions. Some users follow the same itineraries, using similar motion dynamics, for example when going to the main Point of Interest (POI), which is related to their main activities (e.g., going to school, going to work, doing some shopping, going to the nearest public transport station from their home, going to sport center, and/or the like). The device, system, or a remote service center may learn and memorize these habits. In another example, the indication by the user itself of its selected trajectory in particular when changing it (e.g., using a right turn or left turn signal similar to vehicles when indicating a change of direction).

The vehicle motion control 1708 may be included for computer-assisted and/or automated vehicles 1310. Both the HMI entity 1706 and vehicle motion control entity 1708 may be triggered by one or more ITS-S apps. The vehicle motion control entity 1708 may be a function under the responsibility of a human driver or of the vehicle if it is able to drive in automated mode.

The Human Machine Interface (HMI) 1706, 1806, and 1906, when present, enables the configuration of initial data (parameters) in the management entities (e.g., VRU profile management) and in other functions (e.g., VBS management). The HMI 1706, 1806, and 1906 enables communication of external events related to the VBS to the device owner (user), including the alerting about an immediate risk of collision (TTC < 2 s) detected by at least one element of the system and signaling a risk of collision (e.g., TTC > 2 seconds) being detected by at least one element of the system. For a VRU system 1310v (e.g., personal computing system 1800), similar to a vehicle driver, the HMI provides the information to the VRU 1316, considering its profile (e.g., for a blind person, the information is presented with a clear sound level using accessibility capabilities of the particular platform of the personal computing system 1800). In various implementations, the HMI 1706, 1806, and 1906 may be part of the alerting system.

The connected systems 1707, 1807, and 1907 refer to components/devices used to connect a system with one or more other systems. As examples, the connected systems 1707, 1807, and 1907 may include communication circuitry and/or radio units. The system 1700, 1800, 1900 may be a connected system made of various/different levels of equipment (e.g., up to 4 levels). The system 1700, 1800, 1900 may also be an information system which collects, in real time, information resulting from events, processes the collected information and stores them together with processed results. At each level of the system 1700, 1800, 1900, the information collection, processing and storage is related to the functional and data distribution scenario which is implemented.

FIG. 20 illustrates an example of components that may be present in an compute node 2000 for implementing the techniques (e.g., operations, processes, methods, and methodologies) described herein. This compute node 2000 provides a closer view of the respective components of node 2000 when implemented as or as part of a computing device or system. The compute node 2000 can include any combination of the hardware or logical components referenced herein, and may include or couple with any device usable with a communication network or a combination of such networks. In particular, any combination of the components depicted by FIG. 20 can be implemented as individual ICs, discrete electronic devices, or other modules, instruction sets, programmable logic or algorithms, hardware, hardware accelerators, software, firmware, or a combination thereof adapted in the compute node 2000, or as components otherwise incorporated within a chassis of a larger system. Additionally or alternatively, any combination of the components depicted by FIG. 20 can be implemented as a system-on-chip (SoC), a single-board computer (SBC), a system-in-package (SiP), a multi-chip package (MCP), and/or the like, in which a combination of the hardware elements are formed into a single IC or a single package. Furthermore, the compute node 2000 may be or include a client device, server, appliance, network infrastructure, machine, robot, drone, and/or any other type of computing devices such as any of those discussed herein. For example, the compute node 2000 may correspond to any of the UEs 1310, NAN 1330, edge compute node 1340, NFs in network 1365, and/or application functions (AFs)/servers 1390 of FIG. 13; REM-RUM service 950 (or individual REM servers) of FIG. 9; EVSE 1011 and/or EVSE controller 1110 of FIGS. 10-12; ITS 1400 of FIG. 14; vehicle computing system 1700 of FIG. 17; personal computing system 1800 of FIG. 18; roadside infrastructure 1900 of FIG. 19; and/or any other computing device/system discussed herein.

The compute node 2000 includes one or more processors 2002 (also referred to as “processor circuitry 2002”). The processor circuitry 2002 includes circuitry capable of sequentially and/or automatically carrying out a sequence of arithmetic or logical operations, and recording, storing, and/or transferring digital data. Additionally or alternatively, the processor circuitry 2002 includes any device capable of executing or otherwise operating computer-executable instructions, such as program code, software modules, and/or functional processes. The processor circuitry 2002 includes various hardware elements or components such as, for example, a set of processor cores and one or more of on-chip or on-die memory or registers, cache and/or scratchpad memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. Some of these components, such as the on-chip or on-die memory or registers, cache and/or scratchpad memory, may be implemented using the same or similar devices as the memory circuitry 2010 discussed infra. The processor circuitry 2002 is also coupled with memory circuitry 2010 and storage circuitry 2020, and is configured to execute instructions stored in the memory/storage to enable various apps, OSs, or other software elements to run on the platform 2000. In particular, the processor circuitry 2002 is configured to operate app software (e.g., instructions 2001, 2011, 2021) to provide one or more services to a user of the compute node 2000 and/or user(s) of remote systems/devices.

As examples, the processor circuitry 2002 can be embodied as, or otherwise include one or multiple central processing units (CPUs), application processors, graphics processing units (GPUs), RISC processors, Acorn RISC Machine (ARM) processors, complex instruction set computer (CISC) processors, DSPs, FPGAs, programmable logic devices (PLDs), ASICs, baseband processors, radio-frequency integrated circuits (RFICs), microprocessors or controllers, multi-core processors, multithreaded processors, ultra-low voltage processors, embedded processors, a specialized x-processing units (xPUs) or a data processing unit (DPUs) (e.g., Infrastructure Processing Unit (IPU), network processing unit (NPU), and the like), and/or any other processing devices or elements, or any combination thereof. In some implementations, the processor circuitry 2002 is embodied as one or more special-purpose processor(s)/controller(s) configured (or configurable) to operate according to the various implementations and other aspects discussed herein. Additionally or alternatively, the processor circuitry 2002 includes one or more hardware accelerators (e.g., same or similar to acceleration circuitry 2050), which can include microprocessors, programmable processing devices (e.g., FPGAs, ASICs, PLDs, DSPs. and/or the like), and/or the like.

The system memory 2010 (also referred to as “memory circuitry 2010”) includes one or more hardware elements/devices for storing data and/or instructions 2011 (and/or instructions 2001, 2021). Any number of memory devices may be used to provide for a given amount of system memory 2010. As examples, the memory 2010 can be embodied as processor cache or scratchpad memory, volatile memory, non-volatile memory (NVM), and/or any other machine readable media for storing data. Examples of volatile memory include random access memory (RAM), static RAM (SRAM), dynamic RAM (DRAM), synchronous DRAM (SDRAM), thyristor RAM (T-RAM), content-addressable memory (CAM), and/or the like. Examples of NVM can include read-only memory (ROM) (e.g., including programmable ROM (PROM), erasable PROM (EPROM), electrically EPROM (EEPROM), flash memory (e.g., NAND flash memory, NOR flash memory, and the like), solid-state storage (SSS) or solid-state ROM, programmable metallization cell (PMC), and/or the like), non-volatile RAM (NVRAM), phase change memory (PCM) or phase change RAM (PRAM) (e.g., Intel® 3D XPoint™ memory, chalcogenide RAM (CRAM), Interfacial Phase-Change Memory (IPCM), and the like), memistor devices, resistive memory or resistive RAM (ReRAM) (e.g., memristor devices, metal oxide-based ReRAM, quantum dot resistive memory devices, and the like), conductive bridging RAM (or PMC), magnetoresistive RAM (MRAM), electrochemical RAM (ECRAM), ferroelectric RAM (FeRAM), antiferroelectric RAM (AFeRAM), ferroelectric field-effect transistor (FeFET) memory, and/or the like. Additionally or alternatively, the memory circuitry 2010 can include spintronic memory devices (e.g., domain wall memory (DWM), spin transfer torque (STT) memory (e.g., STT-RAM or STT-MRAM), magnetic tunneling junction memory devices, spin-orbit transfer memory devices, Spin-Hall memory devices, nanowire memory cells, and/or the like). In some implementations, the individual memory devices 2010 may be formed into any number of different package types, such as single die package (SDP), dual die package (DDP), quad die package (Q17P), memory modules (e.g., dual inline memory modules (DIMMs), microDIMMs, and/or MiniDIMMs), and/or the like. Additionally or alternatively, the memory circuitry 2010 is or includes block addressable memory device(s), such as those based on NAND or NOR flash memory technologies (e.g., single-level cell (“SLC”), multi-level cell (“MLC”), quad-level cell (“QLC”), tri-level cell (“TLC”), or some other NAND or NOR device). Additionally or alternatively, the memory circuitry 2010 can include resistor-based and/or transistor-less memory architectures. In some examples, the memory circuitry 2010 can refer to a die, chip, and/or a packaged memory product. In some implementations, the memory 2010 can be or include the on-die memory or registers associated with the processor circuitry 2002. Additionally or alternatively, the memory 2010 can include any of the devices/components discussed infra w.r.t the storage circuitry 2020.

The storage 2020 (also referred to as “storage circuitry 2020”) provides persistent storage of information, such as data, OSs, apps, instructions 2021, and/or other software elements. As examples, the storage 2020 may be embodied as a magnetic disk storage device, hard disk drive (HDD), microHDD, solid-state drive (SSD), optical storage device, flash memory devices, memory card (e.g., secure digital (SD) card, eXtreme Digital (XD) picture card, USB flash drives, SIM cards, and/or the like), and/or any combination thereof. The storage circuitry 2020 can also include specific storage units, such as storage devices and/or storage disks that include optical disks (e.g., DVDs, CDs/CD-ROM, Blu-ray disks, and the like), flash drives, floppy disks, hard drives, and/or any number of other hardware devices in which information is stored for any duration (e.g., for extended time periods, permanently, for brief instances, for temporarily buffering, and/or caching). Additionally or alternatively, the storage circuitry 2020 can include resistor-based and/or transistor-less memory architectures. Further, any number of technologies may be used for the storage 2020 in addition to, or instead of, the previously described technologies, such as, for example, resistance change memories, phase change memories, holographic memories, chemical memories, among many others. Additionally or alternatively, the storage circuitry 2020 can include any of the devices or components discussed previously w.r.t the memory 2010.

Computer program code for carrying out operations of the present disclosure (e.g., computational logic and/or instructions 2001, 2011, 2021) may be written in any combination of one or more programming languages, including object oriented programming languages, procedural programming languages, scripting languages, markup languages, and/or some other suitable programming languages including proprietary programming languages and/or development tools, or any other languages tools. The computer program/code 2001, 2011, 2021 for carrying out operations of the present disclosure may also be written in any combination of programming languages and/or machine language, such as any of those discussed herein. The program code may execute entirely on the system 2000, partly on the system 2000, as a standalone software package, partly on the system 2000 and partly on a remote computer or entirely on the remote computer or server. In the latter scenario, the remote computer may be connected to the system 2000 through any type of network, including a LAN or WAN, or the connection may be made to an external computer (e.g., through the Internet, enterprise network, and/or some other network). Additionally or alternatively, the computer program/code 2001, 2011, 2021 can include one or more operating systems (OS) and/or other software to control various aspects of the compute node 2000. The OS can include drivers to control particular devices that are embedded in the compute node 2000, attached to the compute node 2000, and/or otherwise communicatively coupled with the compute node 2000. Example OSs include consumer-based OS, real-time OS (RTOS), hypervisors, and/or the like.

The storage 2020 may include instructions 2021 in the form of software, firmware, or hardware commands to implement the techniques described herein. Although such instructions 2021 are shown as code blocks included in the memory 2010 and/or storage 2020, any of the code blocks may be replaced with hardwired circuits, for example, built into an ASIC, FPGA memory blocks/cells, and/or the like. In an example, the instructions 2001, 2011, 2021 provided via the memory 2010, the storage 2020, and/or the processor 2002 are embodied as a non-transitory or transitory machine-readable medium (also referred to as “computer readable medium” or “CRM”) including code (e.g., instructions 2001, 2011, 2021, accessible over the IX 2006, to direct the processor 2002 to perform various operations and/or tasks, such as a specific sequence or flow of actions as described herein and/or depicted in any of the accompanying drawings. The CRM may be embodied as any of the devices/technologies described for the memory 2010 and/or storage 2020.

The various components of the computing node 2000 communicate with one another over an interconnect (IX) 2006. The IX 2006 may include any number of IX (or similar) technologies including, for example, instruction set architecture (ISA), extended ISA (eISA), Inter-Integrated Circuit (I²C), serial peripheral interface (SPI), point-to-point interfaces, power management bus (PMBus), peripheral component interconnect (PCI), PCI express (PCIe), PCI extended (PCIx), Intel® Ultra Path Interconnect (UPI), Intel® Accelerator Link, Intel® QuickPath Interconnect (QPI), Intel® Omni-Path Architecture (OPA), Compute Express Link™ (CXL™) IX, RapidIO™ IX, Coherent Accelerator Processor Interface (CAPI), OpenCAPI, Advanced Microcontroller Bus Architecture (AMBA) IX, cache coherent interconnect for accelerators (CCIX), Gen-Z Consortium IXs, a HyperTransport IX, NVLink provided by NVIDIA®, ARM Advanced eXtensible Interface (AXI), a Time-Trigger Protocol (TTP) system, a FlexRay system, PROFIBUS, Ethernet, USB, On-Chip System Fabric (IOSF), Infinity Fabric (IF), and/or any number of other IX technologies. The IX 2006 may be a proprietary bus, for example, used in a SoC based system.

The communication circuitry 2060 comprises a set of hardware elements that enables the compute node 2000 to communicate over one or more networks (e.g., cloud 2065) and/or with other devices 2090. Communication circuitry 2060 includes various hardware elements, such as, for example, switches, filters, amplifiers, antenna elements, and the like to facilitate over-the-air (OTA) communications. Communication circuitry 2060 includes modem circuitry 2061 that interfaces with processor circuitry 2002 for generation and processing of baseband signals and for controlling operations of transceivers (TRx) 2062, 2063. The modem circuitry 2061 handles various radio control functions according to one or more communication protocols and/or RATs, such as any of those discussed herein. The modem circuitry 2061 includes baseband processors or control logic to process baseband signals received from a receive signal path of the TRxs 2062, 2063, and to generate baseband signals to be provided to the TRxs 2062, 2063 via a transmit signal path.

The TRxs 2062, 2063 include hardware elements for transmitting and receiving radio waves according to any number of frequencies and/or communication protocols, such as any of those discussed herein. The TRxs 2062, 2063 can include transmitters (Tx) and receivers (Rx) as separate or discrete electronic devices, or single electronic devices with Tx and Rx functionally. In either implementation, the TRxs 2062, 2063 may be configured to communicate over different networks or otherwise be used for different purposes. In one example, the TRx 2062 is configured to communicate using a first RAT (e.g., W-V2X and/or [IEEE802] RATs, such as [IEEE80211], [IEEE802154], [WiMAX], IEEE 802.11bd, ETSI ITS-G5, and/or the like) and TRx 2063 is configured to communicate using a second RAT (e.g., 3GPP RATs such as 3GPP LTE or NR/5G including C-V2X). In another example, the TRxs 2062, 2063 may be configured to communicate over different frequencies or ranges, such as the TRx 2062 being configured to communicate over a relatively short distance (e.g., devices 2090 within about 10 meters using a local Bluetooth®, devices 2090 within about 50 meters using ZigBee®, and/or the like), and TRx 2062 being configured to communicate over a relatively long distance (e.g., using [IEEE802], [WiMAX], and/or 3GPP RATs). The same or different communications techniques may take place over a single TRx at different power levels or may take place over separate TRxs.

A network interface circuitry 2030 (also referred to as “network interface controller 2030” or “NIC 2030”) provides wired communication to nodes of the cloud 2065 and/or to connected devices 2090. The wired communications may be provided according to Ethernet (e.g., [IEEE802.3]) or may be based on other types of networks, such as Controller Area Network (CAN), Local Interconnect Network (LIN), DeviceNet, ControlNet, Data Highway+, or PROFINET, among many others. As examples, the NIC 2030 may be embodied as a SmartNIC and/or one or more intelligent fabric processors (IFPs). One or more additional NICs 2030 may be included to enable connecting to additional networks. For example, a first NIC 2030 can provide communications to the cloud 2065 over an Ethernet network (e.g., [IEEE802.3]), a second NIC 2030 can provide communications to connected devices 2090 over an optical network (e.g., optical transport network (OTN), Synchronous optical networking (SONET), and synchronous digital hierarchy (SDH)), and so forth.

Given the variety of types of applicable communications from the compute node 2000 to another component, device 2090, and/or network 2065, applicable communications circuitry used by the compute node 2000 may include or be embodied by any combination of components 2030, 2040, 2050, or 2060. Accordingly, applicable means for communicating (e.g., receiving, transmitting, broadcasting, and so forth) may be embodied by such circuitry.

The acceleration circuitry 2050 (also referred to as “accelerator circuitry 2050”) includes any suitable hardware device or collection of hardware elements that are designed to perform one or more specific functions more efficiently in comparison to general-purpose processing elements. The acceleration circuitry 2050 can include various hardware elements such as, for example, one or more GPUs, FPGAs, DSPs, SoCs (including programmable SoCs and multi-processor SoCs), ASICs (including programmable ASICs), PLDs (including complex PLDs (CPLDs) and high capacity PLDs (HCPLDs), xPUs (e.g., DPUs, IPUs, and NPUs) and/or other forms of specialized circuitry designed to accomplish specialized tasks. Additionally or alternatively, the acceleration circuitry 2050 may be embodied as, or include, one or more of artificial intelligence (AI) accelerators (e.g., vision processing unit (VPU), neural compute sticks, neuromorphic hardware, deep learning processors (DLPs) or deep learning accelerators, tensor processing units (TPUs), physical neural network hardware, and/or the like), cryptographic accelerators (or secure cryptoprocessors), network processors, I/O accelerator (e.g., DMA engines and the like), and/or any other specialized hardware device/component. The offloaded tasks performed by the acceleration circuitry 2050 can include, for example, AI/ML tasks (e.g., training, feature extraction, model execution for inference/prediction, classification, and so forth), visual data processing, graphics processing, digital and/or analog signal processing, network data processing, infrastructure function management, object detection, rule analysis, and/or the like.

The TEE 2070 operates as a protected area accessible to the processor circuitry 2002 and/or other components to enable secure access to data and secure execution of instructions. In some implementations, the TEE 2070 may be a physical hardware device that is separate from other components of the system 2000 such as a secure-embedded controller, a dedicated SoC, a trusted platform module (TPM), a tamper-resistant chipset or microcontroller with embedded processing devices and memory devices, and/or the like. Additionally or alternatively, the TEE 2070 is implemented as secure enclaves (or “enclaves”), which are isolated regions of code and/or data within the processor and/or memory/storage circuitry of the compute node 2000, where only code executed within a secure enclave may access data within the same secure enclave, and the secure enclave may only be accessible using the secure app (which may be implemented by an app processor or a tamper-resistant microcontroller). In some implementations, the memory circuitry 2004 and/or storage circuitry 2008 may be divided into one or more trusted memory regions for storing apps or software modules of the TEE 2070. Additionally or alternatively, the processor circuitry 2002, acceleration circuitry 2050, memory circuitry 2010, and/or storage circuitry 2020 may be divided into, or otherwise separated into virtualized environments using a suitable virtualization technology, such as, for example, virtual machines (VMs), virtualization containers, and/or the like. These virtualization technologies may be managed and/or controlled by a virtual machine monitor (VMM), hypervisor container engines, orchestrators, and the like. Such virtualization technologies provide execution environments in which one or more apps and/or other software, code, or scripts may execute while being isolated from one or more other apps, software, code, or scripts.

The input/output (I/O) interface circuitry 2040 (also referred to as “interface circuitry 2040”) is used to connect additional devices or subsystems. The interface circuitry 2040, is part of, or includes circuitry that enables the exchange of information between two or more components or devices such as, for example, between the compute node 2000 and various additional/external devices (e.g., sensor circuitry 2042, actuator circuitry 2044, and/or positioning circuitry 2043). Access to various such devices/components may be implementation specific, and may vary from implementation to implementation. At least in some examples, the interface circuitry 2040 includes one or more hardware interfaces such as, for example, buses, input/output (I/O) interfaces, peripheral component interfaces, network interface cards, and/or the like. Additionally or alternatively, the interface circuitry 2040 includes a sensor hub or other like elements to obtain and process collected sensor data and/or actuator data before being passed to other components of the compute node 2000.

The sensor circuitry 2042 includes devices, modules, or subsystems whose purpose is to detect events or changes in its environment and send the information (sensor data) about the detected events to some other a device, module, subsystem, and the like. In some implementations, the sensor(s) 2042 are the same or similar as the sensors 1312 of FIG. 13. Individual sensors 2042 may be exteroceptive sensors (e.g., sensors that capture and/or measure environmental phenomena and/ external states), proprioceptive sensors (e.g., sensors that capture and/or measure internal states of the compute node 2000 and/or individual components of the compute node 2000), and/or exproprioceptive sensors (e.g., sensors that capture, measure, or correlate internal states and external states). Examples of such sensors 2042 include inertia measurement units (IMU), microelectromechanical systems (MEMS) or nanoelectromechanical systems (NEMS), level sensors, flow sensors, temperature sensors (e.g., thermistors, including sensors for measuring the temperature of internal components and sensors for measuring temperature external to the compute node 2000), pressure sensors, barometric pressure sensors, gravimeters, altimeters, image capture devices (e.g., visible light cameras, thermographic camera and/or thermal imaging camera (TIC) systems, forward-looking infrared (FLIR) camera systems, radiometric thermal camera systems, active infrared (IR) camera systems, ultraviolet (UV) camera systems, and/or the like), light detection and ranging (LiDAR) sensors, proximity sensors (e.g., IR radiation detector and the like), depth sensors, ambient light sensors, optical light sensors, ultrasonic transceivers, microphones, inductive loops, and/or the like. The IMUs, MEMS, and/or NEMS can include, for example, one or more 3-axis accelerometers, one or more 3-axis gyroscopes, one or more magnetometers, one or more compasses, one or more barometers, and/or the like.

Additional or alternative examples of the sensor circuitry 2042 used for various aerial asset and/or vehicle control systems can include one or more of exhaust sensors including exhaust oxygen sensors to obtain oxygen data and manifold absolute pressure (MAP) sensors to obtain manifold pressure data; mass air flow (MAF) sensors to obtain intake air flow data; intake air temperature (IAT) sensors to obtain IAT data; ambient air temperature (AAT) sensors to obtain AAT data; ambient air pressure (AAP) sensors to obtain AAP data; catalytic converter sensors including catalytic converter temperature (CCT) to obtain CCT data and catalytic converter oxygen (CCO) sensors to obtain CCO data; vehicle speed sensors (VSS) to obtain VSS data; exhaust gas recirculation (EGR) sensors including EGR pressure sensors to obtain ERG pressure data and EGR position sensors to obtain position/orientation data of an EGR valve pintle; Throttle Position Sensor (TPS) to obtain throttle position/orientation/angle data; a crank/cam position sensors to obtain crank/cam/piston position/orientation/angle data; coolant temperature sensors; pedal position sensors; accelerometers; altimeters; magnetometers; level sensors; flow/fluid sensors, barometric pressure sensors, vibration sensors (e.g., shock & vibration sensors, motion vibration sensors, main and tail rotor vibration monitoring and balancing (RTB) sensor(s), gearbox and drive shafts vibration monitoring sensor(s), bearings vibration monitoring sensor(s), oil cooler shaft vibration monitoring sensor(s), engine vibration sensor(s) to monitor engine vibrations during steady-state and transient phases, and/or the like), force and/or load sensors, remote charge converters (RCC), rotor speed and position sensor(s), fiber optic gyro (FOG) inertial sensors, Attitude & Heading Reference Unit (AHRU), fibre Bragg grating (FBG) sensors and interrogators, tachometers, engine temperature gauges, pressure gauges, transformer sensors, airspeed-measurement meters, vertical speed indicators, and/or the like.

The actuators 2044 allow compute node 2000 to change its state, position, and/or orientation, or move or control a mechanism or system. The actuators 2044 comprise electrical and/or mechanical devices for moving or controlling a mechanism or system, and converts energy (e.g., electric current or moving air and/or liquid) into some kind of motion. Additionally or alternatively, the actuators 2044 can include electronic controllers linked or otherwise connected to one or more mechanical devices and/or other actuation devices. As examples, the actuators 2044 can be or include any number and combination of the following: soft actuators (e.g., actuators that changes its shape in response to a stimuli such as, for example, mechanical, thermal, magnetic, and/or electrical stimuli), hydraulic actuators, pneumatic actuators, mechanical actuators, electromechanical actuators (EMAs), microelectromechanical actuators, electrohydraulic actuators, linear actuators, linear motors, rotary motors, DC motors, stepper motors, servomechanisms, electromechanical switches, electromechanical relays (EMRs), power switches, valve actuators, piezoelectric actuators and/or biomorphs, thermal biomorphs, solid state actuators, solid state relays (SSRs), shape-memory alloy-based actuators, electroactive polymer-based actuators, relay driver integrated circuits (ICs), solenoids, impactive actuators/mechanisms (e.g., jaws, claws, tweezers, clamps, hooks, mechanical fingers, humaniform dexterous robotic hands, and/or other gripper mechanisms that physically grasp by direct impact upon an object), propulsion actuators/mechanisms (e.g., wheels, axles, thrusters, propellers, engines, motors, servos, clutches, rotors, and the like), projectile actuators/mechanisms (e.g., mechanisms that shoot or propel objects or elements), payload actuators, audible sound generators (e.g., speakers and the like), LEDs and/or visual warning devices, and/or other like electromechanical components. Additionally or alternatively, the actuators 2044 can include virtual instrumentation and/or virtualized actuator devices.

Additionally or alternatively, the interface circuitry 2040 and/or the actuators 2044 can include various individual controllers and/or controllers belonging to one or more components of the compute node 2000 such as, for example, host controllers, cooling element controllers, baseboard management controller (BMC), platform controller hub (PCH), uncore components (e.g., shared last level cache (LLC) cache, caching agent (Cbo), integrated memory controller (IMC), home agent (HA), power control unit (PCU), configuration agent (Ubox), integrated I/O controller (IIO), and interconnect (IX) link interfaces and/or controllers), and/or any other components such as any of those discussed herein. The compute node 2000 may be configured to operate one or more actuators 2044 based on one or more captured events, instructions, control signals, and/or configurations received from a service provider, client device, and/or other components of the compute node 2000. Additionally or alternatively, the actuators 2044 can include mechanisms that are used to change the operational state (e.g., on/off, zoom or focus, and/or the like), position, and/or orientation of one or more sensors 2042.

In some implementations, such as when the compute node 2000 is part of a vehicle system (e.g., V-ITS-S 1310 of FIG. 13), the actuators 2044 correspond to the driving control units (DCUs) 1314 discussed previously w.r.t FIG. 13. In some implementations, such as when the compute node 2000 is part of roadside equipment (e.g., R-ITS-S 1330 of FIG. 13), the actuators 2044 can be used to change the operational state of the roadside equipment or other roadside equipment, such as gates, traffic lights, digital signage or variable message signs (VMS), and/or the like. The actuators 2044 are configured to receive control signals from the R-ITS-S 1330 via a roadside network, and convert the signal energy (or some other energy) into an electrical and/or mechanical motion. The control signals may be relatively low energy electric voltage or current.

The positioning circuitry (pos) 2043 includes circuitry to receive and decode signals transmitted/broadcasted by a positioning network of a global navigation satellite system (GNSS). Examples of navigation satellite constellations (or GNSS) include United States’ Global Positioning System (GPS), Russia’s Global Navigation System (GLONASS), the European Union’s Galileo system, China’s BeiDou Navigation Satellite System, a regional navigation system or GNSS augmentation system (e.g., Navigation with Indian Constellation (NAVIC), Japan’s Quasi-Zenith Satellite System (QZSS), France’s Doppler Orbitography and Radio-positioning Integrated by Satellite (DORIS), and the like), or the like. The positioning circuitry 2045 comprises various hardware elements (e.g., including hardware devices such as switches, filters, amplifiers, antenna elements, and the like to facilitate OTA communications) to communicate with components of a positioning network, such as navigation satellite constellation nodes. Additionally or alternatively, the positioning circuitry 2045 may include a Micro-Technology for Positioning, Navigation, and Timing (Micro-PNT) IC that uses a master timing clock to perform position tracking/estimation without GNSS assistance. The positioning circuitry 2045 may also be part of, or interact with, the communication circuitry 2060 to communicate with the nodes and components of the positioning network. The positioning circuitry 2045 may also provide position data and/or time data to the application circuitry (e.g., processor circuitry 2002), which may use the data to synchronize operations with various infrastructure (e.g., radio base stations), for turn-by-turn navigation, or the like. In some implementations, the positioning circuitry 2045 is, or includes an INS, which is a system or device that uses sensor circuitry 2042 (e.g., motion sensors such as accelerometers, rotation sensors such as gyroscopes, and altimeters, magnetic sensors, and/or the like to continuously calculate (e.g., using dead by dead reckoning, triangulation, or the like) a position, orientation, and/or velocity (including direction and speed of movement) of the platform 2000 without the need for external references.

In some examples, various I/O devices may be present within or connected to, the compute node 2000, which are referred to as input circuitry 2046 and output circuitry 2045. The input circuitry 2046 and output circuitry 2045 include one or more user interfaces designed to enable user interaction with the platform 2000 and/or peripheral component interfaces designed to enable peripheral component interaction with the platform 2000. The input circuitry 2046 and/or output circuitry 2045 may be, or may be part of a Human Machine Interface (HMI), such as HMI 1706, 1806, 1906. Input circuitry 2046 includes any physical or virtual means for accepting an input including buttons, switches, dials, sliders, keyboard, keypad, mouse, touchpad, touchscreen, microphone, scanner, headset, and/or the like. The output circuitry 2045 may be included to show information or otherwise convey information, such as sensor readings, actuator position(s), or other like information. Data and/or graphics may be displayed on one or more user interface components of the output circuitry 2045. Output circuitry 2045 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, and the like), with the output of characters, graphics, multimedia objects, and the like being generated or produced from the operation of the compute node 2000. The output circuitry 2045 may also include speakers or other audio emitting devices, printer(s), and/or the like. Additionally or alternatively, the sensor circuitry 2042 may be used as the input circuitry 2045 (e.g., an image capture device, motion capture device, or the like) and one or more actuators 2044 may be used as the output device circuitry 2045 (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, and the like. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 2080 can be used to power the compute node 2000, although, in examples in which the compute node 2000 is mounted in a fixed location, it may have a power supply coupled to an electrical grid, or the battery 2080 may be used as a backup power source. As examples, the battery 2080 can be a lithium ion battery or a metal-air battery (e.g., zinc-air battery, aluminum-air battery, lithium-air battery, and the like). Other battery technologies may be used in other implementations.

A battery monitor/charger 2082 may be included in the compute node 2000 to track various measurements and/or metrics of the battery 2080 (“battery parameters”) such as, for example, voltage (e.g., minimum and/or maximum cell voltage), state of charge (SoCh or SoC) or depth of discharge (DoD) (e.g., the charge level of the battery 2080; state of health (SoH) (e.g., a variously-defined measurement of the remaining capacity of the battery 2080 as % of the original, full, or total capacity); state of function (SoF) (e.g., reflects battery readiness in terms of usable energy by observing state-of-charge in relation to the available capacity), state of power (SoP) (e.g., the amount of power available for a defined time interval given the current power usage, temperature, and other conditions), state of safety (SOS), a charge current limit (CCL) (e.g., maximum charge current), discharge current limit (DCL) (e.g., maximum discharge current), energy [kWh] delivered since last charge or charge cycle, internal impedance of a cell (e.g., to determine open circuit voltage), charge [Ah] delivered or stored (also referred to as a Coulomb counter), total energy delivered since first use, total operating time since first use, total number of cycles, temperature monitoring measurements/metrics, coolant flow for air or liquid cooled batteries, and/or the like. The battery monitor/charger 2082 includes a battery monitoring IC and is capable of communicating the battery parameters to the processor 2002 over the IX 2006. In some implementations, the battery monitor/charger 2082 includes an analog-to-digital (ADC) converter that enables the processor 2002 to directly monitor the voltage of the battery 2080 and/or the current flow from the battery 2080. The battery parameters may be used to determine actions that the compute node 2000 may perform, such as transmission frequency, mesh network operation, sensing frequency, charging time, charging current/voltage draw, battery failure predictions, and the like. In various implementations, the battery monitor/charger 2082 corresponds to the OBC 1082 and/or BMC 1084 of FIG. 10.

A power block 2085, or other power supply coupled to a grid, may be coupled with the battery monitor/charger 2082 to charge the battery 2080. In some examples, the power block 2085 may be replaced with a wireless power receiver to obtain the power wirelessly, for example, through a loop antenna in the compute node 2000. A wireless battery charging circuit may be included in the battery monitor/charger 2082. The specific charging circuits may be selected based on the size of the battery 2080, and thus, the current required. The charging may be performed according to Airfuel Alliance standards, the Qi wireless charging standard, the Rezence charging standard, among others.

The example of FIG. 20 is intended to depict a high-level view of components of a varying device, subsystem, or arrangement of a computing node 2000. However, in other implementations, some of the components shown may be omitted, additional components may be present, and a different arrangement of the components shown may occur in other implementations. Further, these arrangements are usable in a variety of use cases and environments, including those discussed herein.

### 3. Example Implementations

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example includes a method of operating a road usage monitoring service (RUM) of a vehicle station, comprising: obtaining positioning information of the vehicle station from positioning circuitry, wherein the positioning information is based on mobility of the vehicle station; determining RUM information of the vehicle station based on the positioning information, wherein the RUM information includes road usage data of the vehicle station; generating a RUM message to include the determined RUM information; and transmitting the RUM message to an infrastructure node.

Example includes the method of example [0188] and/or some other example(s) herein, wherein the method includes: receiving mapping data from a mapping service; determining a travel route based on the positioning information; determining one or more geographical areas (geo-areas) through which the vehicle station travelled based on the determined travel route; and generating the RUM information to include the one or more geo-areas.

Example includes the method of example [0189] and/or some other example(s) herein, wherein the processor circuitry is to operate the RUM to generate the RUM information to include: a vehicle identifier (ID) of the vehicle station, a start timestamp for the road usage data, an end timestamp for the road usage data, and a set of geo-area tuples, wherein each geo-area tuple of the set of geo-area tuples includes a geo-area ID and a corresponding distance travelled in a geo-area associated with the geo-area ID.

Example includes the method of example [0190] and/or some other example(s) herein, wherein the processor circuitry is to operate the RUM to: store the RUM information as a set of duration bins in local storage circuitry of the vehicle station.

Example includes the method of examples [0188]-[0191] and/or some other example(s) herein, wherein method includes: generating the RUM message; and transmitting the RUM message.

Example includes the method of examples [0188]-[0191] and/or some other example(s) herein, wherein the method includes: determining the RUM information on a periodic basis.

Example includes the method of examples [0188]-[0193] and/or some other example(s) herein, wherein the method includes: obtaining a set of battery parameters from battery charging circuitry of the vehicle station; and determining the RUM information based on the battery parameters.

Example includes the method of example [0194] and/or some other example(s) herein, the method includes: obtaining the set of battery parameters from the battery charging circuitry after a charging process has completed.

Example includes the method of example [0194]-[0195] and/or some other example(s) herein, wherein the battery charging circuitry includes on-board charging circuitry and a battery management system.

Example includes the method of examples [0188]-[0196] and/or some other example(s) herein, wherein the vehicle station is a vehicle intelligent transport system station (ITS-S) and the infrastructure node is a roadside ITS-S or a central ITS-S, and wherein the RUM is an ITS-S application in an ITS applications layer or the RUM is an ITS-S facility in an ITS facilities layer.

Example includes the method of example [0197] and/or some other example(s) herein, wherein the central ITS-S is part of an edge compute node or a cloud computing service.

Example includes a method of operating a road usage monitoring (RUM) service, comprising: receiving, by an infrastructure node, a first RUM message from a vehicle station, wherein the first RUM message includes vehicle information related to mobility of the vehicle station; extracting, by the infrastructure node, the vehicle information from the first RUM message; generating, by the infrastructure node, a second RUM message including the extracted vehicle information; and transmitting, by the infrastructure node, the second RUM message to a cloud-based RUM service.

Example includes the method of example [0199] and/or some other example(s) herein, wherein the vehicle information includes a vehicle identifier (ID) of the vehicle station, location data of the vehicle station, and heading direction of the vehicle station, and one or both of speed data of the vehicle station and a station type of the vehicle station.

Example includes the method of example [0200] and/or some other example(s) herein, wherein the method comprises: determining, by the infrastructure node, a travel distance of the vehicle station based on the location data and location data included in a previously received first RUM message from the vehicle station; and generating, by the infrastructure node, the second RUM message when the travel distance is larger than a threshold distance.

Example includes the method of examples [0199]-[0201] and/or some other example(s) herein, wherein the method comprises: receiving, by an infrastructure node, sensor data from respective sensors; performing, by the infrastructure node, environment perception based on the sensor data to identify the another vehicle station; generating, by the infrastructure node, the other vehicle information for the other vehicle station based on the environment perception; and transmitting, by the infrastructure node, another second RUM message to the cloud-based RUM service.

Example includes the method of examples [0199]-[0202] and/or some other example(s) herein, wherein the vehicle station is a vehicle intelligent transport system station (ITS-S), the infrastructure node is a roadside ITS-S or a central ITS-S, and the cloud-based RUM service is part of the central ITS-S or a different central ITS-S.

Example includes the method of example [0203] and/or some other example(s) herein, wherein the central ITS-S is part of an edge compute node or a cloud computing service, and the other central ITS-S is part of an edge compute node or a cloud computing service.

Example includes a method of operating a road usage monitoring (RUM) service, comprising: receiving a RUM message from a vehicle station, wherein the RUM message includes vehicle information related to mobility of the vehicle station; obtaining historic vehicle data from a RUM database; estimating a travel path of the vehicle station based on the vehicle information and the historic vehicle data; determining one or more geographical areas (geo-areas) through which the vehicle station travelled based on the determined travel path; estimating a distance travelled by the vehicle station based on the travel path and the determined one or more geo-areas; and store the travel path, the one or more geo-areas, and the estimated distance in the RUM database.

Example includes the method of example [0205] and/or some other example(s) herein, wherein the method includes: receiving the RUM message via an infrastructure node.

Example includes the method of examples [0205]-[0206] and/or some other example(s) herein, wherein the vehicle information includes a vehicle identifier (ID) of the vehicle station, location data of the vehicle station, and heading direction of the vehicle station, and one or both of speed data of the vehicle station and a station type of the vehicle station.

Example includes the method of examples [0205]-[0207] and/or some other example(s) herein, wherein the method includes: determining a road usage charge based on the estimated distance.

Example includes the method of examples [0205]-[0208] and/or some other example(s) herein, wherein the vehicle station is a vehicle intelligent transport system station (ITS-S) and the compute node is a roadside ITS-S or a central ITS-S, and wherein the RUM is an ITS-S application in an ITS applications layer, or the RUM is an ITS-S facility in an ITS facilities layer.

Example includes the method of examples [0205]-[0209] and/or some other example(s) herein, wherein the compute node is an edge compute node or a cloud computing service.

Example includes a method of operating electric vehicle supply equipment (EVSE) circuitry, comprising: controlling charging of a rechargeable battery of a vehicle station, and monitor an amount of charge applied to the rechargeable battery; operating a road usage monitoring service (RUM) to determine a road usage fee based on the amount of charge applied to the rechargeable battery; and transmitting the road usage fee to an infrastructure node or to a client application for display.

Example includes the method of example [0211] and/or some other example(s) herein, wherein the EVSE is a direct current (DC) fast charger separate from the vehicle station, or the EVSE is an alternating current (AC) charger implemented by the vehicle station.

Example includes one or more computer readable media comprising instructions, wherein execution of the instructions by processor circuitry is to cause the processor circuitry to perform the method of examples [0188]-[0212] and/or some other example(s) herein.

Example includes a computer program comprising the instructions of example [0213] and/or some other example(s) herein.

Example includes an Application Programming Interface defining functions, methods, variables, data structures, and/or protocols for the computer program of example [0214] and/or some other example(s) herein.

Example includes an apparatus comprising circuitry loaded with the instructions of example [0213] and/or some other example(s) herein.

Example includes an apparatus comprising circuitry operable to run the instructions of example [0213] and/or some other example(s) herein.

Example includes an integrated circuit comprising one or more of the processor circuitry and the one or more computer readable media of example [0213] and/or some other example(s) herein.

Example includes a computing system comprising the one or more computer readable media and the processor circuitry of example [0213] and/or some other example(s) herein.

Example includes an apparatus comprising means for executing the instructions of example [0213] and/or some other example(s) herein.

Example includes a signal generated as a result of executing the instructions of example [0213] and/or some other example(s) herein.

Example includes a data unit generated as a result of executing the instructions of example [0213] and/or some other example(s) herein.

Example includes the data unit of example [0222] and/or some other example(s) herein, wherein the data unit is a packet, frame, datagram, protocol data unit (PDU), service data unit (SDU), segment, message, data block, data chunk, cell, data field, data element, information element, type length value, set of bytes, set of bits, set of symbols, and/or database object.

Example includes a signal encoded with the data unit of examples [0222]-[0223] and/or some other example(s) herein.

Example includes an electromagnetic signal carrying the instructions of example [0213] and/or some other example(s) herein.

Example [0188] includes an apparatus comprising means for performing the method of examples [0188]-[0212] and/or some other example(s) herein.

### 4. Terminology

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” each of which may refer to one or more of the same or different embodiments. Furthermore, the terms “comprising,” “including,” “having,” and the like, as used w.r.t the present disclosure, are synonymous.

The terms “master” and “slave” at least in some examples refers to a model of asymmetric communication or control where one device, process, element, or entity (the “master”) controls one or more other device, process, element, or entity (the “slaves”). The terms “master” and “slave” are used in this disclosure only for their technical meaning. The term “master” or “grandmaster” may be substituted with any of the following terms “main”, “source”, “primary”, “initiator”, “requestor”, “transmitter”, “host”, “maestro”, “controller”, “provider”, “producer”, “client”, “source”, “mix”, “parent”, “chief”, “manager”, “reference” (e.g., as in “reference clock” or the like), and/or the like. Additionally, the term “slave” may be substituted with any of the following terms “receiver”, “secondary”, “subordinate”, “replica”, target”, “responder”, “device”, “performer”, “agent”, “standby”, “consumer”, “peripheral”, “follower”, “server”, “child”, “helper”, “worker”, “node”, and/or the like.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some examples refers to (partial or in full) acts, tasks, operations, and the like, related to bringing or the readying the bringing of something into existence either actively or passively (e.g., exposing a device identity or entity identity). Additionally or alternatively, the term “establish” or “establishment” at least in some examples refers to (partial or in full) acts, tasks, operations, and the like, related to initiating, starting, or warming communication or initiating, starting, or warming a relationship between two entities or elements (e.g., establish a session, establish a session, and the like). Additionally or alternatively, the term “establish” or “establishment” at least in some examples refers to initiating something to a state of working readiness. The term “established” at least in some examples refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some examples refers to (partial or in full) acts, tasks, operations, and the like, of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “receipt” at least in some examples refers to any action (or set of actions) involved with receiving or obtaining an object, data, data unit, and the like, and/or the fact of the object, data, data unit, and the like being received. The term “receipt” at least in some examples refers to an object, data, data unit, and the like, being pushed to a device, system, element, and the like (e.g., often referred to as a push model), pulled by a device, system, element, and the like (e.g., often referred to as a pull model), and/or the like.

The term “element” at least in some examples refers to a unit that is indivisible at a given level of abstraction and has a clearly defined boundary, wherein an element may be any type of entity including, for example, one or more devices, systems, controllers, network elements, modules, and so forth, or combinations thereof.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value. Additionally or alternatively, the term “measurement” at least in some examples refers to data recorded during testing.

The term “metric” at least in some examples refers to a quantity produced in an assessment of a measured value. Additionally or alternatively, the term “metric” at least in some examples refers to data derived from a set of measurements. Additionally or alternatively, the term “metric” at least in some examples refers to set of events combined or otherwise grouped into one or more values. Additionally or alternatively, the term “metric” at least in some examples refers to a combination of measures or set of collected data points. Additionally or alternatively, the term “metric” at least in some examples refers to a standard definition of a quantity, produced in an assessment of performance and/or reliability of the network, which has an intended utility and is carefully specified to convey the exact meaning of a measured value.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The terms “ego” (as in, e.g., “ego device”) and “subject” (as in, e.g., “data subject”) at least in some examples refers to an entity, element, device, system, and the like, that is under consideration or being considered. The terms “neighbor” and “proximate” (as in, e.g., “proximate device”) at least in some examples refers to an entity, element, device, system, and the like, other than an ego device or subject device.

The term “identifier” at least in some examples refers to a value, or a set of values, that uniquely identify an identity in a certain scope. Additionally or alternatively, the term “identifier” at least in some examples refers to a sequence of characters that identifies or otherwise indicates the identity of a unique object, element, or entity, or a unique class of objects, elements, or entities. Additionally or alternatively, the term “identifier” at least in some examples refers to a sequence of characters used to identify or refer to an application, program, session, object, element, entity, variable, set of data, and/or the like. The “sequence of characters” mentioned previously at least in some examples refers to one or more names, labels, words, numbers, letters, symbols, and/or any combination thereof. Additionally or alternatively, the term “identifier” at least in some examples refers to a name, address, label, distinguishing index, and/or attribute. Additionally or alternatively, the term “identifier” at least in some examples refers to an instance of identification. The term “persistent identifier” at least in some examples refers to an identifier that is reused by a device or by another device associated with the same person or group of persons for an indefinite period. The term “identification” at least in some examples refers to a process of recognizing an identity as distinct from other identities in a particular scope or context, which may involve processing identifiers to reference an identity in an identity database. The term “application identifier”, “application ID”, or “app ID” at least in some examples refers to an identifier that can be mapped to a specific application, application instance, or application instance. In the context of 3GPP 5G/NR, an “application identifier” at least in some examples refers to an identifier that can be mapped to a specific application traffic detection rule.

The term “circuitry” at least in some examples refers to a circuit, a system of multiple circuits, and/or a combination of hardware elements configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), system-on-chip (SoC), single-board computer (SBC), system-in-package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The terms “computer-readable medium”, “machine-readable medium”, “computer-readable storage medium”, and the like, at least in some examples refers to any tangible medium that is capable of storing, encoding, and/or carrying data structures, code, and/or instructions for execution by a processing device or other machine. Additionally or alternatively, the terms “computer-readable medium”, “machine-readable medium”, “computer-readable storage medium”, and the like, at least in some examples refers to any tangible medium that is capable of storing, encoding, and/or carrying data structures, code, and/or instructions that cause the processing device or machine to perform any one or more of the methodologies of the present disclosure. The terms “computer-readable medium”, “machine-readable medium”, “computer-readable storage medium”, and the like, at least in some examples refers include, but is/are not limited to, memory device(s), storage device(s) (including portable or fixed), and/or any other media capable of storing, containing, or carrying instructions or data.

The term “device” at least in some examples refers to a physical entity embedded inside, or attached to, another physical entity in its vicinity, with capabilities to convey digital information from or to that physical entity. The term “entity” at least in some examples refers to a distinct component of an architecture or device, or information transferred as a payload. The term “controller” at least in some examples refers to an element or entity that has the capability to affect a physical entity, such as by changing its state or causing the physical entity to move. The term “scheduler” at least in some examples refers to an entity or element that assigns resources (e.g., processor time, network links, memory space, and/or the like) to perform tasks. The term “network scheduler” at least in some examples refers to a node, element, or entity that manages network packets in transmit and/or receive queues of one or more protocol stacks of network access circuitry (e.g., a network interface controller (NIC), baseband processor, and the like). The term “network scheduler” at least in some examples can be used interchangeably with the terms “packet scheduler”, “queueing discipline” or “qdisc”, and/or “queueing algorithm”.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like. For purposes of the present disclosure, the term “node” at least in some examples refers to and/or is interchangeable with the terms “device”, “component”, “sub-system”, and/or the like. The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and the like. Furthermore, the term “user equipment” or “UE” may include any type of wireless/wired device or any computing device including a wireless communications interface. Examples of UEs, client devices, and the like, include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, and/or other like systems or devices. The term “station” or “STA” at least in some examples refers to a logical entity that is a singly addressable instance of a medium access control (MAC) and physical layer (PHY) interface to the wireless medium (WM). The term “wireless medium” or WM” at least in some examples refers to the medium used to implement the transfer of protocol data units (PDUs) between peer physical layer (PHY) entities of a wireless local area network (LAN).

The term “network element” at least in some examples refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like. The term “network controller” at least in some examples refers to a functional block that centralizes some or all of the control and management functionality of a network domain and may provide an abstract view of the network domain to other functional blocks via an interface.

The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” may include specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, Transmission Reception Point (TRxP), a gateway device (e.g., Residential Gateway, Wireline 5G Access Network, Wireline 5G Cable Access Network, Wireline BBF Access Network, and the like), network appliance, and/or some other network access hardware. The term “E-UTEAN NodeB”, “eNodeB”, or “eNB” at least in some examples refers to a RAN node providing E-UTRA user plane (PDCP/RLC/MAC/PHY) and control plane (RRC) protocol terminations towards a UE, and connected via an S 1 interface to the Evolved Packet Core (EPC). Two or more eNBs are interconnected with each other (and/or with one or more en-gNBs) by means of an X2 interface. The term “next generation eNB” or “ng-eNB” at least in some examples refers to a RAN node providing E-UTRA user plane and control plane protocol terminations towards a UE, and connected via the NG interface to the 5GC. Two or more ng-eNBs are interconnected with each other (and/or with one or more gNBs) by means of an Xn interface. The term “Next Generation NodeB”, “gNodeB”, or “gNB” at least in some examples refers to a RAN node providing NR user plane and control plane protocol terminations towards a UE, and connected via the NG interface to the 5GC. Two or more gNBs are interconnected with each other (and/or with one or more ng-eNBs) by means of an Xn interface. The term “E-UTRA-NR gNB” or “en-gNB” at least in some examples refers to a RAN node providing NR user plane and control plane protocol terminations towards a UE, and acting as a Secondary Node in E-UTRA-NR Dual Connectivity (EN-DC) scenarios (see e.g., 3GPP TS 37.340 v17.0.0 (2022-04-15) (“[TS37340]”)). Two or more en-gNBs are interconnected with each other (and/or with one or more eNBs) by means of an X2 interface. The term “Next Generation RAN node” or “NG-RAN node” at least in some examples refers to either a gNB or an ng-eNB. The term “IAB-node” at least in some examples refers to a RAN node that supports new radio (NR) access links to user equipment (UEs) and NR backhaul links to parent nodes and child nodes. The term “IAB-donor” at least in some examples refers to a RAN node (e.g., a gNB) that provides network access to UEs via a network of backhaul and access links. The term “Transmission Reception Point” or “TRxP” at least in some examples refers to an antenna array with one or more antenna elements available to a network located at a specific geographical location for a specific area. The term “access point” or “AP” at least in some examples refers to an entity that contains one station (STA) and provides access to the distribution services, via the wireless medium (WM) for associated STAs. An AP comprises a STA and a distribution system access function (DSAF). The term “cell” at least in some examples refers to a radio network object that can be uniquely identified by a UE from an identifier (e.g., cell ID) that is broadcasted over a geographical area from a network access node (NAN). Additionally or alternatively, the term “cell” at least in some examples refers to a geographic area covered by a NAN.

The term “network function” or “NF” at least in some examples refers to a functional block within a network infrastructure that has one or more external interfaces and a defined functional behavior. The term “network service” or “NS” at least in some examples refers to a composition or collection of NFs and/or network services defined by its functional and behavioral specification(s). The term “RAN function” or “RANF” at least in some examples refers to a functional block within a RAN architecture that has one or more external interfaces and a defined behavior related to the operation of a RAN or RAN node. Additionally or alternatively, the term “RAN function” or “RANF” at least in some examples refers to a set of functions and/or NFs that are part of a RAN. The term “Application Function” or “AF” at least in some examples refers to an element or entity that interacts with a 3GPP core network in order to provide services. Additionally or alternatively, the term “Application Function” or “AF” at least in some examples refers to an edge compute node or ECT framework from the perspective of a 5G core network. The term “edge compute function” or “ECF” at least in some examples refers to an element or entity that performs an aspect of an edge computing technology (ECT), an aspect of edge networking technology (ENT), or performs an aspect of one or more edge computing services running over the ECT or ENT.

The term “management function” at least in some examples refers to a logical entity playing the roles of a service consumer and/or a service producer. The term “management service” at least in some examples refers to a set of offered management capabilities.

The term “network function virtualization” or “NFV” at least in some examples refers to the principle of separating network functions from the hardware they run on by using virtualisation techniques and/or virtualization technologies.

The term “virtualized network function” or “VNF” at least in some examples refers to an implementation of an NF that can be deployed on a Network Function Virtualisation Infrastructure (NFVI).

The term “Network Functions Virtualisation Infrastructure Manager” or “NFVI” at least in some examples refers to a totality of all hardware and software components that build up the environment in which VNFs are deployed.

The term “service producer” at least in some examples refers to an entity that offers, serves, or otherwise provides one or more services.

The term “service provider” at least in some examples refers to an organization or entity that provides one or more services to at least one service consumer. For purposes of the present disclosure, the terms “service provider” and “service producer” may be used interchangeably even though these terms may refer to difference concepts. Examples of service providers include cloud service provider (CSP), network service provider (NSP), application service provider (ASP) (e.g., Application software service provider in a service-oriented architecture (ASSP)), internet service provider (ISP), telecommunications service provider (TSP), online service provider (OSP), payment service provider (PSP), managed service provider (MSP), storage service providers (SSPs), SAML service provider, and/or the like. At least in some examples, SLAs may specify, for example, particular aspects of the service to be provided including quality, availability, responsibilities, metrics by which service is measured, as well as remedies or penalties should agreed-on service levels not be achieved. The term “SAML service provider” at least in some examples refers to a system and/or entity that receives and accepts authentication assertions in conjunction with a single sign-on (SSO) profile of the Security Assertion Markup Language (SAML) and/or some other security mechanism(s).

The term “Virtualized Infrastructure Manager” or “VIM” at least in some examples refers to a functional block that is responsible for controlling and managing the NFVI compute, storage and network resources, usually within one operator’s infrastructure domain.

The term “virtualization container”, “execution container”, or “container” at least in some examples refers to a partition of a compute node that provides an isolated virtualized computation environment. The term “OS container” at least in some examples refers to a virtualization container utilizing a shared Operating System (OS) kernel of its host, where the host providing the shared OS kernel can be a physical compute node or another virtualization container. Additionally or alternatively, the term “container” at least in some examples refers to a standard unit of software (or a package) including code and its relevant dependencies, and/or an abstraction at the application layer that packages code and dependencies together. Additionally or alternatively, the term “container” or “container image” at least in some examples refers to a lightweight, standalone, executable software package that includes everything needed to run an application such as, for example, code, runtime environment, system tools, system libraries, and settings.

The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

The term “edge computing” at least in some examples refers to an implementation or arrangement of distributed computing elements that move processing activities and resources (e.g., compute, storage, acceleration, and/or network resources) towards the “edge” of the network in an effort to reduce latency and increase throughput for endpoint users (client devices, user equipment, and the like). Additionally or alternatively, term “edge computing” at least in some examples refers to a set of services hosted relatively close to a client/UE’s access point of attachment to a network to achieve relatively efficient service delivery through reduced end-to-end latency and/or load on the transport network. In some examples, edge computing implementations involve the offering of services and/or resources in a cloud-like systems, functions, applications, and subsystems, from one or multiple locations accessible via wireless networks.

The term “edge compute node” or “edge compute device” at least in some examples refers to an identifiable entity implementing an aspect of edge computing operations, whether part of a larger system, distributed collection of systems, or a standalone apparatus. In some examples, a compute node may be referred to as a “edge node”, “edge device”, “edge system”, whether in operation as a client, server, or intermediate entity. Additionally or alternatively, the term “edge compute node” at least in some examples refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. however, references to an “edge computing system” generally refer to a distributed architecture, organization, or collection of multiple nodes and devices, and which is organized to accomplish or offer some aspect of services or resources in an edge computing setting. The term “edge computing platform” or “edge platform” at least in some examples refers to a collection of functionality that is used to instantiate, execute, or run edge applications on a specific edge compute node (e.g., virtualisation infrastructure and/or the like), enable such edge applications to provide and/or consume edge services, and/or otherwise provide one or more edge services. The term “edge application” or “edge app” at least in some examples refers to an application that can be instantiated on, or executed by, an edge compute node within an edge computing network, system, or framework, and can potentially provide and/or consume edge computing services. The term “edge service” at least in some examples refers to a service provided via an edge compute node and/or edge platform, either by the edge platform itself and/or by an edge application.

The term “colocated” or “co-located” at least in some examples refers to two or more elements being in the same place or location, or relatively close to one another (e.g., within some predetermined distance from one another). Additionally or alternatively, the term “colocated” or “co-located” at least in some examples refers to the placement or deployment of two or more compute elements or compute nodes together in a secure dedicated storage facility, or within a same enclosure or housing.

The term “cluster” at least in some examples refers to a set or grouping of entities as part of a cloud computing service and/or an edge computing system (or systems), in the form of physical entities (e.g., different computing systems, network elements, networks and/or network groups), logical entities (e.g., applications, functions, security constructs, virtual machines, virtualization containers, and the like), and the like. In some examples, a “cluster” is also referred to as a “group” or a “domain”. The membership of cluster may be modified or affected based on conditions, parameters, criteria, configurations, functions, and/or other aspects including from dynamic or property-based membership, from network or system management scenarios, and/or the like.

The term “Data Network” or “DN” at least in some examples refers to a network hosting data-centric services such as, for example, operator services, the internet, third-party services, or enterprise networks. Additionally or alternatively, a DN at least in some examples refers to service networks that belong to an operator or third party, which are offered as a service to a client or user equipment (UE). DNs are sometimes referred to as “Packet Data Networks” or “PDNs”. The term “Local Area Data Network” or “LADN” at least in some examples refers to a DN that is accessible by the UE only in specific locations, that provides connectivity to a specific DNN, and whose availability is provided to the UE.

The term “Internet of Things” or “IoT” at least in some examples refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities. The term “Edge IoT devices” at least in some examples refers to any kind of IoT devices deployed at a network’s edge.

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like). The term “compute resource” or simply “resource” at least in some examples refers to an object with a type, associated data, a set of methods that operate on it, and, if applicable, relationships to other resources. Additionally or alternatively, the term “compute resource” or “resource” at least in some examples refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, and the like), operating systems, virtual machines (VMs), software/apps, computer files, and/or the like. A “hardware resource” at least in some examples refers to compute, storage, and/or network resources provided by physical hardware element(s). A “virtualized resource” at least in some examples refers to compute, storage, and/or network resources provided by virtualization infrastructure to an app, device, system, and the like. The term “network resource” or “communication resource” at least in some examples refers to resources that are accessible by computer devices/systems via a communications network. The term “system resources” at least in some examples refers to any kind of shared entities to provide services, and may include computing and/or network resources. System resources may be considered as a set of coherent functions, network data objects or services, accessible through a server where such system resources reside on a single host or multiple hosts and are clearly identifiable.

The term “protocol” at least in some examples refers to a predefined procedure or method of performing one or more operations. Additionally or alternatively, the term “protocol” at least in some examples refers to a common means for unrelated objects or nodes to communicate with each other (sometimes also called interfaces). The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure.

The term “application layer” at least in some examples refers to an abstraction layer that specifies shared communications protocols and interfaces used by hosts in a communications network. Additionally or alternatively, the term “application layer” at least in some examples refers to an abstraction layer that interacts with software applications that implement a communicating component, and may include identifying communication partners, determining resource availability, and synchronizing communication. Examples of application layer protocols include HTTP, HTTPs, File Transfer Protocol (FTP), Dynamic Host Configuration Protocol (DHCP), Internet Message Access Protocol (IMAP), Lightweight Directory Access Protocol (LDAP), MQTT (MQ Telemetry Transport), Remote Authentication Dial-In User Service (RADIUS), Diameter protocol, Extensible Authentication Protocol (EAP), RDMA over Converged Ethernet version 2 (RoCEv2), Real-time Transport Protocol (RTP), RTP Control Protocol (RTCP), Real Time Streaming Protocol (RTSP), SBMV Protocol, Skinny Client Control Protocol (SCCP), Session Initiation Protocol (SIP), Session Description Protocol (SDP), Simple Mail Transfer Protocol (SMTP), Simple Network Management Protocol (SNMP), Simple Service Discovery Protocol (SSDP), Small Computer System Interface (SCSI), Internet SCSI (iSCSI), iSCSI Extensions for RDMA (iSER), Transport Layer Security (TLS), voice over IP (VoIP), Virtual Private Network (VPN), Extensible Messaging and Presence Protocol (XMPP), and/or the like.

The term “session layer” at least in some examples refers to an abstraction layer that controls dialogues and/or connections between entities or elements, and may include establishing, managing and terminating the connections between the entities or elements.

The term “transport layer” at least in some examples refers to a protocol layer that provides end-to-end (e2e) communication services such as, for example, connection-oriented communication, reliability, flow control, and multiplexing. Examples of transport layer protocols include datagram congestion control protocol (DCCP), fibre channel protocol (FBC), Generic Routing Encapsulation (GRE), GPRS Tunneling (GTP), Micro Transport Protocol (µTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some examples refers to a protocol layer that includes means for transferring network packets from a source to a destination via one or more networks. Additionally or alternatively, the term “network layer” at least in some examples refers to a protocol layer that is responsible for packet forwarding and/or routing through intermediary nodes. Additionally or alternatively, the term “network layer” or “internet layer” at least in some examples refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer.

The term “link layer” or “data link layer” at least in some examples refers to a protocol layer that transfers data between nodes on a network segment across a physical layer. Examples of link layer protocols include logical link control (LLC), medium access control (MAC), Ethernet (e.g., IEEE Standard for Ethernet, IEEE Std 802.3-2018, pp.1-5600 (31 Aug. 2018) (“[IEEE802.3]”), RDMA over Converged Ethernet version 1 (RoCEv1), and/or the like.

The term “radio resource control”, “RRC layer”, or “RRC” at least in some examples refers to a protocol layer or sublayer that performs system information handling; paging; establishment, maintenance, and release of RRC connections; security functions; establishment, configuration, maintenance and release of Signaling Radio Bearers (SRBs) and Data Radio Bearers (DRBs); mobility functions/services; QoS management; and some sidelink specific services and functions over the Uu interface (see e.g., 3GPP TS 36.331 v17.2.0 (2022-10-04) (“[TS36331]”) and/or 3GPP TS 38.331 v17.2.0 (2022-10-02) (“[TS38331]”)).

The term “Service Data Adaptation Protocol”, “SDAP layer”, or “SDAP” at least in some examples refers to a protocol layer or sublayer that performs mapping between QoS flows and a data radio bearers (DRBs) and marking QoS flow IDs (QFI) in both DL and UL packets (see e.g., 3GPP TS 37.324 v17.0.0 (2022-04-13)).

The term “Packet Data Convergence Protocol”, “PDCP layer”, or “PDCP” at least in some examples refers to a protocol layer or sublayer that performs transfer user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery (see e.g., 3GPP TS 36.323 v17.1.0 (2022-07-17) and/or 3GPP TS 38.323 v17.2.0 (2022-09-29)).

The term “radio link control layer”, “RLC layer”, or “RLC” at least in some examples refers to a protocol layer or sublayer that performs transfer of upper layer PDUs; sequence numbering independent of the one in PDCP; error Correction through ARQ; segmentation and/or re-segmentation of RLC SDUs; reassembly of SDUs; duplicate detection; RLC SDU discarding; RLC re-establishment; and/or protocol error detection (see e.g., 3GPP TS 38.322 v17.1.0 (2022-07-17) and 3GPP TS 36.322 v17.0.0 (2022-04-15)).

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices. Additionally or alternatively, the term “medium access control layer”, “MAC layer”, or “MAC” at least in some examples refers to a protocol layer or sublayer that performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding (see e.g., [IEEE802], 3GPP TS 38.321 v17.2.0 (2022-10-01) and 3GPP TS 36.321 v17.2.0 (2022-10-03)).

The term “physical layer”, “PHY layer”, or “PHY” at least in some examples refers to a protocol layer or sublayer that includes capabilities to transmit and receive modulated signals for communicating in a communications network (see e.g., [IEEE802], 3GPP TS 38.201 v17.0.0 (2022-01-05) and 3GPP TS 36.201 v17.0.0 (2022-03-31)).

The term “radio technology” at least in some examples refers to technology for wireless transmission and/or reception of electromagnetic radiation for information transfer. The term “radio access technology” or “RAT” at least in some examples refers to the technology used for the underlying physical connection to a radio based communication network. The term “RAT type” at least in some examples may identify a transmission technology and/or communication protocol used in an access network, for example, new radio (NR), Long Term Evolution (LTE), narrowband IoT (NB-IOT), untrusted non-3GPP, trusted non-3GPP, trusted Institute of Electrical and Electronics Engineers (IEEE) 802 (e.g., [IEEE80211]; see also IEEE Standard for Local and Metropolitan Area Networks: Overview and Architecture, IEEE Std 802-2014, pp. 1-74 (30 Jun. 2014) (“[IEEE802]”), the contents of which is hereby incorporated by reference in its entirety), non-3GPP access, MuLTEfire, WiMAX, wireline, wireline-cable, wireline broadband forum (wireline-BBF), and the like. Examples of RATs and/or wireless communications protocols include Advanced Mobile Phone System (AMPS) technologies such as Digital AMPS (D-AMPS), Total Access Communication System (TACS) (and variants thereof such as Extended TACS (ETACS), and the like); Global System for Mobile Communications (GSM) technologies such as Circuit Switched Data (CSD), High-Speed CSD (HSCSD), General Packet Radio Service (GPRS), and Enhanced Data Rates for GSM Evolution (EDGE); Third Generation Partnership Project (3GPP) technologies including, for example, Universal Mobile Telecommunications System (UMTS) (and variants thereof such as UMTS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), and the like), Generic Access Network (GAN) / Unlicensed Mobile Access (UMA), High Speed Packet Access (HSPA) (and variants thereof such as HSPA Plus (HSPA+), and the like), Long Term Evolution (LTE) (and variants thereof such as LTE-Advanced (LTE-A), Evolved UTRA (E-UTRA), LTE Extra, LTE-A Pro, LTE LAA, MuLTEfire, and the like), Fifth Generation (5G) or New Radio (NR), and the like; ETSI technologies such as High Performance Radio Metropolitan Area Network (HiperMAN) and the like; IEEE technologies such as [IEEE802] and/or WiFi (e.g., [IEEE80211] and variants thereof), Worldwide Interoperability for Microwave Access (WiMAX) (e.g., [WiMAX] and variants thereof), Mobile Broadband Wireless Access (MBWA)/iBurst (e.g., IEEE 802.20 and variants thereof), and the like; Integrated Digital Enhanced Network (iDEN) (and variants thereof such as Wideband Integrated Digital Enhanced Network (WiDEN); millimeter wave (mmWave) technologies/standards (e.g., wireless systems operating at 10-300 GHz and above such as 3GPP 5G, Wireless Gigabit Alliance (WiGig) standards (e.g., IEEE 802.11ad, IEEE 802.11ay, and the like); short-range and/or wireless personal area network (WPAN) technologies/standards such as Bluetooth (and variants thereof such as Bluetooth 5.3, Bluetooth Low Energy (BLE), and the like), IEEE 802.15 technologies/standards (e.g., IEEE Standard for Low-Rate Wireless Networks, IEEE Std 802.15.4-2020, pp.1-800 (23 Jul. 2020) (“[IEEE802154]”), ZigBee, Thread, IPv6 over Low power WPAN (6LoWPAN), WirelessHART, MiWi, ISA100.11a, IEEE Standard for Local and metropolitan area networks - Part 15.6: Wireless Body Area Networks, IEEE Std 802.15.6-2012, pp. 1-271 (29 Feb. 2012), WiFi-direct, ANT/ANT+, Z-Wave, 3GPP Proximity Services (ProSe), Universal Plug and Play (UPnP), low power Wide Area Networks (LPWANs), Long Range Wide Area Network (LoRA or LoRaWAN™), and the like; optical and/or visible light communication (VLC) technologies/standards such as IEEE Standard for Local and metropolitan area networksPart 15.7: Short-Range Optical Wireless Communications, IEEE Std 802.15.7-2018, pp.1-407 (23 Apr. 2019), and the like; V2X communication including 3GPP cellular V2X (C-V2X), Wireless Access in Vehicular Environments (WAVE) (IEEE Standard for Information technology-- Local and metropolitan area networks-- Specific requirements-- Part 11: Wireless LAN Medium Access Control (MAC) and Physical Layer (PHY) Specifications Amendment 6: Wireless Access in Vehicular Environments, IEEE Std 802.11p-2010, pp.1-51 (15 Jul. 2010) (“[IEEE80211p]”), which is now part of [IEEE80211]), IEEE 802.11bd (e.g., for vehicular ad-hoc environments), Dedicated Short Range Communications (DSRC), Intelligent-Transport-Systems (ITS) (including the European ITS-G5, ITS-G5B, ITS-G5C, and the like); Sigfox; Mobitex; 3GPP2 technologies such as cdmaOne (2G), Code Division Multiple Access 2000 (CDMA 2000), and Evolution-Data Optimized or Evolution-Data Only (EV-DO); Push-to-talk (PTT), Mobile Telephone System (MTS) (and variants thereof such as Improved MTS (IMTS), Advanced MTS (AMTS), and the like); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) (and variants thereof such as DECT Ultra Low Energy (DECT ULE), DECT-2020, DECT-5G, and the like); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information.

The term “Collective Perception” or “CP” at least in some examples refers to the concept of sharing the perceived environment of an ITS-S based on perception sensors, wherein an ITS-S broadcasts information about its current (driving) environment. CP at least in some examples refers to the concept of actively exchanging locally perceived objects between different ITS-Ss by means of a V2X RAT. CP decreases the ambient uncertainty of ITS-Ss by contributing information to their mutual FoVs. The term “Collective Perception basic service”, “CP service”, or CPS” at least in some examples refers to a facility at the ITS-S facilities layer to receive and process CPMs, and generate and transmit CPMs. The term “Collective Perception Message” or “CPM” at least in some examples refers to a CP basic service PDU. The term “Collective Perception data” or “CPM data” at least in some examples refers to a partial or complete CPM payload. The term “Collective Perception protocol” or “CPM protocol” at least in some examples refers to an ITS facilities layer protocol for the operation of the CPM generation, transmission, and reception. The term “CP object” or “CPM object” at least in some examples refers to aggregated and interpreted abstract information gathered by perception sensors about other traffic participants and obstacles. CP/CPM Objects can be represented mathematically by a set of variables describing, amongst other, their dynamic state and geometric dimension. The state variables associated to an object are interpreted as an observation for a certain point in time and are therefore always accompanied by a time reference. The term “environment model” at least in some examples refers to a current representation of the immediate environment of an ITS-S, including all perceived objects perceived by either local perception sensors or received by V2X. The term “object” at least in some examples refers to the state space representation of a physically detected object within a sensor’s perception range. The term “object list” refers to a collection of objects temporally aligned to the same timestamp.

The term “confidence level” at least in some examples refers to a probability with which an estimation of the location of a statistical parameter (e.g., an arithmetic mean) in a sample survey is also true for a population (e.g., a sample survey that is also true for an entire population from which the samples were taken). The term “confidence value” at least in some examples refers to an estimated absolute accuracy of a statistical parameter (e.g., an arithmetic mean) for a given confidence level (e.g., 95%). Additionally or alternatively, the term “confidence value” or “confidence interval” at least in some examples refers to an estimated interval associated with the estimate of a statistical parameter of a population using sample statistics (e.g., an arithmetic mean) within which the true value of the parameter is expected to lie with a specified probability, equivalently at a given confidence level (e.g., 95%). In some examples, confidence intervals are neither to be confused with nor used as estimated uncertainties (covariances) associated with either the output of stochastic estimation algorithms used for tasks such as kinematic and attitude state estimation and the associated estimate error covariance, or the measurement noise variance associated with a sensor’s measurement of a physical quantity (e.g. variance of the output of an accelerometer or specific force meter). The term “detection confidence” at least in some examples refers to a measure related to the certainty, generally a probability. In some examples, the “detection confidence” refers to a sensor or sensor system associates with its output or outputs involving detection of an object or objects from a set of possibilities (e.g., with X% probability the object is a chair, with Y% probability the object is a couch, and with (1-X-Y)% probability it is something else). The term “free space existence confidence” or “perceived region confidence” at least in some examples refers to a quantification of the estimated likelihood that free spaces or unoccupied areas may be detected within a perceived region.

The term “ITS data dictionary” at least in some examples refers to a repository of DEs and DFs used in the ITS apps and ITS facilities layer. The term “ITS message” at least in some examples refers to messages exchanged at ITS facilities layer among ITS stations or messages exchanged at ITS apps layer among ITS stations.

The term “ITS station” or “ITS-S” at least in some examples refers to functional entity specified by the ITS station (ITS-S) reference architecture. The term “personal ITS-S” or “P-ITS-S” refers to an ITS-S in a nomadic ITS sub-system in the context of a portable device (e.g., a mobile device of a pedestrian). The term “Roadside ITS-S” or “R-ITS-S” at least in some examples refers to an ITS-S operating in the context of roadside ITS equipment. The term “Vehicle ITS-S” or “V-ITS-S” at least in some examples refers to an ITS-S operating in the context of vehicular ITS equipment. The term “ITS central system” or “Central ITS-S” refers to an ITS system in the backend, for example, traffic control center, traffic management center, or cloud system from road authorities, ITS app suppliers or automotive OEMs.

The term “geographical area”, “geographic area”, or “geo-area” at least in some examples refers to a defined two-dimensional (2D) or three-dimensional (3D) area, region, plot of land, or other demarcated terrestrial space that can be considered as a unit. In some examples, a “geographical area”, “geographic area”, or “geo-area” is represented by a boundingg-box or one or more geometric shapes, such as circles, spheres, rectangles, cubes, cuboids, ellipses, ellipsoids, and/or any other 2D or 3D shape.

The term “geo-fence” or “geofence” at least in some examples refers to a virtual perimeter or boundary that corresponds to a real-world geographic area (or a geo-area). In some examples, a “geo-fence” or “geofence” can correspond to a predefined boundary or border (e.g., property/plot boundaries; school zones; neighborhood boundaries; national or provincial boundaries; a configured or user-selectable boundary; a cell provided by a network access node; a service area, registration area, tracking area, 5G enhanced positioning area, and/or 5G positioning service area, as defined by relevant 3GPP standards, and/or the like) and/or can be dynamically generated (e.g., radius around a point/location of an entity/element, or some other shape of a dynamic of predefined size surrounding a point/location of an entity/element). The term “geofencing” at least in some examples refers to the use of a geofence, for example, by using a location-aware device and/or location services to determine when a user enters and/or exits a geofence.

The term “object” at least in some examples refers to a material thing that can be detected and with which parameters can be associated that can be measured and/or estimated. The term “object existence confidence” at least in some examples refers to a quantification of the estimated likelihood that a detected object exists, i.e., has been detected previously and has continuously been detected by a sensor. The term “object list” at least in some examples refers to a collection of objects and/or a data structure including a collection of detected objects.

The term “sensor measurement” at least in some examples refers to abstract object descriptions generated or provided by feature extraction algorithm(s), which may be based on the measurement principle of a local perception sensor mounted to a station/UE, wherein a feature extraction algorithm processes a sensor’s raw data (e.g., reflection images, camera images, and the like) to generate an object description. The term “state space representation” at least om some examples refers to a mathematical description of a detected object (or perceived object), which includes a set of state variables, such as distance, position, velocity or speed, attitude, angular rate, object dimensions, and/or the like. In some examples, state variables associated with/to an object are interpreted as an observation for a certain point in time, and are accompanied by a time reference.

The term “vehicle” at least in some examples refers to a machine designed to carry people or cargo. Examples of “vehicles” include wagons, bicycles, motor vehicles (e.g., electric bicycles, motorcycles, cars, trucks, motor homes, buses, mobility scooters, Segways, and/or the like), railed vehicles (e.g., trains, trams, trolleybuses, and/or the like), watercraft (e.g., ships, boats, underwater vehicles, and/or the like), cable transport vehicles (e.g., cable cars, gondolas, chairlifts, a type of aerial lift, and/or the like), amphibious vehicles (e.g., screw-propelled vehicles, hovercraft, and/or the like), aircraft (e.g., airplanes, helicopters, aerostats, balloons, air ships, UAVs, and/or the like), and spacecraft (e.g., spaceships, satellites, and/or the like). Additionally, “vehicles” may be human-operated vehicles, semi-autonomous or computer-assisted vehicles, and/or autonomous vehicles. The term “electric vehicle” or “EV” at least in some examples refers to a vehicle that uses one or more electric motors for propulsion. In some examples, “electric vehicles” are powered by a collector system with electricity from extra-vehicular sources (e.g., overhead cables, electric third rails, group level power supplies, in-road inductive loop charging or wireless on-road charging systems, and/or the like) or powered autonomously by a battery, which can be charged by solar panels, or by converting fuel to electricity using fuel cells or a generator. The term “batter electric vehicle” or “BEV” at least in some examples refers to an EV that exclusively uses chemical energy stored in rechargeable battery packs for electric motors and motor controllers, with no secondary source of propulsion (e.g., hydrogen fuel cells, internal combustion engines, and the like). The term “plug-in electric vehicle” or “PEV” at least in some examples refers to a vehicle that can utilize an external source of electricity, such as a wall socket that connects to a power grid, to store electrical power within its onboard rechargeable battery packs, which then powers its electric motor(s) and contributes to propelling the vehicle.

The term “charging station” at least in some examples refers to a piece of equipment that supplies electrical power for charging an EV or (BEVs, PEVs, and plug-in hybrid vehicles). The term “charging station” is also referred to as a “charge point”, an electric vehicle supply equipment” or “EVSE”, and/or XXX

The term “Vehicle-to-Everything” or “V2X” at least in some examples refers to vehicle to vehicle (V2V), vehicle to infrastructure (V2I), infrastructure to vehicle (I2V), vehicle to network (V2N), and/or network to vehicle (N2V) communications and associated RATs.

The term “application” or “app” at least in some examples refers to a computer program designed to carry out a specific task other than one relating to the operation of the computer itself. Additionally or alternatively, term “application” or “app” at least in some examples refers to a complete and deployable package, environment to achieve a certain function in an operational environment. The term “application programming interface” or “API” at least in some examples refers to a set of subroutine definitions, communication protocols, and tools for building software. Additionally or alternatively, the term “application programming interface” or “API” at least in some examples refers to a set of clearly defined methods of communication among various components. In some examples, an API may be defined or otherwise used for a web-based system, operating system, database system, computer hardware, software library, and/or the like. The term “process” at least in some examples refers to an instance of a computer program that is being executed by one or more threads. In some implementations, a process may be made up of multiple threads of execution that execute instructions concurrently. The term “algorithm” at least in some examples refers to an unambiguous specification of how to solve a problem or a class of problems by performing calculations, input/output operations, data pre-processing, data processing, automated reasoning tasks, and/or the like. The terms “instantiate,” “instantiation,” and the like at least in some examples refers to the creation of an instance. An “instance” also at least in some examples refers to a concrete occurrence of an object, which may occur, for example, during execution of program code.

The term “advanced driver-assistance system” or “ADAS” at least in some examples at least in some examples refers to a groups of electronic systems, devices, and/or other technologies that assist drivers in driving and parking functions. In some examples, ADAS uses automation technology, including sensors and computing devices, to detect nearby obstacles or driver errors, and respond accordingly. Examples of ADAS include cruise control and/or adaptive cruise control, anti-lock braking system, automatic parking, backup cameras, blind spot cameras/detection, collision avoidance system, crosswind stabilization, descent control, driver warning systems, electronic stability control, emergency driver assistance, head-up display (HUD), hill start-assist, lane centering, lane change assistance, navigation systems, night vision systems, omniview technology, rain sensing, traction control system, traffic sign recognition, vehicle communication systems, and/or the like.

The term “data unit” at least in some examples at least in some examples refers to a basic transfer unit associated with a packet-switched network; a datagram may be structured to have header and payload sections. The term “data unit” at least in some examples may be synonymous with any of the following terms, even though they may refer to different aspects: “datagram”, a “protocol data unit” or “PDU”, a “service data unit” or “SDU”, “frame”, “packet”, a “network packet”, “segment”, “block”, “cell”, “chunk”, “message”, “information element” or “IE”, “Type Length Value” or “TLV”, and/or the like. Examples of datagrams, network packets, and the like, include internet protocol (IP) packet, Internet Control Message Protocol (ICMP) packet, UDP packet, TCP packet, SCTP packet, ICMP packet, Ethernet frame, RRC messages/packets, SDAP PDU, SDAP SDU, PDCP PDU, PDCP SDU, MAC PDU, MAC SDU, BAP PDU. BAP SDU, RLC PDU, RLC SDU, WiFi frames as discussed in a [IEEE802] protocol/standard (e.g., [IEEE80211] or the like), Type Length Value (TLV), and/or other like data structures.

The term “data element” or “DE” at least in some examples refers to a data type that contains one single data. Additionally or alternatively, the term “data element” at least in some examples refers to an atomic state of a particular object with at least one specific property at a certain point in time, and may include one or more of a data element name or identifier, a data element definition, one or more representation terms, enumerated values or codes (e.g., metadata), and/or a list of synonyms to data elements in other metadata registries. Additionally or alternatively, a “data element” at least in some examples refers to a data type that contains one single data. In some examples, the data stored in a data element may be referred to as the data element’s content, “content item”, or “item”.

The term “bin” or “data bin” at least in some examples refers to an interval that represents a range of data points that has been sorted by a data binning system. Additionally or alternatively, the term “bin” or “data bin” at least in some examples refers to a data structure used for region queries, wherein the frequency of a bin is increased by one each time a data point falls into the bin. The term “data binning”, “data bucketing”, or “binning” at least in some examples refers to a data pre-processing technique or task that groups a set of more-or-less continuous values into a number of bins. Additionally or alternatively, the term “data binning”, “data bucketing”, or “binning” at least in some examples refers to a data pre-processing technique used to reduce the effects of observation errors, wherein original data values that fall into a given interval (e.g., a bin) are replaced by a value representative of that interval (e.g., central value, mean, median, and/or the like). The term “data binning system” at least in some examples refers to a data pre-processing system that implements a data binning algorithm (e.g., forward binning, backward binning, binning sketch, clustering, cartographic binning, histogram binning, spectral binning, Oscar binning, and/or the like) and/or is otherwise configured to solve a data binning task. The term “data binning task” at least in some examples refers to a data pre-processing task that converts a dataset (e.g., a continuous dataset) into a set of data bins or buckets.

The term “data structure” at least in some examples refers to a data organization, management, and/or storage format. Additionally or alternatively, the term “data structure” at least in some examples refers to a collection of data values, the relationships among those data values, and/or the functions, operations, tasks, and the like, that can be applied to the data. Examples of data structures include primitives (e.g., Boolean, character, floating-point numbers, fixed-point numbers, integers, reference or pointers, enumerated type, and/or the like), composites (e.g., arrays, records, strings, union, tagged union, and/or the like), abstract data types (e.g., data container, list, tuple, associative array, map, dictionary, set (or dataset), multiset or bag, stack, queue, graph (e.g., tree, heap, and the like), and/or the like), routing table, symbol table, quad-edge, blockchain, purely-functional data structures (e.g., stack, queue, (multi)set, random access list, hash consing, zipper data structure, and/or the like).

Although many of the previous examples are provided with use of specific cellular / mobile network terminology, including with the use of 4G/5G 3GPP network components (or expected terahertz-based 6G/6G+ technologies), it will be understood these examples may be applied to many other deployments of wide area and local wireless networks, as well as the integration of wired networks (including optical networks and associated fibers, transceivers, and/or the like). Furthermore, various standards (e.g., 3GPP, ETSI, and/or the like) may define various message formats, PDUs, containers, frames, and/or the like, as comprising a sequence of optional or mandatory data elements (DEs), data frames (DFs), information elements (IEs), and/or the like. However, it should be understood that the requirements of any particular standard should not limit the examples discussed herein, and as such, any combination of containers, frames, DFs, DEs, IEs, values, actions, and/or features are possible in various examples, including any combination of containers, DFs, DEs, values, actions, and/or features that are strictly required to be followed in order to conform to such standards or any combination of containers, frames, DFs, DEs, IEs, values, actions, and/or features strongly recommended and/or used with or in the presence/absence of optional elements.

Aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1. A vehicle station, comprising:
positioning circuitry to generate positioning information of the vehicle station based on mobility of the vehicle station;
processor circuitry connected to the positioning circuitry, wherein the processor is to operate to a road usage monitoring service (RUM) to:
determine RUM information of the vehicle station based on the positioning information, wherein the RUM information includes road usage data of the vehicle station, and
generate a RUM message to include the determined RUM information; and
communication circuitry connected to the processor circuitry, wherein the communication circuitry is to transmit the RUM message to an infrastructure node.

2. The vehicle station of claim 1, wherein the processor circuitry is to operate the RUM to:
receive mapping data from a mapping service;
determine a travel route based on the positioning information;
determine one or more geographical areas (geo-areas) through which the vehicle station travelled based on the determined travel route; and
generate the RUM information to include the one or more geo-areas.

3. The vehicle station of claim 2, wherein the processor circuitry is to operate the RUM to generate the RUM information to include: a vehicle identifier (ID) of the vehicle station, a start timestamp for the road usage data, an end timestamp for the road usage data, and a set of geo-area tuples, wherein each geo-area tuple of the set of geo-area tuples includes a geo-area ID and a corresponding distance travelled in a geo-area associated with the geo-area ID.

4. The vehicle station of claim 3, wherein the processor circuitry is to operate the RUM to: store the RUM information as a set of duration bins in local storage circuitry of the vehicle station.

5. The vehicle station of claim 1, wherein the processor circuitry is to operate the RUM to, in response to receipt of a RUM request from the infrastructure node:
generate the RUM message; and
cause the communication circuitry to transmit the RUM message.

6. The vehicle station of claim 1, wherein the processor circuitry is to operate the RUM to:
determine the RUM information on a periodic basis.

7. The vehicle station of claim 1, wherein the vehicle station includes battery charging circuitry connected to the processor circuitry, and the processor circuitry is to operate the RUM to:
obtain a set of battery parameters from the battery charging circuitry; and
determine the RUM information based on the battery parameters.

8. The vehicle station of claim 7, wherein the processor circuitry is to operate the RUM to: obtain the set of battery parameters from the battery charging circuitry after a charging process has completed.

9. The vehicle station of claim 7, wherein the battery charging circuitry includes on-board charging circuitry and a battery management system.

10. The vehicle station of claim 1, wherein the vehicle station is a vehicle intelligent transport system station (ITS-S) and the infrastructure node is a roadside ITS-S or a central ITS-S, and wherein the RUM is an ITS-S application in an ITS applications layer or the RUM is an ITS-S facility in an ITS facilities layer.

11. The vehicle station of claim 10, wherein the central ITS-S is part of an edge compute node or a cloud computing service.

12. A method of operating a road usage monitoring (RUM) service, comprising:
receiving, by an infrastructure node, a first RUM message from a vehicle station, wherein the first RUM message includes vehicle information related to mobility of the vehicle station;
extracting, by the infrastructure node, the vehicle information from the first RUM message;
generating, by the infrastructure node, a second RUM message including the extracted vehicle information; and
transmitting, by the infrastructure node, the second RUM message to a cloud-based RUM service.

13. The method of claim 12, wherein the vehicle information includes a vehicle identifier (ID) of the vehicle station, location data of the vehicle station, and heading direction of the vehicle station, and one or both of speed data of the vehicle station and a station type of the vehicle station.

14. The method of claim 13, wherein the method comprises:
determining, by the infrastructure node, a travel distance of the vehicle station based on the location data and location data included in a previously received first RUM message from the vehicle station; and
generating, by the infrastructure node, the second RUM message when the travel distance is larger than a threshold distance.

15. The method of claim 12, wherein the method comprises:
receiving, by an infrastructure node, sensor data from respective sensors;
performing, by the infrastructure node, environment perception based on the sensor data to identify the another vehicle station;
generating, by the infrastructure node, the other vehicle information for the other vehicle station based on the environment perception; and
transmitting, by the infrastructure node, another second RUM message to the cloud-based RUM service.

16. The method of claim 12, wherein the vehicle station is a vehicle intelligent transport system station (ITS-S), the infrastructure node is a roadside ITS-S or a central ITS-S, and the cloud-based RUM service is part of the central ITS-S or a different central ITS-S.

17. The method of claim 16, wherein the central ITS-S is part of an edge compute node or a cloud computing service, and the other central ITS-S is part of an edge compute node or a cloud computing service.

18. One or more non-transitory computer readable medium comprising instructions of a road usage monitoring (RUM) service, wherein execution of the instructions by one or more processors of a compute node is to cause the compute node to:
receive a RUM message from a vehicle station, wherein the RUM message includes vehicle information related to mobility of the vehicle station;
obtain historic vehicle data from a RUM database;
estimate a travel path of the vehicle station based on the vehicle information and the historic vehicle data;
determine one or more geographical areas (geo-areas) through which the vehicle station travelled based on the determined travel path;
estimate a distance travelled by the vehicle station based on the travel path and the determined one or more geo-areas; and
store the travel path, the one or more geo-areas, and the estimated distance in the RUM database.

19. The one or more non-transitory computer readable medium of claim 18, wherein execution of the instructions is to cause the compute node to: receive the RUM message via an infrastructure node.

20. The one or more non-transitory computer readable medium of claim 18, wherein the vehicle information includes a vehicle identifier (ID) of the vehicle station, location data of the vehicle station, and heading direction of the vehicle station, and one or both of speed data of the vehicle station and a station type of the vehicle station.

21. The one or more non-transitory computer readable medium of claim 18, wherein execution of the instructions is to cause the infrastructure node to:
determine a road usage charge based on the estimated distance.

22. The one or more non-transitory computer readable medium of claim 18, wherein the vehicle station is a vehicle intelligent transport system station (ITS-S) and the compute node is a roadside ITS-S or a central ITS-S, and wherein the RUM is an ITS-S application in an ITS applications layer, or the RUM is an ITS-S facility in an ITS facilities layer.

23. The one or more non-transitory computer readable medium of claim 18, wherein the compute node is an edge compute node or a cloud computing service.

24. Electric vehicle supply equipment (EVSE) circuitry, comprising:
a charge controller to control charging of a rechargeable battery of a vehicle station, and monitor an amount of charge applied to the rechargeable battery;
processor circuitry connected to the charge controller, wherein the processor is to operate to a road usage monitoring service (RUM) to determine a road usage fee based on the amount of charge applied to the rechargeable battery; and
communication circuitry connected to the processor circuitry, wherein the communication circuitry is to transmit the road usage fee to an infrastructure node or to a client application for display.

25. The EVSE circuitry of claim 24, wherein the EVSE is a direct current (DC) fast charger separate from the vehicle station, or the EVSE is an alternating current (AC) charger implemented by the vehicle station.
